(19) United States
(12) Patent Application Publication
(10) Pub. No.: US 2026/0038718 A1
(43) Pub. Date: Feb. 5, 2026

(54) SOFT MAGNETIC ALLOY POWDER, MAGNETIC CORE, MAGNETIC DEVICE, AND ELECTRONIC APPARATUS

(71) Applicant: TDK CORPORATION, Tokyo (JP)

(72) Inventors: Akito HASEGAWA, Tokyo (JP); Yoshiki Kajiura, Tokyo (JP)

(73) Assignee: TDK CORPORATION, Tokyo (JP)

(21) Appl. No.: 19/285,040

(22) Filed: Jul. 30, 2025

(30) Foreign Application Priority Data
Jul. 31, 2024 (JP) 2024-124900
Jun. 19, 2025 (JP) 2025-104151

(51) Int. Cl. H01F 1/153; C22C 45/02; H01F 3/08; H01F 27/255

(52) U.S. Cl. CPC H01F 1/15308; C22C 45/02; H01F 1/15333; H01F 3/08; C22C 2202/02; H01F 27/255

(57) ABSTRACT

A soft magnetic alloy powder represented by a composition formula of (Fe₁₋ₚX1ₚ)_{100-(a+b+c+d+e)}BₐP_{b}Si_{c}C_{d}X2ₑ (atomic ratio); wherein X1 is one or more selected from the group consisting of Co and Ni, X2 is one or more selected from the group consisting of Ti, Zr, Hf, Nb, Ta, Mo, Cr, W, Al, Ga, Ag, Zn, S, Ca, Mg, V, Mn, Sn, As, Sb, Bi, N, Au, Cu, a rare earth element, and a platinum group element; and p, a, b, c, d, and e satisfy 0≤p≤0.5, 2.00≤a≤20.00, 0.00≤b≤14.00, 0.00≤c≤10.00, 0.00≤d≤5.00, 0.00≤e≤3.00, and 70.00≤100−(a+b+c+d+e)≤96.00.

### BACKGROUND OF THE INVENTION

The present disclosure relates to a soft magnetic alloy powder, a magnetic core, a magnetic device, and an electronic apparatus.

### DESCRIPTION OF THE RELATED ART

Patent document 1 discloses a soft magnetic material ensuring an excellent fluidity and reduced material loss. Said soft magnetic material is made of a powder-particle substance having a particle size frequency distribution having a plurality of peak tops.

### PRIOR ART DOCUMENT

### Patent Document

Patent Document 1: JP Patent Application Laid Open No.2024-36194

### BRIEF SUMMARY OF THE INVENTION

### [the Object to Solved by the Invention]

The object of the present disclosure is to provide a soft magnetic alloy powder capable of σbtaining a magnetic core which achieves good DC superimposition characteristic, permeability, and withstand voltage.

### [Means for Solving the Object]

In order to achieve the above-mentioned object, the soft magnetic alloy powder of the present disclosure is represented by a composition formula of (Fe₁₋ₚX1ₚ)_{100-(a+b+c+d+e)}BₐP_{b}Si_{c}C_{d}X2. (atomic ratio); wherein X1 is one or more selected from the group consisting of Co and Ni, X2 is one or more selected from the group consisting of Ti, Zr, Hf, Nb, Ta, Mo, Cr, W, Al, Ga, Ag, Zn, S, Ca, Mg, V, Mn, Sn, As, Sb, Bi, N, Au, Cu, a rare earth element, and a platinum group element; and p, a, b, c, d, and e satisfy 0≤p≤0.5, 2.00≤a≤20.00, 0.00≤b≤14.00, 0.00≤c≤10.00, 0.00≤d≤5.00, 0.00≤e≤3.00, and 70.00≤100−(a+b+c+d+e)≤96.00.

The soft magnetic alloy powder may satisfy, 0≤|exp(μ₁)−exp(μ₂)|/(D90−D10)≤1.0, 0.1≤σ₁≤1.1, and 0.01≤σ₂≤1.5; wherein D10 denotes a particle size at which a cumulative relative frequency based on volume calculated from F(x) is 10%, and D90 denotes a particle size at which a cumulative relative frequency based on volume calculated from F(x) is 90%, provided that F(x) is a particle size distribution based on volume of the soft magnetic alloy powder represented by following formulae (1) to (4) using a plurality of probability density functions fᵢ(x)(i=1, 2, . . . , n)(n≥2).

$$\begin{matrix}[ Formula 1 ] & \\ F ( x ) = {\sum }_{i = 1}^{n} {X}_{i} {f}_{i} ( x ) & ( 1 )\end{matrix}$$

$$\begin{matrix}[ Formula 2 ] & \\ {\sum }_{i = 1}^{n} {X}_{i} = 1 & ( 2 )\end{matrix}$$

$$\begin{matrix}[ Formula 3 ] & \\ {X}_{i} \geq {X}_{i + 1} & ( 3 )\end{matrix}$$

$$\begin{matrix}[ Formula 4 ] & \\ {f}_{i} ( x ) = \frac{1}{\sqrt{2 π} {σ}_{i} x} {e}^{- \frac{1}{2} {( \frac{ln x - {μ}_{i}}{{σ}_{i}} )}^{2}} & ( 4 )\end{matrix}$$

In the soft magnetic alloy powder, D50 a particle size at which the cumulative relative frequency based on volume is 50% may be between 1.0 μm or larger and smaller than 45.0 μm.

An oxygen content may be between 300 ppm or more and 10000 ppm or less.

The soft magnetic alloy powder may further include amorphous.

The soft magnetic alloy powder according may have a crystallization temperature Tx and a glass transition temperature Tg, and may have a super cooled liquid range represented by ΔTx=Tx−Tg.

The soft magnetic alloy powder may include a nanocrystal.

A magnetic core of the present disclosure includes the soft magnetic alloy powder mentioned in above.

The magnetic core may include two or more types of powders.

A magnetic core of the present disclosure includes the soft magnetic alloy powder mentioned in above.

A magnetic device of the present disclosure includes the above-mentioned soft magnetic alloy powder.

An electronic apparatus of the present disclosure includes the above-mentioned soft magnetic alloy powder.

### BRIEF DESCRIPTION OF THE SEVERAL VIEWS OF THE DRAWING

FIG. 1 is a schematic diagram showing the arrangement of an injection hole.

FIG. 2 is a graph showing a relation between a water pressure injected from the injection hole and a time.

FIG. 3 is a graph of f₁(x) of Example 5.

FIG. 4 is a graph of f₁(x) and f₂(x) of Example 21.

### DETAILED DESCRIPTION OF THE INVENTION

Embodiments of the present disclosure are described below.

A soft magnetic alloy powder of the present embodiment is represented by a composition formula of (Fe₁₋ₚX1ₚ)_{100-(a+b+c+d+e)} BₐP_{b}Si_{c}CaX2. (atomic ratio); in which X1 is one or more selected from the group consisting of Co and Ni, X2 is one or more selected from the group consisting of Ti, Zr, Hf, Nb, Ta, Mo, Cr, W, Al, Ga, Ag, Zn, S, Ca, Mg, V, Mn, Sn, As, Sb, Bi, N, Au, Cu, a rare earth element, and a platinum group element; and p, a, b, c, d, and e satisfy 0≤p≤0.5, 2.00≤a≤20.00, 0.00≤b≤14.00, 0.00≤c≤10.00, 0.00≤ d≤5.00, 0.00≤e≤3.00, and 70.00≤100−(a+b+c+d+e)≤96.00.

By using the soft magnetic alloy powder having the composition within the above-mentioned range, a magnetic core with good DC superimposition characteristic, permeability, and withstand voltage can be obtained.

A method for analyzing the composition of the soft magnetic alloy powder is not particularly limited. For example, the composition can be verified using an ICP analysis. Also, a cross-section of a molded body containing the soft magnetic alloy powder may be analyzed using SEM-EDS, EPMA, and the like.

Hereinbelow, details of each component of the soft magnetic alloy powder according to the present embodiment are described.

X1 is at least one or more selected from the group consisting of Co and Ni. By using the soft magnetic alloy powder satisfying 0≤p≤0.5; that is, by using the soft magnetic alloy powder in which a content ratio of Fe is equal to or greater than a total content ratio of Co and Ni, a magnetic core with excellent properties can be obtained. Regarding the soft magnetic alloy powder having p greater than 0.5, an amorphous forming ability is significantly lowered compared to a soft magnetic alloy powder having p of 0.5 or less. Thus, a voltage resistance of the magnetic core using said soft magnetic alloy powder decreases.

The content of B which is represented by “a” satisfies 2.00≤a≤20.00. It may be 3.00≤a≤18.00, or 5.00≤a≤15.00. The larger the content of B, the more easily the permeability and the voltage resistance decrease. The smaller the content of B, the more easily the permeability, the DC superimposition characteristic, and the withstand voltage decrease. The withstand voltage particularly decreases, when the content of B is either too large or too small.

The content of P which is represented by “b” satisfies 0.00≤b≤14.00. That is, P may not be included. Further, it may be 2.00≤b≤12.00, or 4.00≤b≤10.00. The permeability and the withstand voltage tend to easily decrease when the content of P is either too large or too small.

The content of Si which is represented by “c” satisfies 0.00≤c≤10.00. That is, Si may not be included. Further, it may be 0.00≤c≤8.00, or 0.00≤c≤6.00. The greater the content of Si is, the more easily the permeability and the withstand voltage decrease.

The range of b+c which represents a total content of P and the content of Si is not particularly limited. For example, it may be 4.00≤b+c≤20.00. The greater the total content of P and Si, the more easily the DC superimposition characteristic decrease.

The content of C which is represented by “d” satisfies 0.00≤d≤5.00. That is, C may not be included. Further, the content of C may be 0.00≤d≤3.00, or 0.00≤d≤1.00. The larger the content of C, the more easily the DC superimposition characteristic and the withstand voltage decrease.

The content of X2 which is represented by “e” satisfies 0.00≤e≤3.00. That is, X2 may not be included. Further, the content of X2 may be 0.00≤e≤1.00, or 0.01≤e≤1.00. The larger the content of X2, the more easily the DC superimposition characteristic and the withstand voltage decrease. In the case that e is 1.00 or less, the permeability can be maintained high. In the case e is larger than 1.00, the larger the e, the more easily the permeability decreases.

The soft magnetic alloy powder according to the present embodiment satisfies 70.00≤100−(a+b+c+d+e)≤96.00. That is, the total content of Fe and X1 is 70.00 at % or greater and 96.00 at % or less. The total content of Fe and X1 may be 72.00≤100−(a+b+c+d+e)≤88.00, or 74.00≤100−(a+b+c+d+e)≤82.00. The smaller the total content of Fe and X1, the more easily Bs decreases. The DC superimposition characteristic and the withstand voltage tend to decrease easily when the total content of Fe and X1 is either too large or too small.

The soft magnetic alloy powder according to the present embodiment may further include oxygen. Further, the oxygen content with respect to 100 mass % of the soft magnetic alloy powder may by be 0 ppm or more and 10000 ppm or less, or 300 ppm or more and 10000 ppm or less in terms of mass. The larger the oxygen content, the more easily the withstand voltage improves, and the more easily the permeability and the DC superimposition characteristic decrease.

Note that, the soft magnetic alloy powder according to the present embodiment may include elements of inevitable impurities in addition to Fe, X1, B, P, Si, C, and X2 within a range which does not significantly influence the properties of the soft magnetic alloy powder. The content of σxygen is as described in above. Regarding the elements of the inevitable impurities other than oxygen, 0.1 mass % or less of said elements may be included in 100 mass % of the soft magnetic alloy powder.

The particle size distribution F(x) based on volume of the soft magnetic alloy powder may be represented by following formulae (1) to (4) using a plurality of probability density functions fᵢ(x) (i=1, 2, . . . , n) (n≥2).

$$\begin{matrix}[ Formula 1 ] & \\ F ( x ) = {\sum }_{i = 1}^{n} {X}_{i} {f}_{i} ( x ) & ( 1 )\end{matrix}$$

$$\begin{matrix}[ Formula 2 ] & \\ {\sum }_{i = 1}^{n} {X}_{i} = 1 & ( 2 )\end{matrix}$$

$$\begin{matrix}[ Formula 3 ] & \\ {X}_{i} \geq {X}_{i + 1} & ( 3 )\end{matrix}$$

$$\begin{matrix}[ Formula 4 ] & \\ {f}_{i} ( x ) = \frac{1}{\sqrt{2 π} {σ}_{i} x} {e}^{- \frac{1}{2} {( \frac{ln x - {μ}_{i}}{{σ}_{i}} )}^{2}} & ( 4 )\end{matrix}$$

Further, when D10 is a particle size at which a cumulative relative frequency based on volume calculated from F(x) reaches 10% and D90 is a particle size at which a cumulative relative frequency based on volume calculated from F(x) reaches 90%, followings may be satisfied:

$$0 < \vert exp ( {μ}_{1} ) - exp ( {μ}_{2} ) \vert / ( D 90 - D 10 ) \leq 1. ,$$

$$1.1 \leq {σ}_{1} \leq 1.1 , and 0.01 \leq {σ}_{2} \leq 1.5 .$$

In above, exp(A) refers to e^{A}.

In following description, |exp(μ₁)−exp(μ₂)|/(D90−D10) may be simply referred to as Z.

The formula (4) shows a probability density function of a log-normal distribution. In the case that the particle size distribution F(x) of the soft magnetic alloy particle can be shown by a plurality of probability density functions as shown in the formulae (1) to (3), and μ₁, μ₂, σ₁, and σ₂ of f₁(x) and f₂(x) satisfy all of the above-mentioned three formulae, the magnetic core with even more enhanced permeability, DC superimposition characteristic, and withstand voltage can be obtained without changing the composition of the soft magnetic alloy powder.

The left side of the formula (1) is a probability density function showing a particle size distribution of the soft magnetic alloy powder which has been actually measured. The right side of the formula (1) is a probability density function obtained by using a plurality of probability density functions which is log-normal distribution. In the case where the sum of squared differences between the probability obtained by the probability density function showing a particle size distribution of the soft magnetic alloy powder which has been actually measured and the probability obtained by the probability density function obtained by using a plurality of probability density functions which is log-normal distribution across all intervals is 5×10⁻⁴ or less, a plurality of fᵢ(x) is considered to have successfully fitted to F(x). In such case, it is considered that the particle size distribution F(x) of the soft magnetic alloy powder can be expressed using fᵢ(x) (i=1, 2, . . . , n) (n≥2).

In the case of fitting F(x) using fᵢ(x), n is to be as small as possible. Therefore, in the case that F(x) can be fit only using f₁(x), that is, in the case that F(x) can be fit only using the probability density function of σne log-normal distribution, n is intentionally not 2 or larger.

An evaluation of the particle size distribution of the soft magnetic alloy powder, that is, the measurement of F(x) may be performed using a laser diffraction type particle size analyzer. When D50 is a particle size at which the cumulative relative frequency based on volume calculated from F(x) reaches 50%, then, D50 may be 1.0 μm or larger and 100 μm or smaller, 1.0 μm or larger and less than 45.0 μm, or 1.5 μm or larger and 44.7 μm or smaller. Particularly, in the case that D50 is less than 45.0 μm, the DC superimposition characteristic and the withstand voltage tend to improve.

The particle size distribution based on volume of the soft magnetic alloy powder including the soft magnetic alloy particle may be evaluated using an image obtained by observing a cross-section of the magnetic core including the soft magnetic alloy particle. Specifically, first, the cross-section obtained by cutting the magnetic core is observed using devices such as SEM-EDS and EPMA.

The more the soft magnetic alloy particles are observed, the better it is; and at least 20000 soft magnetic alloy particles are observed. Also, the magnification for observation is set to an appropriate magnification for measuring a cross-section area of each soft magnetic alloy particle. In order to observe the particularly small soft magnetic alloy particle, the observation magnification may be increased accordingly.

The cross-section area of a soft magnetic alloy particle included in the observation field is calculated. In the case that various particles other than the soft magnetic alloy particle are included in the observation field, only the soft magnetic alloy particles are selected to calculate the cross-section area. Next, using the cross-section area of the soft magnetic particle, a Heywood diameter of each particle is calculated. A volume of the soft magnetic alloy particle included in the cross-section of the magnetic core is calculated assuming that the shape of each particle is a sphere having the diameter of the above-mentioned Heywood diameter. The particle size distribution F(x) based on volume of the soft magnetic alloy powder is calculated from the Heywood diameter and the volume of each soft magnetic alloy particle.

As mentioned in above, the value of Z may be larger than 0 and 1.0 or smaller, or it may be 0.1≤Z≤1.0. The value of μᵢ (i=1, 2) is not particularly limited. For example, it may be 0.4 or larger and 4.3 or smaller. As mentioned in above, the value of σ₁ may be 0.1 or larger and 1.1 or smaller, and the value of σ₂ may be 0.01 or larger and 1.5 or smaller.

The soft magnetic alloy powder according to the present embodiment may include amorphous. Further, the soft magnetic alloy powder including amorphous may have a crystallization temperature Tx and a glass transition temperature Tg; and may also have a super cooled liquid range which is represented by ΔTx=Tx−Tg.

As the temperature of the soft magnetic alloy including amorphous increases, a glass transition reaction (endothermic reaction) may occur at a certain temperature. This temperature is the glass transition temperature Tg. When the temperature further increases, a crystallization reaction (exothermic reaction) may occur at a certain temperature. This temperature is the crystallization temperature Tx. In such case, the super cooled liquid range ΔTx can be expressed using Tx−Tg.

The super cooled liquid range relates to a stabilization of amorphous; and the wider the super cooled liquid range and the larger ΔT, the higher the amorphous forming ability. On the contrary to this, the narrower the super cooled liquid range, the lower the amorphous forming ability. The presence of Tx, the presence of Tg, and ΔT can be verified using a differential scanning calorimeter (DSC).

The soft magnetic alloy powder according to the present embodiment may include a nanocrystal, that is, a crystal having a crystal particle size of 50 nm or less. The soft magnetic alloy powder including the nanocrystal may be obtained by carrying out heat treatment to the soft magnetic alloy powder including amorphous.

A method for verifying whether the soft magnetic alloy powder includes the amorphous and the nanocrystal is not particularly limited. For example, XRD can be used for verification.

Below describes the method of verifying whether the soft magnetic alloy powder of the present embodiment includes the structure including an amorphous structure (the structure made only of the amorphous structure or a nanohetero structure). In the present embodiment, the soft magnetic alloy powder having 85% or higher of an amorphous ratio X shown by the below formula (A) is considered to include the amorphous structure; and the soft magnetic alloy powder having the amorphous ratio X of less than 85% is considered to include a structure made of crystals or nanocrystals.

$$X = 100 - ( I c / ( I c + I a ) \times 100 ) \qquad ( A )$$

Ic: Crystal scattering integrated intensity

Ia: Amorphous scattering integrated intensity

For calculating the amorphous ratio X of the soft magnetic alloy powder, first, a crystal structure analysis is carried out to the soft magnetic alloy powder using X-ray diffraction method (XRD). Next, a phase is determined, and a peak of crystallized Fe or a peak of a crystallized compound is read (Ic: Crystal scattering integrated intensity, Ia: Amorphous scattering integrated intensity). Then, a crystal ratio is obtained from the peak intensity, and the amorphous ratio X is calculated using the above-mentioned formula (A). Below describes the method for calculation in further detail.

A crystal structure analysis is carried out using XRD to the soft magnetic alloy powder according to the present embodiment, and a profile fitting is carried out using a Lorentz function to obtain a crystal component pattern which indicates a crystal scattering integrated intensity, an amorphous component pattern which indicates an amorphous scattering integrated intensity, and a pattern which is a combination of these two. From the crystal scattering integrated intensity and the amorphous scattering integrated intensity of the obtained patterns, the amorphous ratio X is obtained using the above-mentioned formula (A). Note that, a measurement range of a diffraction angle 20 in which amorphous-derived halos can be confirmed is within a range of 2σ=30° to 60°. Within this range, the difference between the integrated intensities actually measured using XRD and the integrated intensities calculated using the Lorentz function is within 1%.

There is no particular limitation regarding a method for determining whether the soft magnetic alloy powder has a structure made of crystals having a crystal particle diameter of larger than 50 nm, or a structure made of nanocrystals having a crystal particle size of 50 nm or less. Examples of the method include a method of calculating the crystal particle size by evaluating a size of a crystalline obtained by analyzing full width at half maximum, and a method of calculating the crystal particle size through observation using TEM.

A coating treatment may be carried out to the soft magnetic alloy powder, or a coating layer may be formed on the surface of the soft magnetic alloy powder. A material of the coating layer is not particularly limited. In the technical field of the present embodiment, generally used coating layers such as a phosphate-based coating layer and a silica-based coating layer may be used to form the coating. A thickness of the coating layer is not particularly limited. For example, it may be thicker than 0 nm and 50 nm or thinner, or 5 nm or thicker and 50 nm or thinner. The thicker the coating layer, the more easily the permeability decreases but the more easily the DC superimposition characteristic and the withstand voltage improve.

Below describes a method for producing the soft magnetic alloy powder according to the present embodiment.

A method for producing the soft magnetic alloy powder according to the present embodiment is not particularly limited. Below describes an example of using a water atomization method.

Below describes the method for producing the soft magnetic alloy powder using a water atomization method.

A water atomization device used in the present embodiment may be a conventionally used water atomization device. Note that, by using a special water atomization device shown below, the soft magnetic alloy powder which a particle size distribution F(x) based on volume represented by the plurality of probability density functions fᵢ(x) (i=1, 2, . . . , n) (n≥2), as mentioned in above, can be obtained.

The special water atomization device is similar to the conventionally used water atomization method except that the special water atomization method has a nozzle (hereinafter, this may be referred as a particle) for injecting water to the discharged molten metal droplets.

Also, an oxygen content of the soft magnetic alloy powder changes depending on a drying condition when the soft magnetic alloy powder collected from the water atomization device is dried. The drying condition is not particularly limited, and the atmosphere while drying may have an oxygen concentration of 5% or less, or 0.1% or less. Further, vacuum atmosphere is preferable, that is, atmosphere having an atmospheric pressure between 1×10⁻⁴ Pa and 1×10⁻² Pa is preferable. In the vacuum atmosphere, the oxygen concentration consequently becomes 0.1% or less. A drying temperature may be adjusted between 30° C. and 100° C., and also a drying time may be adjusted within 1 hour to 48 hours. The higher the oxygen concentration, the larger the oxygen content tends to be. The higher the drying temperature and the longer the drying time while drying, the larger the oxygen content tends to be. The smaller the particle size of the soft magnetic alloy powder, the larger the oxygen content tends to be.

In the conventionally used water atomization device, the same types of injection holes are arranged in equally spaced intervals. Further, water is continuously injected from each injection hole to form the molten metal droplets.

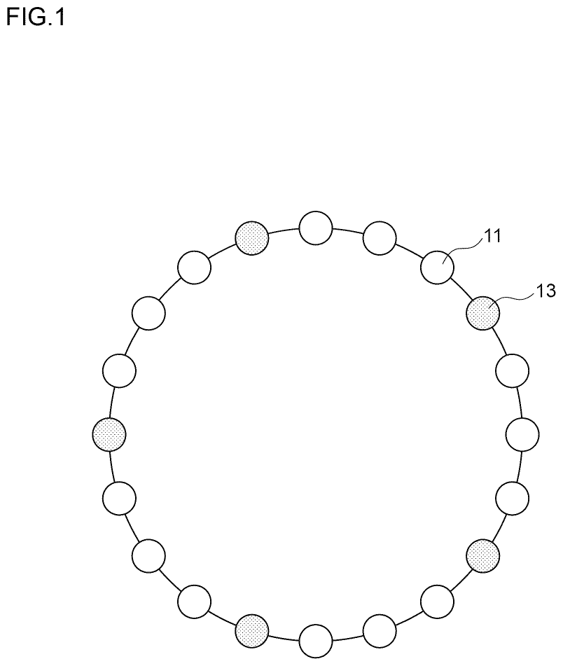

In the case of the special water atomization device, a continuous injection hole 11 are partially replaced with an intermittent injection hole 13. As shown in FIG. 1, the intermittent injection holes 13 are roughly arranged in equally spaced intervals. Also, a diameter of each injection hole is not particularly limited, and for example, it may be 0.3 mm or larger and 1.5 mm or smaller.

The continuous injection hole 11 injects water continuously on the molten metal droplets. The intermittent injection hole 13 periodically injects water in a certain time intervals.

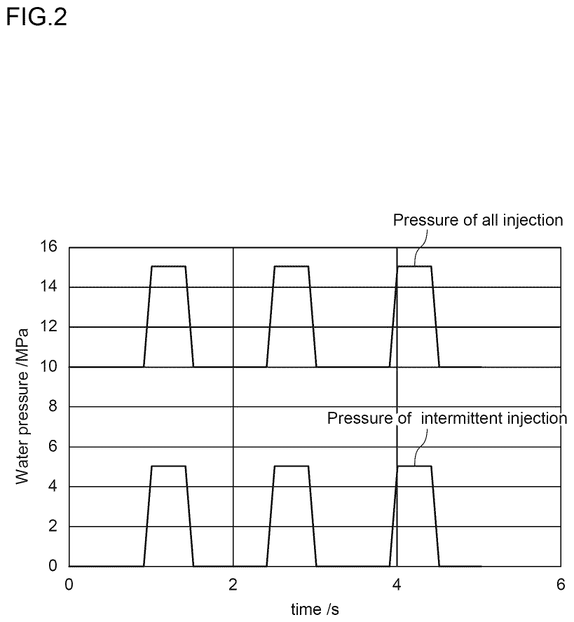

FIG. 2 shows one example of water pressure of injected water from the injection holes. The total water pressure of injected water from the plurality of intermittent injection holes 13 periodically changes between 0 MPa and 5 MPa in a certain time intervals. Hence, a total water pressure of injected water from all of the injection holes periodically changes between 10 MPa and 15 MPa.

By periodically changing the total water pressure injected from the injection holes, the soft magnetic alloy powder which the particle size distribution F(x) based on volume represented by the plurality of probability density functions fᵢ(x) (i=1, 2, . . . , n) (n≥2) can be obtained.

The soft magnetic alloy powder at this point is preferably made of amorphous and it does not include a crystal (nanocrystal).

The heat treatment is preferably carried out to the soft magnetic alloy powder made of amorphous obtained using the above-mentioned water atomization method. For example, by carrying out the heat treatment at a temperature between 450° C. and 650° C. for 1 to 120 minutes, the powder particles sinter with each other, and the powder particles are prevented from becoming coarse while facilitating dispersion of elements. Further, thermodynamic equilibrium state is achieved in short period of time, and strain and stress can be removed. Note that, the nanocrystal does not precipitate at this point.

The coating treatment may be performed to the soft magnetic alloy powder at any stage. A method of coating treatment is not particularly limited. In the technical field of the present embodiment, a generally used coating treatment can be used.

The use of the soft magnetic alloy powder according to the present embodiment is not particularly limited. When the soft magnetic alloy powder of the present embodiment is used for a composite material, a high permeability composite material can be obtained.

In the case of producing the composite material by using the conventional soft magnetic alloy powder, it is necessary to increase a filling factor of the soft magnetic alloy powder in order to obtain the composite material with a high permeability. However, when the filling factor is increased, the powder particles easily contact with each other, and the withstand voltage decreases; consequently, leading to increase of dielectric loss. By using the soft magnetic alloy powder according to the present embodiment, the composite material having a high permeability can be obtained without increasing the filling factor, and the withstand voltage improves.

Also, in the case of producing the magnetic core including the soft magnetic alloy powder according to the present embodiment, the soft magnetic alloy powder may be only used, or two or more types of powders which include the soft magnetic alloy powder according to the present embodiment may be used. The powder other than the soft magnetic alloy powder according to the present embodiment is not particularly limited. Examples include Fe powder, FeNi alloy powder, and FeCo alloy powder. Particularly, in the case that the other powder has a smaller particle size than the soft magnetic alloy powder according to the present embodiment, the filling factor of the powder in the magnetic device obtained at the end can be increased. A ratio of the soft magnetic alloy powder according to the present embodiment in the mixed powder is not particularly limited. For example, the ratio of the soft magnetic alloy powder in the mixed powder may be 20.0% or more, 50.0% or more, 75.0% or more, or 87.5% or more.

As an example, the composite material including the soft magnetic alloy powder according to the present embodiment include can be used as a magnetic core. The composite material can be used particularly suitably as a magnetic core for a powder inductor. Also, the soft magnetic alloy powder according to the present embodiment can be suitably used as a magnetic device such as a thin film inductor and a magnetic head. Further, the magnetic core and the magnetic device using the soft magnetic alloy powder can be suitably used for electronic apparatus.

### EXAMPLES

Below describes the present disclosure in detail based on examples.

### Experiment Example 1

Ingots of various materials were prepared and weighed to obtain a mother alloy satisfying the composition shown in Table 1A and Table 1B. Then, the ingots were housed in a crucible arranged in a water atomization device. Note that, in the present example, samples with no indication of an oxygen content had an oxygen content of about 1500 ppm unless mentioned otherwise.

Next, the mother alloy was housed in a heat-resistant container arranged in the water atomization device. Next, a cylinder was vacuumed, and the heat-resistant container was heated by high-frequency induction by using a heating coil provided outside of the heat-resistant container to obtain a molten metal (molten) by melting and mixing raw material metals in the heat-resistant container.

Regarding each sample shown in Table 1A, water was injected continuously from continuous injection holes at water pressure indicated in Table 1A to the molten at 1500° C. to collide water against the molten. Thereby, the molten was formed into molten droplets. A diameter of the continuous injection hole was 0.8 mm. The molten droplets were cooled using cooling water and formed a fine soft magnetic alloy powder; and then, the powder was collected. The collected soft magnetic alloy powder was dried. Drying was performed under a vacuumed atmosphere, a drying temperature was 50° C., and a drying time was 12 hours. An oil-sealed rotary pump was used to create a vacuumed atmosphere.

Regarding each sample shown in Tabe 1B, to the molten at 1500° C., water was continuously injected from the continuous injection holes at the water pressure shown in Table 1B and water was also injected intermittently from intermittent injection holes having a hole size shown in Table 1B at a water pressure, an injection time interval, and an injection time as shown in Table 1B. Thereby, water was collided against the molten, and then the molten was formed into molten droplets. A diameter of the continuous spray hole was 0.8 mm. The molten droplets were cooled using a cooling water to form a fine soft magnetic alloy powder. Then, the powder was collected.

An ICP analysis confirmed that the composition of the mother alloy and the composition of the soft magnetic alloy were about the same.

The obtained soft magnetic alloy powder was verified whether it included amorphous or nanocrystals. The peak derived from the nanocrystal was verified using XRD. Hereinafter, unless mentioned otherwise, the peak derived from the nanocrystal was not observed.

A particle size distribution F(x) of the obtained soft magnetic alloy powder was measured using a laser diffraction type particle size distribution analyzer (HELOS&RODOS (Sympatec)). From the obtained particle size distribution F(x), D10, D50, and D90 were determined.

Further, the particle size distribution F(x) of each soft magnetic alloy powder was shown using formulae (1) to (4). Specifically, fᵢ(x) was determined which was when F(x) was able to fit using one or more probability density functions fᵢ(x) shown by the formula (4). Then, n, μᵢ, and σⱼ at this point were determined, and when n was n≥2, Z=|exp(μ₁)−exp(μ₂)|/(D90−D10) was calculated. Results are shown in each table.

To each obtained soft magnetic alloy powder, a DSC measurement was performed using (STA449F3 (NETZSCH)). In Experiment example 1, the soft magnetic alloy powders of all of the examples were confirmed to have a crystallization temperature Tx, a glass transition temperature Tg, and a super cooled liquid range ΔTx.

A toroidal core was made from each soft magnetic alloy powder. Specifically, a phenol resin was mixed to each soft magnetic alloy powder to obtain a mixture of the sot magnetic alloy powder and the phenol resin. The phenol resin was adjusted to be 3 mass % of the mixture as a whole. Next, the mixture was stirred and granulated to obtain a granulated powder. Specifically, a generally used planetary mixer was used as a stirrer to obtain the granulated powder of 500 μm or so. Next, the obtained granulated powder was molded at a surface pressure of 4 ton/cm² (392 MPa); and thereby, a toroidal-shaped molded body having an outer diameter of 13 mmo, an inner diameter of 8 mmo, and a height of 6 mm was obtained. The obtained molded body was cured at 150° C. to obtain the toroidal core. Also, a cylinder-shaped molded body having a diameter of 8 mmo, and a height of 5 mm was made for a withstand voltage measurement. The obtained molded body was cured at 150° C. to obtain a cylinder-shaped core.

Then, a UEW wire was wound around the toroidal core, and a relative permeability was measured at 100 kHz by using 4284A PRECISION LCR METER (HP Development Company, L. P.). Results are shown in Tables 1A and 1B. In the case that the relative permeability was 10.0 or greater, it was considered good, and 15.0 or greater was considered even better.

In regards with the DC superimposition characteristic, a DC current was applied from 0 to the above-mentioned toroidal core, and inductance was measured. The value of DC current (Isat) was measured at which the inductance dropped to 10% of the starting value (dropped to one tenth of the starting value) from the inductance at 0 DC current. The inductance was measured by using 4284A PRECISION LCR METER (HP Development Company, L. P.) at a frequency of 100 kHz and a measuring current of 0.3 mA. Results are shown in each Table. When Isat was 5.5 A or greater, it was considered that the DC superimposition characteristic was good.

For the withstand voltage measurement, an In—Ga electrode was formed on each end surface of the cylinder-shaped core. Next, voltage was applied to the cylinder-shaped core using a withstand voltage tester (THK-2011ADMPT made by TAMADENSOKU CO., LTD.), and the voltage at which current of 1 mA flew was observed. Then, the measured voltage was divided by a height of the cylinder-shaped core (the distance between the end faces of the cylinder-shaped core); thereby, the withstand voltage of the cylinder-shaped core was measured.

TABLE 1A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Comparative | Fe_{47.60}Co_{20.40}B_{15.00}P_{12.00}Si_{5.00} | 1.29 | 24 | N/A | | | | 1 |
| example 1 | | | | | | | | |
| Example 2 | Fe_{49.00}Co_{21.00}B_{13.00}P_{12.00}Si_{5.00} | 1.31 | 24 | N/A | | | | 1 |
| Example 3 | Fe_{50.40}Co_{21.60}B_{11.00}P_{12.00}Si_{5.00} | 1.33 | 24 | N/A | | | | 1 |
| Example 4 | Fe_{51.80}Co_{22.20}B_{11.00}P_{10.00}Si_{5.00} | 1.37 | 24 | N/A | | | | 1 |
| Example 5 | Fe_{53.20}Co_{22.80}B_{11.00}P_{9.00}Si_{4.00} | 1.42 | 24 | N/A | | | | 1 |
| Example 6 | Fe_{54.60}Co_{23.40}B_{11.00}P_{8.00}Si_{3.00} | 1.50 | 24 | N/A | | | | 1 |
| Example 7 | Fe_{56.00}Co_{24.00}B_{11.00}P_{7.00}Si_{2.00} | 1.59 | 24 | N/A | | | | 1 |
| Example 8 | Fe_{57.40}Co_{24.60}B_{11.00}P_{5.00}Si_{2.00} | 1.70 | 24 | N/A | | | | 1 |
| Example 9 | Fe_{58.80}Co_{25.20}B_{11.00}P_{4.00}Si_{1.00} | 1.82 | 24 | N/A | | | | 1 |
| Example 10 | Fe_{60.20}Co_{25.80}B_{10.00}P_{3.00}Si_{1.00} | 1.90 | 24 | N/A | | | | 1 |
| Example 11 | Fe_{61.60}Co_{26.40}B_{9.00}P_{2.00}Si_{1.00} | 1.96 | 24 | N/A | | | | 1 |
| Example 12 | Fe_{63.00}Co_{27.00}B_{7.50}P_{1.56}Si_{1.00} | 2.00 | 24 | N/A | | | | 1 |
| Example 13 | Fe_{64.40}Co_{27.60}B_{6.50}P_{0.50}Si_{1.00} | 2.03 | 24 | N/A | | | | 1 |
| Example 14 | Fe_{65.80}Co_{28.20}B_{4.50}P_{0.50}Si_{1.00} | 2.07 | 24 | N/A | | | | 1 |
| Example 15 | Fe_{67.20}Co_{28.80}B_{3.50}P_{0.50} | 2.13 | 24 | N/A | | | | 1 |
| Comparative | Fe_{67.90}Co_{29.10}B_{2.50}P_{0.50} | 2.15 | 24 | N/A | | | | 1 |
| example 16 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Comparative | 24.2 | 41.6 | 14.2 | 3.4 | — | — | 0.4 | — | 29.0 | 4.2 | 280 |
| example 1 | | | | | | | | | | | |
| Example 2 | 24.2 | 41.5 | 14.2 | 3.5 | — | — | 0.4 | — | 29.7 | 5.5 | 330 |
| Example 3 | 24.3 | 41.7 | 14.1 | 3.5 | — | — | 0.4 | — | 30.3 | 6.7 | 370 |
| Example 4 | 24.3 | 41.6 | 14.1 | 3.4 | — | — | 0.4 | — | 31.7 | 8.6 | 380 |
| Example 5 | 24.3 | 41.6 | 14.2 | 3.4 | — | — | 0.4 | — | 33.1 | 9.9 | 390 |
| Example 6 | 24.3 | 41.5 | 14.2 | 3.5 | — | — | 0.4 | — | 33.4 | 11.0 | 385 |
| Example 7 | 24.2 | 41.7 | 14.2 | 3.4 | — | — | 0.4 | — | 34.2 | 11.0 | 380 |
| Example 8 | 24.3 | 41.5 | 14.2 | 3.4 | — | — | 0.4 | — | 33.9 | 10.3 | 370 |
| Example 9 | 24.2 | 41.5 | 14.1 | 3.5 | — | — | 0.4 | — | 33.3 | 9.2 | 350 |
| Example 10 | 24.2 | 41.6 | 14.2 | 3.5 | — | — | 0.4 | — | 31.1 | 8.6 | 340 |
| Example 11 | 24.3 | 41.7 | 14.2 | 3.5 | — | — | 0.4 | — | 27.2 | 8.1 | 330 |
| Example 12 | 24.2 | 41.5 | 14.1 | 3.5 | — | — | 0.4 | — | 22.3 | 7.7 | 325 |
| Example 13 | 24.4 | 41.7 | 14.1 | 3.4 | — | — | 0.4 | — | 19.6 | 7.3 | 320 |
| Example 14 | 24.3 | 41.7 | 14.2 | 3.5 | — | — | 0.4 | — | 18.1 | 6.8 | 315 |
| Example 15 | 24.2 | 41.6 | 14.1 | 3.5 | — | — | 0.4 | — | 16.8 | 5.8 | 310 |
| Comparative | 24.2 | 41.6 | 14.1 | 3.4 | — | — | 0.4 | — | 15.9 | 5.2 | 180 |
| example 16 | | | | | | | | | | | |

TABLE 1B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Comparative | Fe_{47.60}Co_{20.40}B_{15.00}P_{12.00}Si_{5.00} | 1.29 | 20 | 0.3 | 10 | 0.5 | 0.5 | 3 |
| example 17 | | | | | | | | |
| Example 18 | Fe_{49.00}Co_{21.00}B_{13.00}P_{12.00}Si_{5.00} | 1.31 | 20 | 0.3 | 10 | 0.5 | 0.5 | 3 |
| Example 19 | Fe_{50.40}Co_{21.60}B_{11.00}P_{12.00}Si_{5.00} | 1.33 | 20 | 0.3 | 10 | 0.5 | 0.5 | 3 |
| Example 20 | Fe_{51.80}Co_{22.20}B_{11.00}P_{10.00}Si_{5.00} | 1.37 | 20 | 0.3 | 10 | 0.5 | 0.5 | 3 |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 22 | Fe_{54.60}Co_{23.40}B_{11.00}P_{8.00}Si_{3.00} | 1.50 | 20 | 0.3 | 10 | 0.5 | 0.5 | 3 |
| Example 23 | Fe_{56.00}Co_{24.00}B_{11.00}P_{7.00}Si_{2.00} | 1.59 | 20 | 0.3 | 10 | 0.5 | 0.5 | 3 |
| Example 24 | Fe_{57.40}Co_{24.60}B_{11.00}P_{5.00}Si_{2.00} | 1.70 | 20 | 0.3 | 10 | 0.5 | 0.5 | 3 |
| Example 25 | Fe_{58.80}Co_{25.20}B_{11.00}P_{4.00}Si_{1.00} | 1.82 | 20 | 0.3 | 10 | 0.5 | 0.5 | 3 |
| Example 26 | Fe_{60.20}Co_{25.80}B_{10.00}P_{3.00}Si_{1.00} | 1.90 | 20 | 0.3 | 10 | 0.5 | 0.5 | 3 |
| Example 27 | Fe_{61.60}Co_{26.40}B_{9.00}P_{2.00}Si_{1.00} | 1.96 | 20 | 0.3 | 10 | 0.5 | 0.5 | 3 |
| Example 28 | Fe_{63.00}Co_{27.00}B_{7.50}P_{1.50}Si_{1.00} | 2.00 | 20 | 0.3 | 10 | 0.5 | 0.5 | 3 |
| Example 29 | Fe_{64.40}Co_{27.60}B_{6.50}P_{0.50}Si_{1.00} | 2.03 | 20 | 0.3 | 10 | 0.5 | 0.5 | 3 |
| Example 30 | Fe_{65.80}Co_{28.20}B_{4.50}P_{0.50}Si_{1.00} | 2.07 | 20 | 0.3 | 10 | 0.5 | 0.5 | 3 |
| Example 31 | Fe_{67.20}Co_{28.80}B_{3.50}P_{0.50} | 2.13 | 20 | 0.3 | 10 | 0.5 | 0.5 | 3 |
| Comparative | Fe_{67.90}Co_{29.10}B_{2.50}P_{0.50} | 2.15 | 20 | 0.3 | 10 | 0.5 | 0.5 | 3 |
| example 32 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Comparative | 24.7 | 50.0 | 10.2 | 3.2 | 3.9 | 0.7 | 0.5 | 0.4 | 29.8 | 4.3 | 289 |
| example 17 | | | | | | | | | | | |
| Example 18 | 24.5 | 49.8 | 10.2 | 3.1 | 3.8 | 0.6 | 0.6 | 0.4 | 30.5 | 5.7 | 403 |
| Example 19 | 24.6 | 49.9 | 10.1 | 3.1 | 3.8 | 0.5 | 0.5 | 0.4 | 31.2 | 6.8 | 460 |
| Example 20 | 24.6 | 49.8 | 10.3 | 3.0 | 3.9 | 0.7 | 0.4 | 0.4 | 32.7 | 8.8 | 462 |
| Example 21 | 24.6 | 49.9 | 10.2 | 3.1 | 3.8 | 0.6 | 0.5 | 0.4 | 34.1 | 10.2 | 476 |
| Example 22 | 24.6 | 49.9 | 10.3 | 3.2 | 3.8 | 0.6 | 0.6 | 0.4 | 34.3 | 11.3 | 467 |
| Example 23 | 24.6 | 49.8 | 10.2 | 3.1 | 3.8 | 0.6 | 0.6 | 0.4 | 35.2 | 11.3 | 466 |
| Example 24 | 24.7 | 49.8 | 10.3 | 3.2 | 3.8 | 0.5 | 0.4 | 0.4 | 35.0 | 10.5 | 460 |
| Example 25 | 24.6 | 49.9 | 10.2 | 3.2 | 3.8 | 0.5 | 0.6 | 0.3 | 32.8 | 9.4 | 432 |
| Example 26 | 24.6 | 50.0 | 10.3 | 3.0 | 3.7 | 0.5 | 0.5 | 0.5 | 32.0 | 8.8 | 419 |
| Example 27 | 24.7 | 49.9 | 10.1 | 3.1 | 3.9 | 0.7 | 0.6 | 0.3 | 28.0 | 8.3 | 400 |
| Example 28 | 24.6 | 49.9 | 10.3 | 3.1 | 3.9 | 0.7 | 0.4 | 0.4 | 23.0 | 7.9 | 390 |
| Example 29 | 24.5 | 50.0 | 10.2 | 3.1 | 3.8 | 0.5 | 0.5 | 0.4 | 20.3 | 7.5 | 392 |
| Example 30 | 24.5 | 49.8 | 10.2 | 3.2 | 3.9 | 0.6 | 0.5 | 0.3 | 18.7 | 7.0 | 387 |
| Example 31 | 24.6 | 49.9 | 10.2 | 3.1 | 3.9 | 0.7 | 0.5 | 0.4 | 17.3 | 6.0 | 372 |
| Comparative | 24.6 | 50.0 | 10.3 | 3.1 | 3.8 | 0.6 | 0.5 | 0.4 | 16.4 | 5.4 | 216 |
| example 32 | | | | | | | | | | | |

Table 1A shows samples on which water was applied at a constant pressure using a water atomization device. Table 1B shows samples on which the compositions were the same as the samples shown in Table 1A; however, the water pressure was periodically changed using the water atomization device.

In the case that the composition was within a predetermined range, Bs, a relative permeability, the DC superimposition characteristic, and the withstand voltage were all good. Regarding Comparative examples 1 and 17 in which a content of B was too large, Bs, the DC superimposition characteristic, and the withstand voltage decreased. Comparative examples 16 and 32 in which a total content Fe and Co was too large, the DC superimposition characteristic and the withstand voltage decreased.

When the cases having the same compositions but with different water injecting conditions were compared, the soft magnetic alloy powders of all of the examples shown in Table 1B exhibited enhanced DC superimposition characteristic and withstand voltage compared to the soft magnetic alloy powders of the examples shown in Table 1A. The relative permeabilities were about the same.

The soft magnetic alloy powders shown in Table 1A all had n=1. That is, the soft magnetic alloy powders shown in Table 1A were those which the particle size distribution was expressed by only one probability density function. The soft magnetic alloy powders shown in Table 1B all had n=3. That is, the soft magnetic alloy powders shown in Table 1B were those which the particle size distribution was expressed by using a plurality of probability density functions. Further, in regards with the soft magnetic alloy powders of the examples shown in Table 1B, Z, σ₁, and σ₂ were within the predetermined ranges. Because of this, it is speculated that the DC superimposition characteristic and the withstand voltage of the soft magnetic alloy powders of the examples shown in Table 1B were enhanced compared to those of the soft magnetic alloy powders shown in Table 1A.

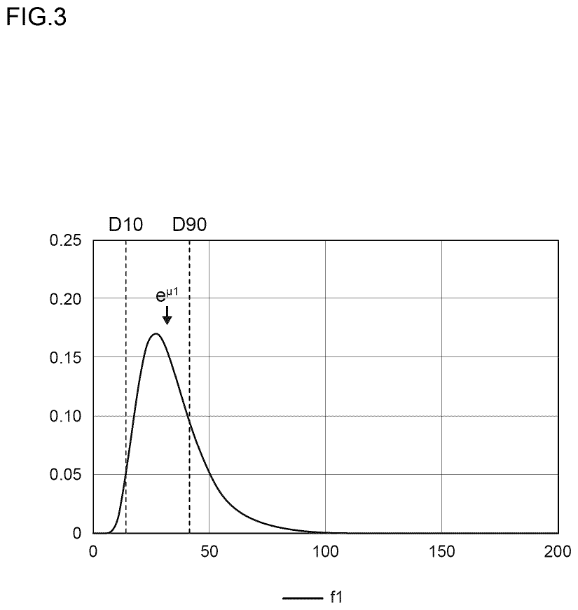

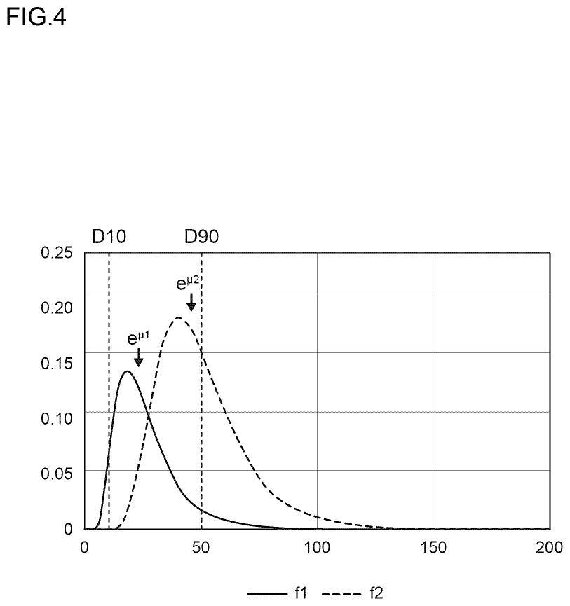

The graph of FIG. 3 shows f₁(x) of Example 5. The graph of FIG. 4 shows fᵢ(x) and f₂(x) of Example 21. In FIG. 4, f₃(x) is omitted. For all of the graphs, the horizontal axis is the particle size (unit: μm), and the vertical axis is the probability density.

### Experiment Example 2

Experiment example 2 was carried out under the same conditions as Example 21 of Experiment example 1 except that the compositions of the soft magnetic alloy powders were changed. Results are shown in Tables 2A and 2B.

TABLE 2A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Comparative | Fe_{53.20}Co_{22.80}B_{21.00}P_{3.00} | 1.55 | 20 | 0.3 | 10 | 0.5 | 0.5 | 3 |
| example 33 | | | | | | | | |
| Example 34 | Fe_{53.20}Co_{22.80}B_{20.00}P_{3.00}Si_{1.00} | 1.53 | 20 | 0.3 | 10 | 0.5 | 0.5 | 3 |
| Example 35 | Fe_{53.20}Co_{22.80}B_{18.00}P_{5.00}Si_{1.00} | 1.49 | 20 | 0.3 | 10 | 0.5 | 0.5 | 3 |
| Example 36 | Fe_{53.20}Co_{22.80}B_{15.00}P_{7.00}Si_{2.00} | 1.45 | 20 | 0.3 | 10 | 0.5 | 0.5 | 3 |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 37 | Fe_{53.20}Co_{22.80}B_{9.00}P_{10.00}Si_{5.00} | 1.41 | 20 | 0.3 | 10 | 0.5 | 0.5 | 3 |
| Example 38 | Fe_{53.20}Co_{22.80}B_{7.00}P_{11.00}Si_{6.00} | 1.40 | 20 | 0.3 | 10 | 0.5 | 0.5 | 3 |
| Example 39 | Fe_{53.20}Co_{22.80}B_{5.00}P_{12.00}Si_{7.00} | 1.38 | 20 | 0.3 | 10 | 0.5 | 0.5 | 3 |
| Example 40 | Fe_{53.20}Co_{22.80}B_{3.00}P_{13.00}Si_{7.00}C_{1.00} | 1.37 | 20 | 0.3 | 10 | 0.5 | 0.5 | 3 |
| Example 41 | Fe_{53.20}Co_{22.80}B_{2.00}P_{13.00}Si_{7.00}C_{2.00} | 1.37 | 20 | 0.3 | 10 | 0.5 | 0.5 | 3 |
| Comparative | Fe_{53.20}Co_{22.80}B_{1.00}P_{13.00}Si_{7.00}C_{3.00} | 1.37 | 20 | 0.3 | 10 | 0.5 | 0.5 | 3 |
| example 42 | | | | | | | | |
| Example 43 | Fe_{53.20}Co_{22.80}B_{20.00}P_{0.00}Si_{4.00} | 1.53 | 20 | 0.3 | 10 | 0.5 | 0.5 | 3 |
| Example 44 | Fe_{53.20}Co_{22.80}B_{18.00}P_{2.00}Si_{4.00} | 1.50 | 20 | 0.3 | 10 | 0.5 | 0.5 | 3 |
| Example 45 | Fe_{53.20}Co_{22.80}B_{16.00}P_{4.00}Si_{4.00} | 1.47 | 20 | 0.3 | 10 | 0.5 | 0.5 | 3 |
| Example 46 | Fe_{53.20}Co_{22.80}B_{14.00}P_{6.00}Si_{4.00} | 1.45 | 20 | 0.3 | 10 | 0.5 | 0.5 | 3 |
| Example 47 | Fe_{53.20}Co_{22.80}B_{12.00}P_{8.00}Si_{4.00} | 1.43 | 20 | 0.3 | 10 | 0.5 | 0.5 | 3 |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 48 | Fe_{53.20}Co_{22.80}B_{10.00}P_{10.00}Si_{4.00} | 1.42 | 20 | 0.3 | 10 | 0.5 | 0.5 | 3 |
| Example 49 | Fe_{53.20}Co_{22.80}B_{9.00}P_{11.00}Si_{4.00} | 1.41 | 20 | 0.3 | 10 | 0.5 | 0.5 | 3 |
| Example 50 | Fe_{53.20}Co_{22.80}B_{8.00}P_{12.00}Si_{4.00} | 1.41 | 20 | 0.3 | 10 | 0.5 | 0.5 | 3 |
| Example 51 | Fe_{53.20}Co_{22.80}B_{6.00}P_{14.00}Si_{4.00} | 1.39 | 20 | 0.3 | 10 | 0.5 | 0.5 | 3 |
| Comparative | Fe_{53.20}Co_{22.80}B_{5.00}P_{15.00}Si_{4.00} | 1.38 | 20 | 0.3 | 10 | 0.5 | 0.5 | 3 |
| example 52 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Comparative | 24.7 | 49.8 | 10.3 | 3.1 | 3.8 | 0.6 | 0.5 | 0.3 | 19.5 | 11.4 | 180 |
| example 33 | | | | | | | | | | | |
| Example 34 | 24.6 | 50.0 | 10.1 | 3.1 | 3.8 | 0.6 | 0.5 | 0.4 | 20.0 | 11.4 | 405 |
| Example 35 | 24.6 | 49.9 | 10.3 | 3.1 | 3.9 | 0.6 | 0.5 | 0.4 | 25.0 | 11.2 | 435 |
| Example 36 | 24.6 | 49.9 | 10.2 | 3.1 | 3.8 | 0.6 | 0.5 | 0.4 | 32.0 | 10.8 | 460 |
| Example 21 | 24.6 | 49.9 | 10.2 | 3.1 | 3.8 | 0.6 | 0.5 | 0.4 | 34.1 | 10.2 | 476 |
| Example 37 | 24.6 | 50.0 | 10.3 | 3.1 | 3.9 | 0.7 | 0.5 | 0.5 | 34.0 | 9.9 | 470 |
| Example 38 | 24.6 | 49.9 | 10.1 | 3.1 | 3.9 | 0.6 | 0.5 | 0.3 | 33.5 | 9.6 | 465 |
| Example 39 | 24.7 | 49.9 | 10.1 | 3.1 | 3.8 | 0.6 | 0.5 | 0.4 | 33.0 | 9.0 | 445 |
| Example 40 | 24.6 | 49.9 | 10.3 | 3.1 | 3.7 | 0.5 | 0.5 | 0.4 | 30.0 | 8.6 | 434 |
| Example 41 | 24.6 | 49.9 | 10.3 | 3.1 | 3.8 | 0.6 | 0.5 | 0.4 | 25.0 | 8.6 | 420 |
| Comparative | 24.6 | 49.9 | 10.2 | 3.1 | 3.9 | 0.7 | 0.5 | 0.3 | 22.0 | 8.6 | 222 |
| example 42 | | | | | | | | | | | |
| Example 43 | 24.5 | 49.9 | 10.3 | 3.1 | 3.8 | 0.6 | 0.5 | 0.4 | 17.0 | 11.4 | 450 |
| Example 44 | 24.6 | 49.9 | 10.2 | 3.1 | 3.8 | 0.5 | 0.5 | 0.4 | 25.0 | 11.3 | 455 |
| Example 45 | 24.6 | 49.8 | 10.2 | 3.1 | 3.8 | 0.5 | 0.5 | 0.3 | 30.0 | 11.0 | 463 |
| Example 46 | 24.7 | 49.9 | 10.2 | 3.1 | 3.9 | 0.6 | 0.5 | 0.4 | 33.0 | 10.7 | 470 |
| Example 47 | 24.6 | 49.9 | 10.2 | 3.1 | 3.9 | 0.6 | 0.5 | 0.4 | 34.3 | 10.4 | 473 |
| Example 21 | 24.6 | 49.9 | 10.2 | 3.1 | 3.8 | 0.6 | 0.5 | 0.4 | 34.1 | 10.2 | 476 |
| Example 48 | 24.6 | 49.9 | 10.3 | 3.1 | 3.8 | 0.6 | 0.5 | 0.3 | 33.1 | 10.0 | 469 |
| Example 49 | 24.7 | 49.8 | 10.2 | 3.1 | 3.8 | 0.6 | 0.5 | 0.3 | 32.0 | 9.9 | 452 |
| Example 50 | 24.6 | 50.0 | 10.2 | 3.1 | 3.9 | 0.7 | 0.5 | 0.4 | 28.0 | 9.8 | 432 |
| Example 51 | 24.7 | 50.0 | 10.3 | 3.1 | 3.9 | 0.7 | 0.5 | 0.4 | 25.0 | 9.3 | 403 |
| Comparative | 24.7 | 49.8 | 10.2 | 3.1 | 3.7 | 0.5 | 0.5 | 0.3 | 23.0 | 9.0 | 260 |
| example 52 | | | | | | | | | | | |

TABLE 2B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 53 | Fe_{53.20}Co_{22.80}B_{13.00}P_{11.00} | 1.44 | 20 | 0.3 | 10 | 0.5 | 0.5 | 3 |
| Example 54 | Fe_{53.20}Co_{22.80}B_{12.00}P_{10.00}Si_{2.00} | 1.43 | 20 | 0.3 | 10 | 0.5 | 0.5 | 3 |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 55 | Fe_{53.20}Co_{22.86}B_{10.00}P_{8.00}Si_{6.00} | 1.42 | 20 | 0.3 | 10 | 0.5 | 0.5 | 3 |
| Example 56 | Fe_{53.20}Co_{22.80}B_{9.00}P_{7.00}Si_{8.00} | 1.41 | 20 | 0.3 | 10 | 0.5 | 0.5 | 3 |
| Example 57 | Fe_{53.20}Co_{22.80}B_{8.00}P_{6.00}Si_{10.00} | 1.41 | 20 | 0.3 | 10 | 0.5 | 0.5 | 3 |
| Comparative | Fe_{53.20}Co_{22.80}B_{8.00}P_{5.00}Si_{11.00} | 1.41 | 20 | 0.3 | 10 | 0.5 | 0.5 | 3 |
| example 58 | | | | | | | | |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 59 | Fe_{53.19}Co_{22.80}B_{11.00}P_{9.00}S_{14.00}C_{0.01} | 1.42 | 20 | 0.3 | 10 | 0.5 | 0.5 | 3 |
| Example 60 | Fe_{53.17}Co_{22.79}B_{11.00}P_{9.00}Si_{4.00}C_{0.05} | 1.42 | 20 | 0.3 | 10 | 0.5 | 0.5 | 3 |
| Example 61 | Fe_{53.13}Co_{22.77}B_{11.00}P_{9.00}Si_{4.00}C_{0.10} | 1.42 | 20 | 0.3 | 10 | 0.5 | 0.5 | 3 |
| Example 62 | Fe_{52.99}Co_{22.71}B_{11.00}P_{9.00}S_{14.00}C_{0.30} | 1.42 | 20 | 0.3 | 10 | 0.5 | 0.5 | 3 |
| Example 63 | Fe_{52.85}Co_{22.65}B_{11.00}P_{9.00}Si_{4.00}C_{0.50} | 1.41 | 20 | 0.3 | 10 | 0.5 | 0.5 | 3 |
| Example 64 | Fe_{52.50}Co_{22.58}B_{11.00}P_{9.00}Si_{4.00}C_{1.00} | 1.41 | 20 | 0.3 | 10 | 0.5 | 0.5 | 3 |
| Example 65 | Fe_{51.10}Co_{21.90}B_{11.00}P_{9.00}Si_{4.00}C_{3.00} | 1.40 | 20 | 0.3 | 10 | 0.5 | 0.5 | 3 |
| Example 66 | Fe_{49.70}Co_{21.30}B_{11.00}P_{9.00}Si_{4.00}C_{5.00} | 1.39 | 20 | 0.3 | 10 | 0.5 | 0.5 | 3 |
| Comparative | Fe_{49.00}Co_{21.00}B_{11.00}P_{9.00}Si_{4.00}C_{6.00} | 1.38 | 20 | 0.3 | 10 | 0.5 | 0.5 | 3 |
| example 67 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 53 | 24.5 | 49.9 | 10.3 | 3.1 | 3.8 | 0.5 | 0.5 | 0.5 | 34.2 | 10.6 | 460 |
| Example 54 | 24.7 | 50.0 | 10.1 | 3.1 | 3.8 | 0.5 | 0.5 | 0.3 | 34.3 | 10.4 | 470 |
| Example 21 | 24.6 | 49.9 | 10.2 | 3.1 | 3.8 | 0.6 | 0.5 | 0.4 | 34.1 | 10.2 | 476 |
| Example 55 | 24.6 | 49.9 | 10.2 | 3.1 | 3.8 | 0.5 | 0.5 | 0.3 | 33.9 | 10.0 | 465 |
| Example 56 | 24.6 | 49.8 | 10.2 | 3.1 | 3.9 | 0.7 | 0.5 | 0.4 | 31.0 | 9.9 | 446 |
| Example 57 | 24.7 | 49.8 | 10.3 | 3.1 | 3.9 | 0.7 | 0.5 | 0.4 | 25.0 | 9.3 | 410 |
| Comparative | 24.7 | 49.9 | 10.2 | 3.1 | 3.9 | 0.7 | 0.5 | 0.4 | 22.0 | 9.0 | 230 |
| example 58 | | | | | | | | | | | |
| Example 21 | 24.6 | 49.9 | 10.2 | 3.1 | 3.8 | 0.6 | 0.5 | 0.4 | 34.1 | 10.2 | 476 |
| Example 59 | 24.6 | 49.9 | 10.3 | 3.1 | 3.9 | 0.7 | 0.5 | 0.4 | 34.0 | 10.2 | 473 |
| Example 60 | 24.6 | 49.9 | 10.3 | 3.1 | 3.8 | 0.6 | 0.5 | 0.4 | 33.9 | 10.2 | 472 |
| Example 61 | 24.6 | 49.8 | 10.3 | 3.1 | 3.8 | 0.5 | 0.5 | 0.4 | 33.8 | 10.2 | 470 |
| Example 62 | 24.7 | 49.9 | 10.2 | 3.1 | 3.8 | 0.6 | 0.5 | 0.3 | 33.5 | 10.0 | 468 |
| Example 63 | 24.6 | 49.8 | 10.3 | 3.1 | 3.9 | 0.7 | 0.5 | 0.4 | 33.0 | 10.0 | 463 |
| Example 64 | 24.7 | 49.9 | 10.2 | 3.1 | 3.8 | 0.5 | 0.5 | 0.3 | 31.2 | 9.9 | 458 |
| Example 65 | 24.7 | 49.8 | 10.1 | 3.1 | 3.9 | 0.7 | 0.5 | 0.4 | 26.0 | 9.6 | 443 |
| Example 66 | 24.6 | 49.8 | 10.3 | 3.1 | 3.9 | 0.6 | 0.5 | 0.5 | 22.0 | 9.3 | 418 |
| Comparative | 24.6 | 49.9 | 10.3 | 3.1 | 3.8 | 0.5 | 0.5 | 0.4 | 19.0 | 9.0 | 280 |
| example 67 | | | | | | | | | | | |

Each example having a composition within a predetermined range exhibited good properties. On the contrary to this, the withstand voltage significantly decreased in the case of Comparative example 33 where the content of B was too large, Comparative example 42 where the content of B was too small, Comparative example 52 where the content of P was too large, Comparative example 58 where the content of Si was too large, and Comparative example 67 where the content of C was too large.

### Experiment Example 3

Experiment example 3 was carried out under the same conditions as Examples 19 to 24 of Experiment example 1 except that a composition of the soft magnetic alloy powder was changed. Results are shown in Tables 3A and 3B.

TABLE 3A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 68 | Fe_{72.00}B_{11.00}P_{12.00}Si_{5.00} | 1.42 | 20 | 0.3 | 10 | 0.5 | 0.5 | 3 |
| Example 69 | Fe_{68.40}Co_{3.60}B_{11.00}P_{12.00}Si_{5.00} | 1.41 | 20 | 0.3 | 10 | 0.5 | 0.5 | 3 |
| Example 70 | Fe_{64.80}Co_{7.20}B_{11.00}P_{12.00}Si_{5.00} | 1.40 | 20 | 0.3 | 10 | 0.5 | 0.5 | 3 |
| Example 71 | Fe_{57.60}Co_{14.40}B_{11.00}P_{12.00}Si_{5.00} | 1.36 | 20 | 0.3 | 10 | 0.5 | 0.5 | 3 |
| Example 19 | Fe_{50.40}Co_{21.60}B_{11.00}P_{12.00}Si_{5.00} | 1.33 | 20 | 0.3 | 10 | 0.5 | 0.5 | 3 |
| Example 72 | Fe_{43.20}Co_{28.80}B_{11.00}P_{12.00}Si_{5.00} | 1.32 | 20 | 0.3 | 10 | 0.5 | 0.5 | 3 |
| Example 73 | Fe_{36.00}Co_{36.00}B_{11.00}P_{12.00}Si_{5.00} | 1.31 | 20 | 0.3 | 10 | 0.5 | 0.5 | 3 |
| Comparative | Fe_{28.80}Co_{43.20}B_{11.00}P_{12.00}Si_{5.00} | 1.29 | 20 | 0.3 | 10 | 0.5 | 0.5 | 3 |
| example 74 | | | | | | | | |
| Example 75 | Fe_{74.00}B_{11.00}P_{10.00}Si_{5.00} | 1.47 | 20 | 0.3 | 10 | 0.5 | 0.5 | 3 |
| Example 76 | Fe_{70.30}Co_{3.70}B_{11.00}P_{10.00}Si_{5.00} | 1.46 | 20 | 0.3 | 10 | 0.5 | 0.5 | 3 |
| Example 77 | Fe_{66.50}Co_{7.40}B_{11.00}P_{10.00}Si_{5.00} | 1.45 | 20 | 0.3 | 10 | 0.5 | 0.5 | 3 |
| Example 78 | Fe_{59.20}Co_{14.80}B_{11.00}P_{10.00}Si_{5.00} | 1.40 | 20 | 0.3 | 10 | 0.5 | 0.5 | 3 |
| Example 20 | Fe_{51.80}Co_{22.20}B_{11.00}P_{10.00}Si_{5.00} | 1.37 | 20 | 0.3 | 10 | 0.5 | 0.5 | 3 |
| Example 79 | Fe_{44.40}Co_{29.60}B_{11.00}P_{10.00}Si_{5.00} | 1.36 | 20 | 0.3 | 10 | 0.5 | 0.5 | 3 |
| Example 80 | Fe_{37.00}Co_{37.00}B_{11.00}P_{10.00}Si_{5.00} | 1.34 | 20 | 0.3 | 10 | 0.5 | 0.5 | 3 |
| Comparative | Fe_{29.60}Co_{44.40}B_{11.00}P_{10.00}Si_{5.00} | 1.33 | 20 | 0.3 | 10 | 0.5 | 0.5 | 3 |
| example 81 | | | | | | | | |
| Example 82 | Fe_{76.00}B_{11.00}P_{9.00}Si_{4.00} | 1.52 | 20 | 0.3 | 10 | 0.5 | 0.5 | 3 |
| Example 83 | Fe_{72.20}Co_{3.80}B_{11.00}P_{9.00}Si_{4.00} | 1.51 | 20 | 0.3 | 10 | 0.5 | 0.5 | 3 |
| Example 84 | Fe_{68.40}Co_{7.60}B_{11.00}P_{9.00}Si_{4.00} | 1.50 | 20 | 0.3 | 10 | 0.5 | 0.5 | 3 |
| Example 85 | Fe_{60.80}Co_{15.20}B_{11.00}P_{9.00}Si_{4.00} | 1.46 | 20 | 0.3 | 10 | 0.5 | 0.5 | 3 |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 86 | Fe_{45.60}Co_{30.40}B_{11.00}P_{9.00}Si_{4.00} | 1.40 | 20 | 0.3 | 10 | 0.5 | 0.5 | 3 |
| Example 87 | Fe_{38.00}Co_{33.00}B_{11.00}P_{9.00}Si_{4.00} | 1.36 | 20 | 0.3 | 10 | 0.5 | 0.5 | 3 |
| Comparative | Fe_{30.40}Co_{45.60}B_{11.00}P_{9.00}Si_{4.00} | 1.35 | 20 | 0.3 | 10 | 0.5 | 0.5 | 3 |
| example 88 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 68 | 24.6 | 49.9 | 10.3 | 3.1 | 3.8 | 0.5 | 0.5 | 0.3 | 34.1 | 10.2 | 425 |
| Example 69 | 24.6 | 50.0 | 10.2 | 3.1 | 3.7 | 0.5 | 0.5 | 0.3 | 33.8 | 9.9 | 435 |
| Example 70 | 24.6 | 49.8 | 10.1 | 3.1 | 3.8 | 0.5 | 0.5 | 0.3 | 33.5 | 9.6 | 449 |
| Example 71 | 24.7 | 49.8 | 10.3 | 3.1 | 3.8 | 0.6 | 0.5 | 0.3 | 32.3 | 8.2 | 458 |
| Example 19 | 24.6 | 49.9 | 10.1 | 3.1 | 3.8 | 0.5 | 0.5 | 0.4 | 31.2 | 6.8 | 460 |
| Example 72 | 24.7 | 49.9 | 10.2 | 3.1 | 3.8 | 0.6 | 0.5 | 0.4 | 30.9 | 6.3 | 435 |
| Example 73 | 24.6 | 49.8 | 10.2 | 3.1 | 3.9 | 0.6 | 0.5 | 0.4 | 30.2 | 5.5 | 401 |
| Comparative | 24.6 | 49.9 | 10.2 | 3.1 | 3.8 | 0.5 | 0.5 | 0.4 | 29.8 | 4.3 | 271 |
| example 74 | | | | | | | | | | | |
| Example 75 | 24.7 | 49.9 | 10.2 | 3.1 | 3.8 | 0.5 | 0.5 | 0.4 | 34.9 | 11.0 | 430 |
| Example 76 | 24.7 | 49.9 | 10.2 | 3.1 | 3.9 | 0.7 | 0.5 | 0.3 | 34.8 | 10.8 | 440 |
| Example 77 | 24.5 | 50.0 | 10.2 | 3.1 | 3.9 | 0.6 | 0.5 | 0.4 | 34.6 | 10.7 | 455 |
| Example 78 | 24.7 | 49.8 | 10.2 | 3.1 | 3.9 | 0.6 | 0.5 | 0.4 | 33.7 | 9.8 | 464 |
| Example 20 | 24.6 | 49.8 | 10.3 | 3.0 | 3.9 | 0.7 | 0.4 | 0.4 | 32.7 | 8.8 | 462 |
| Example 79 | 24.6 | 49.9 | 10.2 | 3.1 | 3.8 | 0.5 | 0.5 | 0.3 | 32.4 | 8.4 | 440 |
| Example 80 | 24.7 | 49.8 | 10.3 | 3.1 | 3.9 | 0.6 | 0.5 | 0.3 | 31.7 | 7.5 | 405 |
| Comparative | 24.7 | 49.9 | 10.1 | 3.1 | 3.8 | 0.6 | 0.5 | 0.3 | 31.3 | 7.0 | 273 |
| example 81 | | | | | | | | | | | |
| Example 82 | 24.5 | 49.9 | 10.2 | 3.1 | 3.8 | 0.5 | 0.5 | 0.3 | 35.2 | 11.4 | 439 |
| Example 83 | 24.6 | 49.9 | 10.1 | 3.1 | 3.9 | 0.7 | 0.5 | 0.4 | 35.2 | 11.3 | 449 |
| Example 84 | 24.5 | 50.0 | 10.2 | 3.1 | 3.8 | 0.5 | 0.5 | 0.4 | 35.2 | 11.3 | 464 |
| Example 85 | 24.6 | 49.9 | 10.1 | 3.1 | 3.9 | 0.7 | 0.5 | 0.3 | 34.8 | 10.9 | 474 |
| Example 21 | 24.6 | 49.9 | 10.2 | 3.1 | 3.8 | 0.6 | 0.5 | 0.4 | 34.1 | 10.2 | 476 |
| Example 86 | 24.7 | 49.9 | 10.3 | 3.1 | 3.8 | 0.5 | 0.5 | 0.4 | 33.5 | 9.6 | 449 |
| Example 87 | 24.6 | 50.0 | 10.3 | 3.1 | 3.9 | 0.7 | 0.5 | 0.4 | 32.3 | 8.2 | 413 |
| Comparative | 24.6 | 49.8 | 10.3 | 3.1 | 3.9 | 0.6 | 0.5 | 0.4 | 31.9 | 7.8 | 274 |
| example 88 | | | | | | | | | | | |

TABLE 3B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 89 | Fe_{78.00}B_{11.00}P_{8.00}Si_{3.00} | 1.60 | 20 | 0.3 | 10 | 0.5 | 0.5 | 3 |
| Example 90 | Fe_{74.10}Co_{3.90}B_{11.00}P_{8.00}Si_{3.00} | 1.62 | 20 | 0.3 | 10 | 0.5 | 0.5 | 3 |
| Example 91 | Fe_{70.20}Co_{7.80}B_{11.00}P_{8.00}Si_{3.00} | 1.61 | 20 | 0.3 | 10 | 0.5 | 0.5 | 3 |
| Example 92 | Fe_{62.40}Co_{15.60}B_{11.00}P_{8.00}Si_{3.00} | 1.57 | 20 | 0.3 | 10 | 0.5 | 0.5 | 3 |
| Example 22 | Fe_{54.50}Co_{23.40}B_{11.00}P_{8.00}Si_{3.00} | 1.50 | 20 | 0.3 | 10 | 0.5 | 0.5 | 3 |
| Example 93 | Fe_{46.80}Co_{31.20}B_{11.00}P_{8.00}Si_{3.00} | 1.45 | 20 | 0.3 | 10 | 0.5 | 0.5 | 3 |
| Example 94 | Fe_{39.00}Co_{39.00}B_{11.00}P_{8.00}Si_{3.00} | 1.42 | 20 | 0.3 | 10 | 0.5 | 0.5 | 3 |
| Comparative | Fe_{31.20}Co_{46.80}B_{11.00}P_{8.00}Si_{3.00} | 1.40 | 20 | 0.3 | 10 | 0.5 | 0.5 | 3 |
| example 95 | | | | | | | | |
| Example 96 | Fe_{80.00}B_{11.00}P_{7.00}Si_{2.00} | 1.65 | 20 | 0.3 | 10 | 0.5 | 0.5 | 3 |
| Example 97 | Fe_{76.00}Co_{4.00}B_{11.00}P_{7.00}Si_{2.00} | 1.66 | 20 | 0.3 | 10 | 0.5 | 0.5 | 3 |
| Example 98 | Fe_{72.00}Co_{8.00}B_{11.00}P_{7.00}Si_{2.00} | 1.66 | 20 | 0.3 | 10 | 0.5 | 0.5 | 3 |
| Example 99 | Fe_{64.00}Co_{16.00}B_{11.00}P_{7.00}Si_{2.00} | 1.63 | 20 | 0.3 | 10 | 0.5 | 0.5 | 3 |
| Example 23 | Fe_{56.00}Co_{24.00}B_{11.00}P_{7.00}Si_{2.00} | 1.59 | 20 | 0.3 | 10 | 0.5 | 0.5 | 3 |
| Example 100 | Fe_{48.00}Co_{32.00}B_{11.00}P_{7.00}Si_{2.00} | 1.55 | 20 | 0.3 | 10 | 0.5 | 0.5 | 3 |
| Example 101 | Fe_{40.00}Co_{40.00}B_{11.00}P_{7.00}Si_{2.00} | 1.52 | 20 | 0.3 | 10 | 0.5 | 0.5 | 3 |
| Comparative | Fe_{32.00}Co_{48.00}B_{11.00}P_{7.00}Si_{2.00} | 1.48 | 20 | 0.3 | 10 | 0.5 | 0.5 | 3 |
| example 102 | | | | | | | | |
| Example 103 | Fe_{82.00}B_{11.00}P_{5.00}Si_{2.00} | 1.67 | 20 | 0.3 | 10 | 0.5 | 0.5 | 3 |
| Example 104 | Fe_{77.90}Co_{4.10}B_{11.00}P_{5.00}Si_{2.00} | 1.69 | 20 | 0.3 | 10 | 0.5 | 0.5 | 3 |
| Example 105 | Fe_{73.80}Co_{8.20}B_{11.00}P_{5.00}Si_{2.00} | 1.71 | 20 | 0.3 | 10 | 0.5 | 0.5 | 3 |
| Example 106 | Fe_{65.50}Co_{16.40}B_{11.00}P_{5.00}Si_{2.00} | 1.72 | 20 | 0.3 | 10 | 0.5 | 0.5 | 3 |
| Example 24 | Fe_{57.40}Co_{24.60}B_{11.00}P_{5.00}Si_{2.00} | 1.70 | 20 | 0.3 | 10 | 0.5 | 0.5 | 3 |
| Example 107 | Fe_{49.20}Co_{32.80}B_{11.00}P_{5.00}Si_{2.00} | 1.67 | 20 | 0.3 | 10 | 0.5 | 0.5 | 3 |
| Example 108 | Fe_{41.00}Co_{41.00}B_{11.00}P_{5.00}Si_{2.00} | 1.62 | 20 | 0.3 | 10 | 0.5 | 0.5 | 3 |
| Comparative | Fe_{32.80}Co_{49.20}B_{11.00}P_{5.00}Si_{2.00} | 1.59 | 20 | 0.3 | 10 | 0.5 | 0.5 | 3 |
| example 109 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 89 | 24.7 | 49.8 | 10.2 | 3.1 | 3.9 | 0.6 | 0.5 | 0.3 | 35.0 | 11.2 | 430 |
| Example 90 | 24.7 | 49.8 | 10.3 | 3.1 | 3.8 | 0.6 | 0.5 | 0.4 | 34.9 | 11.2 | 440 |
| Example 91 | 24.6 | 49.8 | 10.2 | 3.1 | 3.8 | 0.5 | 0.5 | 0.3 | 34.7 | 11.2 | 456 |
| Example 92 | 24.6 | 49.9 | 10.2 | 3.1 | 3.7 | 0.5 | 0.5 | 0.3 | 34.5 | 11.4 | 465 |
| Example 22 | 24.6 | 49.9 | 10.3 | 3.2 | 3.8 | 0.6 | 0.6 | 0.4 | 34.3 | 11.3 | 467 |
| Example 93 | 24.7 | 49.9 | 10.3 | 3.1 | 3.7 | 0.5 | 0.5 | 0.3 | 33.8 | 10.7 | 440 |
| Example 94 | 24.7 | 49.8 | 10.3 | 3.1 | 3.7 | 0.5 | 0.5 | 0.3 | 33.3 | 10.2 | 405 |
| Comparative | 24.5 | 49.9 | 10.1 | 3.1 | 3.9 | 0.7 | 0.5 | 0.3 | 33.0 | 9.6 | 266 |
| example 95 | | | | | | | | | | | |
| Example 96 | 24.7 | 49.9 | 10.2 | 3.1 | 3.8 | 0.6 | 0.5 | 0.4 | 34.0 | 10.9 | 429 |
| Example 97 | 24.7 | 49.9 | 10.3 | 3.1 | 3.8 | 0.6 | 0.5 | 0.4 | 34.3 | 10.9 | 439 |
| Example 98 | 24.6 | 50.0 | 10.3 | 3.1 | 3.8 | 0.5 | 0.5 | 0.5 | 34.7 | 11.0 | 455 |
| Example 99 | 24.6 | 49.9 | 10.2 | 3.1 | 3.8 | 0.5 | 0.5 | 0.3 | 34.9 | 11.1 | 464 |
| Example 23 | 24.6 | 49.8 | 10.2 | 3.1 | 3.8 | 0.6 | 0.6 | 0.4 | 35.2 | 11.3 | 466 |
| Example 100 | 24.6 | 49.9 | 10.3 | 3.1 | 3.8 | 0.5 | 0.5 | 0.4 | 34.8 | 11.4 | 439 |
| Example 101 | 24.6 | 49.9 | 10.3 | 3.1 | 3.9 | 0.7 | 0.5 | 0.3 | 33.9 | 11.4 | 403 |
| Comparative | 24.6 | 49.9 | 10.3 | 3.1 | 3.9 | 0.6 | 0.5 | 0.4 | 32.0 | 11.1 | 263 |
| example 102 | | | | | | | | | | | |
| Example 103 | 24.5 | 49.9 | 10.3 | 3.1 | 3.9 | 0.7 | 0.5 | 0.4 | 33.9 | 10.7 | 423 |
| Example 104 | 24.7 | 49.9 | 10.2 | 3.1 | 3.8 | 0.6 | 0.5 | 0.4 | 34.2 | 10.6 | 433 |
| Example 105 | 24.5 | 49.9 | 10.3 | 3.1 | 3.8 | 0.5 | 0.5 | 0.3 | 34.6 | 10.4 | 449 |
| Example 106 | 24.5 | 50.0 | 10.2 | 3.1 | 3.8 | 0.5 | 0.5 | 0.4 | 34.8 | 10.3 | 458 |
| Example 24 | 24.7 | 49.8 | 10.3 | 3.2 | 3.8 | 0.5 | 0.4 | 0.4 | 35.0 | 10.5 | 460 |
| Example 107 | 24.5 | 49.9 | 10.1 | 3.1 | 3.9 | 0.7 | 0.5 | 0.4 | 34.7 | 10.8 | 433 |
| Example 108 | 24.6 | 49.9 | 10.2 | 3.1 | 3.9 | 0.6 | 0.5 | 0.4 | 33.8 | 11.1 | 397 |
| Comparative | 24.6 | 49.8 | 10.3 | 3.1 | 3.8 | 0.5 | 0.5 | 0.4 | 31.9 | 11.3 | 256 |
| example 109 | | | | | | | | | | | |

Each example having a composition within a predetermined range exhibited good properties. On the contrary to this, the withstand voltage significantly decreased in the case of Comparative examples 74, 81, 88, 95, 102, and 109 where the content ratio of Co was too large.

### Experiment Example 4

Experiment example 4 was carried out under the same conditions as Experiment example 3 except that Ni was used as X1. Results are shown in Tables 4A and 4B.

TABLE 4A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 110 | Fe_{68.40}Ni_{3.60}B_{11.00}P_{12.00}Si_{5.00} | 1.39 | 20 | 0.3 | 10 | 0.5 | 0.5 | 3 |
| Example 111 | Fe_{64.80}Ni_{7.20}B_{11.00}P_{12.00}Si_{5.00} | 1.39 | 20 | 0.3 | 10 | 0.5 | 0.5 | 3 |
| Example 112 | Fe_{57.60}Ni_{14.40}B_{11.00}P_{12.00}Si_{5.00} | 1.37 | 20 | 0.3 | 10 | 0.5 | 0.5 | 3 |
| Example 113 | Fe_{50.40}Ni_{21.60}B_{11.00}P_{12.00}Si_{5.00} | 1.35 | 20 | 0.3 | 10 | 0.5 | 0.5 | 3 |
| Example 114 | Fe_{43.20}Ni_{28.80}B_{11.00}P_{12.00}Si_{5.00} | 1.33 | 20 | 0.3 | 10 | 0.5 | 0.5 | 3 |
| Example 115 | Fe_{36.00}Ni_{36.00}B_{11.00}P_{12.00}Si_{5.00} | 1.31 | 20 | 0.3 | 10 | 0.5 | 0.5 | 3 |
| Comparative | Fe_{28.80}Ni_{43.20}B_{11.00}P_{12.00}Si_{5.00} | 1.28 | 20 | 0.3 | 10 | 0.5 | 0.5 | 3 |
| example 116 | | | | | | | | |
| Example 117 | Fe_{70.30}Ni_{3.70}B_{11.00}P_{10.00}Si_{5.00} | 1.46 | 20 | 0.3 | 10 | 0.5 | 0.5 | 3 |
| Example 118 | Fe_{66.60}Ni_{7.40}B_{11.00}P_{10.00}Si_{5.00} | 1.45 | 20 | 0.3 | 10 | 0.5 | 0.5 | 3 |
| Example 119 | Fe_{59.20}Ni_{14.80}B_{11.00}P_{10.00}Si_{5.00} | 1.43 | 20 | 0.3 | 10 | 0.5 | 0.5 | 3 |
| Example 120 | Fe_{51.80}Ni_{22.20}B_{11.00}P_{10.00}Si_{5.00} | 1.41 | 20 | 0.3 | 10 | 0.5 | 0.5 | 3 |
| Example 121 | Fe_{44.40}Ni_{29.60}B_{11.00}P_{10.00}Si_{5.00} | 1.39 | 20 | 0.3 | 10 | 0.5 | 0.5 | 3 |
| Example 122 | Fe_{37.00}Ni_{37.00}B_{11.00}P_{10.00}Si_{5.00} | 1.37 | 20 | 0.3 | 10 | 0.5 | 0.5 | 3 |
| Comparative | Fe_{29.60}Ni_{44.40}B_{11.00}P_{10.00}Si_{5.00} | 1.35 | 20 | 0.3 | 10 | 0.5 | 0.5 | 3 |
| example 123 | | | | | | | | |
| Example 124 | Fe_{72.20}Ni_{3.80}B_{11.00}P_{9.00}Si_{4.00} | 1.51 | 20 | 0.3 | 10 | 0.5 | 0.5 | 3 |
| Example 125 | Fe_{68.40}Ni_{7.60}B_{11.00}P_{9.00}Si_{4.00} | 1.50 | 20 | 0.3 | 10 | 0.5 | 0.5 | 3 |
| Example 126 | Fe_{60.80}Ni_{15.20}B_{11.00}P_{9.00}Si_{4.00} | 1.48 | 20 | 0.3 | 10 | 0.5 | 0.5 | 3 |
| Example 127 | Fe_{53.20}Ni_{22.80}B_{11.00}P_{9.00}Si_{4.00} | 1.46 | 20 | 0.3 | 10 | 0.5 | 0.5 | 3 |
| Example 128 | Fe_{45.60}Ni_{30.40}B_{11.00}P_{9.00}Si_{4.00} | 1.44 | 20 | 0.3 | 10 | 0.5 | 0.5 | 3 |
| Example 129 | Fe_{38.00}Ni_{38.00}B_{11.00}P_{9.00}Si_{4.00} | 1.42 | 20 | 0.3 | 10 | 0.5 | 0.5 | 3 |
| Comparative | Fe_{30.40}Ni_{45.60}B_{11.00}P_{9.00}Si_{4.00} | 1.40 | 20 | 0.3 | 10 | 0.5 | 0.5 | 3 |
| example 130 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 110 | 24.7 | 50.0 | 10.2 | 3.1 | 3.9 | 0.7 | 0.5 | 0.4 | 33.8 | 9.3 | 432 |
| Example 111 | 24.6 | 49.8 | 10.2 | 3.1 | 3.9 | 0.6 | 0.5 | 0.3 | 33.6 | 9.1 | 450 |
| Example 112 | 24.6 | 49.9 | 10.2 | 3.1 | 3.8 | 0.5 | 0.5 | 0.4 | 33.0 | 8.6 | 462 |
| Example 113 | 24.6 | 50.0 | 10.2 | 3.1 | 3.9 | 0.6 | 0.5 | 0.4 | 32.1 | 7.7 | 452 |
| Example 114 | 24.5 | 49.8 | 10.2 | 3.1 | 3.9 | 0.7 | 0.5 | 0.4 | 31.0 | 6.5 | 434 |
| Example 115 | 24.7 | 49.9 | 10.2 | 3.1 | 3.8 | 0.5 | 0.5 | 0.3 | 30.5 | 5.6 | 407 |
| Comparative | 24.7 | 49.9 | 10.1 | 3.1 | 3.8 | 0.6 | 0.5 | 0.4 | 29.5 | 3.5 | 267 |
| example 116 | | | | | | | | | | | |
| Example 117 | 24.7 | 49.9 | 10.2 | 3.1 | 3.7 | 0.5 | 0.5 | 0.4 | 34.8 | 10.8 | 443 |
| Example 118 | 24.7 | 49.9 | 10.3 | 3.1 | 3.8 | 0.6 | 0.5 | 0.3 | 34.6 | 10.7 | 455 |
| Example 119 | 24.7 | 49.9 | 10.2 | 3.1 | 3.9 | 0.7 | 0.5 | 0.3 | 34.0 | 10.3 | 461 |
| Example 120 | 24.5 | 49.9 | 10.3 | 3.1 | 3.7 | 0.5 | 0.5 | 0.4 | 33.1 | 9.9 | 460 |
| Example 121 | 24.7 | 49.9 | 10.3 | 3.1 | 3.9 | 0.6 | 0.5 | 0.5 | 32.0 | 9.3 | 441 |
| Example 122 | 24.6 | 49.9 | 10.2 | 3.1 | 3.8 | 0.6 | 0.5 | 0.4 | 31.4 | 8.6 | 403 |
| Comparative | 24.6 | 49.8 | 10.3 | 3.1 | 3.9 | 0.6 | 0.5 | 0.4 | 30.4 | 7.8 | 271 |
| example 123 | | | | | | | | | | | |
| Example 124 | 24.5 | 49.8 | 10.2 | 3.1 | 3.9 | 0.6 | 0.5 | 0.5 | 35.1 | 11.3 | 441 |
| Example 125 | 24.7 | 49.8 | 10.2 | 3.1 | 3.9 | 0.6 | 0.5 | 0.3 | 34.9 | 11.2 | 465 |
| Example 126 | 24.7 | 49.8 | 10.1 | 3.1 | 3.8 | 0.5 | 0.5 | 0.4 | 34.3 | 11.1 | 481 |
| Example 127 | 24.7 | 49.9 | 10.3 | 3.1 | 3.9 | 0.6 | 0.5 | 0.4 | 33.3 | 10.8 | 469 |
| Example 128 | 24.7 | 50.0 | 10.2 | 3.1 | 3.9 | 0.6 | 0.5 | 0.4 | 32.2 | 10.5 | 451 |
| Example 129 | 24.6 | 49.9 | 10.1 | 3.1 | 3.9 | 0.7 | 0.5 | 0.3 | 31.7 | 10.1 | 410 |
| Comparative | 24.7 | 49.9 | 10.2 | 3.1 | 3.8 | 0.6 | 0.5 | 0.3 | 30.7 | 9.6 | 271 |
| example 130 | | | | | | | | | | | |

TABLE 4B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 131 | Fe_{74.10}Ni_{3.90}B_{11.00}P_{8.00}Si_{3.00} | 1.59 | 20 | 0.3 | 10 | 0.5 | 0.5 | 3 |
| Example 132 | Fe_{70.20}Ni_{7.80}B_{11.00}P_{8.00}Si_{3.00} | 1.58 | 20 | 0.3 | 10 | 0.5 | 0.5 | 3 |
| Example 133 | Fe_{62.40}Ni_{15.60}B_{11.00}P_{8.00}Si_{3.00} | 1.56 | 20 | 0.3 | 10 | 0.5 | 0.5 | 3 |
| Example 134 | Fe_{54.60}Ni_{23.40}B_{11.00}P_{8.00}Si_{3.00} | 1.54 | 20 | 0.3 | 10 | 0.5 | 0.5 | 3 |
| Example 135 | Fe_{46.80}Ni_{31.20}B_{11.00}P_{8.00}Si_{3.00} | 1.52 | 20 | 0.3 | 10 | 0.5 | 0.5 | 3 |
| Example 136 | Fe_{39.00}Ni_{39.00}B_{11.00}P_{8.00}Si_{3.00} | 1.50 | 20 | 0.3 | 10 | 0.5 | 0.5 | 3 |
| Comparative | Fe_{31.20}Ni_{46.80}B_{11.00}P_{8.00}Si_{3.00} | 1.48 | 20 | 0.3 | 10 | 0.5 | 0.5 | 3 |
| example 137 | | | | | | | | |
| Example 138 | Fe_{76.00}Ni_{4.00}B_{11.00}P_{7.00}Si_{2.00} | 1.64 | 20 | 0.3 | 10 | 0.5 | 0.5 | 3 |
| Example 139 | Fe_{72.00}Ni_{8.00}B_{11.00}P_{7.00}Si_{2.00} | 1.63 | 20 | 0.3 | 10 | 0.5 | 0.5 | 3 |
| Example 140 | Fe_{64.00}Ni_{16.00}B_{11.00}P_{7.00}Si_{2.00} | 1.61 | 20 | 0.3 | 10 | 0.5 | 0.5 | 3 |
| Example 141 | Fe_{56.00}Ni_{24.00}B_{11.00}P_{7.00}Si_{2.00} | 1.59 | 20 | 0.3 | 10 | 0.5 | 0.5 | 3 |
| Example 142 | Fe_{48.00}Ni_{32.00}B_{11.00}P_{7.00}Si_{2.00} | 1.57 | 20 | 0.3 | 10 | 0.5 | 0.5 | 3 |
| Example 143 | Fe_{40.00}Ni_{40.00}B_{11.00}P_{7.00}Si_{2.00} | 1.55 | 20 | 0.3 | 10 | 0.5 | 0.5 | 3 |
| Comparative | Fe_{32.00}Ni_{48.00}B_{11.00}P_{7.00}Si_{2.00} | 1.53 | 20 | 0.3 | 10 | 0.5 | 0.5 | 3 |
| example 144 | | | | | | | | |
| Example 145 | Fe_{77.90}Ni_{4.10}B_{11.00}P_{5.00}Si_{2.00} | 1.66 | 20 | 0.3 | 10 | 0.5 | 0.5 | 3 |
| Example 146 | Fe_{73.80}Ni_{8.20}B_{11.00}P_{5.00}Si_{2.00} | 1.65 | 20 | 0.3 | 10 | 0.5 | 0.5 | 3 |
| Example 147 | Fe_{65.60}Ni_{16.40}B_{11.00}P_{5.00}Si_{2.00} | 1.63 | 20 | 0.3 | 10 | 0.5 | 0.5 | 3 |
| Example 148 | Fe_{57.40}Ni_{24.60}B_{11.00}P_{5.00}Si_{2.00} | 1.61 | 20 | 0.3 | 10 | 0.5 | 0.5 | 3 |
| Example 149 | Fe_{49.20}Ni_{32.80}B_{11.00}P_{5.00}Si_{2.00} | 1.59 | 20 | 0.3 | 10 | 0.5 | 0.5 | 3 |
| Example 150 | Fe_{41.00}Ni_{41.00}B_{11.00}P_{5.00}Si_{2.00} | 1.57 | 20 | 0.3 | 10 | 0.5 | 0.5 | 3 |
| Comparative | Fe_{32.80}Ni_{49.20}B_{11.00}P_{5.00}Si_{2.00} | 1.55 | 20 | 0.3 | 10 | 0.5 | 0.5 | 3 |
| example 151 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 131 | 24.6 | 49.8 | 10.3 | 3.1 | 3.9 | 0.7 | 0.5 | 0.4 | 35.2 | 11.2 | 436 |
| Example 132 | 24.7 | 49.8 | 10.1 | 3.1 | 3.8 | 0.6 | 0.5 | 0.4 | 34.9 | 11.3 | 462 |
| Example 133 | 24.6 | 49.8 | 10.3 | 3.1 | 3.7 | 0.5 | 0.5 | 0.4 | 34.3 | 11.3 | 471 |
| Example 134 | 24.7 | 50.0 | 10.1 | 3.1 | 3.9 | 0.7 | 0.5 | 0.4 | 33.4 | 11.3 | 461 |
| Example 135 | 24.7 | 49.8 | 10.2 | 3.1 | 3.8 | 0.6 | 0.5 | 0.5 | 32.3 | 11.3 | 448 |
| Example 136 | 24.7 | 50.0 | 10.3 | 3.1 | 3.8 | 0.5 | 0.5 | 0.4 | 31.7 | 11.2 | 410 |
| Comparative | 24.7 | 49.9 | 10.3 | 3.1 | 3.9 | 0.7 | 0.5 | 0.3 | 30.7 | 11.1 | 269 |
| example 137 | | | | | | | | | | | |
| Example 138 | 24.6 | 49.9 | 10.3 | 3.1 | 3.8 | 0.6 | 0.5 | 0.4 | 34.1 | 10.9 | 433 |
| Example 139 | 24.7 | 49.8 | 10.3 | 3.1 | 3.7 | 0.5 | 0.5 | 0.4 | 33.9 | 11.0 | 459 |
| Example 140 | 24.7 | 50.0 | 10.1 | 3.1 | 3.9 | 0.6 | 0.5 | 0.5 | 33.3 | 11.1 | 465 |
| Example 141 | 24.7 | 49.9 | 10.2 | 3.1 | 3.9 | 0.6 | 0.5 | 0.4 | 32.4 | 11.2 | 467 |
| Example 142 | 24.7 | 49.8 | 10.2 | 3.1 | 3.8 | 0.5 | 0.5 | 0.4 | 31.3 | 11.3 | 447 |
| Example 143 | 24.7 | 49.8 | 10.2 | 3.1 | 3.9 | 0.6 | 0.5 | 0.3 | 30.8 | 11.3 | 409 |
| Comparative | 24.6 | 50.0 | 10.2 | 3.1 | 3.9 | 0.7 | 0.5 | 0.3 | 29.8 | 11.3 | 263 |
| example 144 | | | | | | | | | | | |
| Example 145 | 24.7 | 50.0 | 10.2 | 3.1 | 3.9 | 0.7 | 0.5 | 0.3 | 34.0 | 10.8 | 439 |
| Example 146 | 24.5 | 49.9 | 10.3 | 3.1 | 3.9 | 0.7 | 0.5 | 0.3 | 33.8 | 10.9 | 454 |
| Example 147 | 24.6 | 49.9 | 10.2 | 3.1 | 3.7 | 0.5 | 0.5 | 0.3 | 33.2 | 11.0 | 467 |
| Example 148 | 24.7 | 49.9 | 10.3 | 3.1 | 3.7 | 0.5 | 0.5 | 0.3 | 32.3 | 11.1 | 457 |
| Example 149 | 24.7 | 49.8 | 10.2 | 3.1 | 3.9 | 0.6 | 0.5 | 0.3 | 31.2 | 11.2 | 435 |
| Example 150 | 24.7 | 49.9 | 10.2 | 3.1 | 3.8 | 0.5 | 0.5 | 0.3 | 30.7 | 11.3 | 394 |
| Comparative | 24.5 | 49.8 | 10.2 | 3.1 | 3.8 | 0.5 | 0.5 | 0.5 | 29.7 | 11.3 | 260 |
| example 151 | | | | | | | | | | | |

Each example having a composition within a predetermined range exhibited good properties. On the contrary to this, the withstand voltage decreased significantly in the case of Comparative examples 116, 123, 130, 137, 144, and 151 where the content ratio of Ni was too large. Also, Bs decreased in Comparative example 116.

### Experiment Example 5

Experiment example 5 was carried out under the same conditions as Experiment example 3 except that Co and Ni were used as X1. Results are shown in Table 5.

TABLE 5

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 152 | Fe_{68.40}Co_{3.80}Ni_{3.80}B_{11.00}P_{9.00}Si_{4.00} | 1.51 | 20 | 0.3 | 10 | 0.5 | 0.5 | 3 |
| Example 153 | Fe_{64.60}Co_{3.80}Ni_{7.60}B_{11.00}P_{9.00}Si_{4.00} | 1.50 | 20 | 0.3 | 10 | 0.5 | 0.5 | 3 |
| Example 154 | Fe_{57.00}Co_{3.80}Ni_{15.20}B_{11.00}P_{9.00}Si_{4.00} | 1.49 | 20 | 0.3 | 10 | 0.5 | 0.5 | 3 |
| Example 155 | Fe_{49.40}Co_{3.80}Ni_{22.80}B_{11.00}P_{9.00}Si_{4.00} | 1.47 | 20 | 0.3 | 10 | 0.5 | 0.5 | 3 |
| Example 156 | Fe_{41.80}Co_{3.80}Ni_{30.40}B_{11.00}P_{9.00}Si_{4.00} | 1.45 | 20 | 0.3 | 10 | 0.5 | 0.5 | 3 |
| Comparative | Fe_{34.20}Co_{3.80}Ni_{38.00}B_{11.00}P_{9.00}Si_{4.00} | 1.43 | 20 | 0.3 | 10 | 0.5 | 0.5 | 3 |
| example 157 | | | | | | | | |
| Example 158 | Fe_{64.60}Co_{7.60}Ni_{3.80}B_{11.00}P_{9.00}Si_{4.00} | 1.50 | 20 | 0.3 | 10 | 0.5 | 0.5 | 3 |
| Example 159 | Fe_{60.80}Co_{7.60}Ni_{7.60}B_{11.00}P_{9.00}Si_{4.00} | 1.50 | 20 | 0.3 | 10 | 0.5 | 0.5 | 3 |
| Example 160 | Fe_{53.20}Co_{7.60}Ni_{15.20}B_{11.00}P_{9.00}Si_{4.00} | 1.49 | 20 | 0.3 | 10 | 0.5 | 0.5 | 3 |
| Example 161 | Fe_{45.60}Co_{7.60}Ni_{22.80}B_{11.00}P_{9.00}Si_{4.00} | 1.47 | 20 | 0.3 | 10 | 0.5 | 0.5 | 3 |
| Example 162 | Fe_{38.00}Co_{7.60}Ni_{30.40}B_{11.00}P_{9.00}Si_{4.00} | 1.45 | 20 | 0.3 | 10 | 0.5 | 0.5 | 3 |
| Comparative | Fe_{30.40}Co_{7.60}Ni_{38.00}B_{11.00}P_{9.00}Si_{4.00} | 1.43 | 20 | 0.3 | 10 | 0.5 | 0.5 | 3 |
| example 163 | | | | | | | | |
| Example 164 | Fe_{57.00}Co_{15.20}Ni_{3.80}B_{11.00}P_{9.00}Si_{4.00} | 1.47 | 20 | 0.3 | 10 | 0.5 | 0.5 | 3 |
| Example 165 | Fe_{53.20}Co_{15.20}Ni_{7.60}B_{11.00}P_{9.00}Si_{4.00} | 1.47 | 20 | 0.3 | 10 | 0.5 | 0.5 | 3 |
| Example 166 | Fe_{45.60}Co_{15.20}Ni_{15.20}B_{11.00}P_{9.00}Si_{4.00} | 1.47 | 20 | 0.3 | 10 | 0.5 | 0.5 | 3 |
| Example 167 | Fe_{38.00}Co_{15.20}Ni_{22.80}B_{11.00}P_{9.00}Si_{4.00} | 1.46 | 20 | 0.3 | 10 | 0.5 | 0.5 | 3 |
| Comparative | Fe_{30.40}Co_{15.20}Ni_{30.40}B_{11.00}P_{9.00}Si_{4.00} | 1.45 | 20 | 0.3 | 10 | 0.5 | 0.5 | 3 |
| example 168 | | | | | | | | |
| Example 169 | Fe_{49.40}Co_{22.80}Ni_{3.80}B_{11.00}P_{9.00}Si_{4.00} | 1.43 | 20 | 0.3 | 10 | 0.5 | 0.5 | 3 |
| Example 170 | Fe_{45.60}Co_{22.80}Ni_{7.60}B_{11.00}P_{9.00}Si_{4.00} | 1.44 | 20 | 0.3 | 10 | 0.5 | 0.5 | 3 |
| Example 171 | Fe_{38.00}Co_{22.80}Ni_{15.20}B_{11.00}P_{9.00}Si_{4.00} | 1.44 | 20 | 0.3 | 10 | 0.5 | 0.5 | 3 |
| Comparative | Fe_{30.40}Co_{22.80}Ni_{22.80}B_{11.00}P_{9.00}Si_{4.00} | 1.44 | 20 | 0.3 | 10 | 0.5 | 0.5 | 3 |
| example 172 | | | | | | | | |
| Example 173 | Fe_{41.80}Co_{30.40}Ni_{3.80}B_{11.00}P_{9.00}Si_{4.00} | 1.41 | 20 | 0.3 | 10 | 0.5 | 0.5 | 3 |
| Example 174 | Fe_{38.00}Co_{30.40}Ni_{7.60}B_{11.00}P_{9.00}Si_{4.00} | 1.42 | 20 | 0.3 | 10 | 0.5 | 0.5 | 3 |
| Comparative | Fe_{30.40}Co_{30.40}Ni_{15.20}B_{11.00}P_{9.00}Si_{4.00} | 1.43 | 20 | 0.3 | 10 | 0.5 | 0.5 | 3 |
| example 175 | | | | | | | | |
| Comparative | Fe_{34.20}Co_{38.00}Ni_{3.80}B_{11.00}P_{9.00}Si_{4.00} | 1.37 | 20 | 0.3 | 10 | 0.5 | 0.5 | 3 |
| example 176 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 152 | 24.6 | 49.9 | 10.2 | 3.1 | 3.9 | 0.7 | 0.5 | 0.3 | 35.2 | 11.3 | 450 |
| Example 153 | 24.6 | 49.9 | 10.2 | 3.1 | 3.7 | 0.5 | 0.5 | 0.4 | 35.0 | 11.3 | 457 |
| Example 154 | 24.5 | 49.9 | 10.1 | 3.1 | 3.8 | 0.6 | 0.5 | 0.4 | 34.5 | 11.1 | 473 |
| Example 155 | 24.7 | 49.9 | 10.2 | 3.1 | 3.8 | 0.5 | 0.5 | 0.4 | 33.6 | 10.9 | 470 |
| Example 156 | 24.6 | 50.0 | 10.3 | 3.1 | 3.9 | 0.7 | 0.5 | 0.4 | 32.6 | 10.6 | 446 |
| Comparative | 24.7 | 49.9 | 10.2 | 3.1 | 3.8 | 0.5 | 0.5 | 0.3 | 32.0 | 10.2 | 278 |
| example 157 | | | | | | | | | | | |
| Example 158 | 24.7 | 49.8 | 10.2 | 3.1 | 3.9 | 0.7 | 0.5 | 0.3 | 35.2 | 11.3 | 460 |
| Example 159 | 24.6 | 50.0 | 10.2 | 3.1 | 3.8 | 0.6 | 0.5 | 0.5 | 35.0 | 11.2 | 463 |
| Example 160 | 24.6 | 49.9 | 10.2 | 3.1 | 3.9 | 0.6 | 0.5 | 0.3 | 34.6 | 11.1 | 474 |
| Example 161 | 24.7 | 50.0 | 10.2 | 3.1 | 3.9 | 0.6 | 0.5 | 0.4 | 33.8 | 10.9 | 471 |
| Example 162 | 24.7 | 49.9 | 10.2 | 3.1 | 3.8 | 0.6 | 0.5 | 0.3 | 32.8 | 10.7 | 450 |
| Comparative | 24.7 | 49.9 | 10.3 | 3.1 | 3.7 | 0.5 | 0.5 | 0.4 | 32.3 | 10.3 | 282 |
| example 163 | | | | | | | | | | | |
| Example 164 | 24.6 | 49.9 | 10.3 | 3.1 | 3.8 | 0.6 | 0.5 | 0.3 | 34.9 | 11.0 | 469 |
| Example 165 | 24.7 | 50.0 | 10.3 | 3.1 | 3.9 | 0.7 | 0.5 | 0.3 | 34.9 | 11.0 | 470 |
| Example 166 | 24.7 | 49.8 | 10.2 | 3.1 | 3.9 | 0.6 | 0.5 | 0.3 | 34.6 | 11.0 | 476 |
| Example 167 | 24.7 | 49.8 | 10.3 | 3.1 | 3.9 | 0.7 | 0.5 | 0.4 | 33.9 | 10.9 | 473 |
| Comparative | 24.6 | 49.9 | 10.2 | 3.1 | 3.8 | 0.5 | 0.5 | 0.4 | 33.1 | 10.6 | 288 |
| example 168 | | | | | | | | | | | |
| Example 169 | 24.6 | 49.9 | 10.2 | 3.1 | 3.7 | 0.5 | 0.5 | 0.4 | 34.2 | 10.3 | 473 |
| Example 170 | 24.6 | 50.0 | 10.2 | 3.1 | 3.9 | 0.6 | 0.5 | 0.4 | 34.3 | 10.4 | 473 |
| Example 171 | 24.6 | 49.9 | 10.2 | 3.1 | 3.9 | 0.6 | 0.5 | 0.3 | 34.2 | 10.5 | 477 |
| Comparative | 24.6 | 49.9 | 10.1 | 3.1 | 3.9 | 0.6 | 0.5 | 0.3 | 33.7 | 10.5 | 285 |
| example 172 | | | | | | | | | | | |
| Example 173 | 24.5 | 49.8 | 10.2 | 3.1 | 3.8 | 0.5 | 0.5 | 0.3 | 33.7 | 9.8 | 449 |
| Example 174 | 24.7 | 49.8 | 10.3 | 3.1 | 3.8 | 0.5 | 0.5 | 0.3 | 33.8 | 10.0 | 452 |
| Comparative | 24.7 | 49.9 | 10.2 | 3.1 | 3.8 | 0.5 | 0.5 | 0.5 | 33.8 | 10.1 | 279 |
| example 175 | | | | | | | | | | | |
| Comparative | 24.5 | 49.8 | 10.2 | 3.1 | 3.9 | 0.7 | 0.5 | 0.5 | 32.5 | 8.5 | 276 |
| example 176 | | | | | | | | | | | |

Each example having a composition within a predetermined range exhibited good properties. On the contrary to this, the withstand voltage decreased significantly in the case of Comparative examples 157, 163, 168, 172, 175, and 176 where the total content ratio of Co and Ni was too large.

### Experiment Example 6

Experiment example 6 was carried out under the same conditions as in the case of Example 21 which did not include C and Example 63 which included C except that, in Experiment example 6, part of Fe and Co of Example 21 and Example 63 were replaced with X2. Results are shown in each Table. Note that, Table 6A and Tables 7A to 7D show the results of experiments carried out under the same conditions as Example 21 except for replacing part of Fe and Co of Example 21 with X2. Table 6B and Tables 8A to 8B show the results of experiments carried out under the same conditions as Example 63 except for replacing part of Fe and part of Co of Example 63 with X2.

TABLE 6A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 21 | Fe_{53.20}Co_{22.80}B_{11.00}P_{9.00}Si_{4.00} | 1.42 | 20 | 0.3 | 10 | 0.5 | 0.5 | 3 |
| Example 177 | Fe_{53.19}Co_{22.80}B_{11.00}P_{9.00}Si_{4.00}Cr_{0.01} | 1.42 | 20 | 0.3 | 10 | 0.5 | 0.5 | 3 |
| Example 178 | Fe_{53.17}Co_{22.79}B_{11.00}P_{9.00}Si_{4.00}Cr_{0.05} | 1.42 | 20 | 0.3 | 10 | 0.5 | 0.5 | 3 |
| Example 179 | Fe_{53.13}Co_{22.77}B_{11.00}P_{9.00}Si_{4.00}Cr_{0.10} | 1.42 | 20 | 0.3 | 10 | 0.5 | 0.5 | 3 |
| Example 180 | Fe_{52.85}Co_{22.65}B_{11.00}P_{9.00}Si_{4.00}Cr_{0.50} | 1.41 | 20 | 0.3 | 10 | 0.5 | 0.5 | 3 |
| Example 181 | Fe_{52.50}Co_{22.50}B_{11.00}P_{9.00}Si_{4.00}Cr_{1.00} | 1.40 | 20 | 0.3 | 10 | 0.5 | 0.5 | 3 |
| Example 182 | Fe_{51.10}Co_{21.90}B_{11.00}P_{9.00}Si_{4.00}Cr_{3.00} | 1.35 | 20 | 0.3 | 10 | 0.5 | 0.5 | 3 |
| Comparative | Fe_{50.40}Co_{21.60}B_{11.00}P_{9.00}Si_{4.00}Cr_{4.00} | 1.33 | 20 | 0.3 | 10 | 0.5 | 0.5 | 3 |
| example 183 | | | | | | | | |
| Example 184 | Fe_{53.19}Co_{22.80}B_{11.00}P_{9.00}Si_{4.00}Cu_{0.01} | 1.42 | 20 | 0.3 | 10 | 0.5 | 0.5 | 3 |
| Example 185 | Fe_{53.17}Co_{22.79}B_{11.00}P_{9.00}Si_{4.00}Cu_{0.05} | 1.42 | 20 | 0.3 | 10 | 0.5 | 0.5 | 3 |
| Example 186 | Fe_{53.13}Co_{22.77}B_{11.00}P_{9.00}Si_{4.00}Cu_{0.10} | 1.42 | 20 | 0.3 | 10 | 0.5 | 0.5 | 3 |
| Example 187 | Fe_{52.85}Co_{22.65}B_{11.00}P_{9.00}Si_{4.00}Cu_{0.50} | 1.41 | 20 | 0.3 | 10 | 0.5 | 0.5 | 3 |
| Example 188 | Fe_{52.50}Co_{22.50}B_{11.00}P_{9.00}Si_{4.00}Cu_{1.00} | 1.39 | 20 | 0.3 | 10 | 0.5 | 0.5 | 3 |
| Example 189 | Fe_{51.10}Co_{21.90}B_{11.00}P_{9.00}Si_{4.00}Cu_{3.00} | 1.34 | 20 | 0.3 | 10 | 0.5 | 0.5 | 3 |
| Comparative | Fe_{50.40}Co_{21.60}B_{11.00}P_{9.00}Si_{4.00}Cu_{4.00} | 1.31 | 20 | 0.3 | 10 | 0.5 | 0.5 | 3 |
| example 190 | | | | | | | | |
| Example 191 | Fe_{53.19}Co_{22.80}B_{11.00}P_{9.00}Si_{4.00}Nb_{0.01} | 1.42 | 20 | 0.3 | 10 | 0.5 | 0.5 | 3 |
| Example 192 | Fe_{53.17}Co_{22.79}B_{11.00}P_{9.00}Si_{4.00}Nb_{0.05} | 1.42 | 20 | 0.3 | 10 | 0.5 | 0.5 | 3 |
| Example 193 | Fe_{53.13}Co_{22.77}B_{11.00}P_{9.00}Si_{4.00}Nb_{0.10} | 1.42 | 20 | 0.3 | 10 | 0.5 | 0.5 | 3 |
| Example 194 | Fe_{52.85}Co_{22.65}B_{11.00}P_{9.00}Si_{4.00}Nb_{0.50} | 1.40 | 20 | 0.3 | 10 | 0.5 | 0.5 | 3 |
| Example 195 | Fe_{52.50}Co_{22.50}B_{11.00}P_{9.00}Si_{4.00}Nb_{1.00} | 1.38 | 20 | 0.3 | 10 | 0.5 | 0.5 | 3 |
| Example 196 | Fe_{51.10}Co_{21.90}B_{11.00}P_{9.00}Si_{4.00}Nb_{3.00} | 1.31 | 20 | 0.3 | 10 | 0.5 | 0.5 | 3 |
| Comparative | Fe_{50.40}Co_{21.60}B_{11.00}P_{9.00}Si_{4.00}Nb_{4.00} | 1.27 | 20 | 0.3 | 10 | 0.5 | 0.5 | 3 |
| example 197 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 21 | 24.6 | 49.9 | 10.2 | 3.1 | 3.8 | 0.6 | 0.5 | 0.4 | 34.1 | 10.2 | 476 |
| Example 177 | 24.7 | 50.0 | 10.2 | 3.1 | 3.7 | 0.5 | 0.5 | 0.4 | 34.1 | 10.2 | 475 |
| Example 178 | 24.6 | 49.9 | 10.1 | 3.1 | 3.9 | 0.6 | 0.5 | 0.4 | 34.0 | 10.1 | 474 |
| Example 179 | 24.5 | 49.9 | 10.2 | 3.1 | 3.8 | 0.5 | 0.5 | 0.4 | 34.0 | 10.1 | 472 |
| Example 180 | 24.6 | 49.8 | 10.2 | 3.1 | 3.9 | 0.6 | 0.5 | 0.5 | 33.7 | 9.8 | 468 |
| Example 181 | 24.6 | 49.9 | 10.2 | 3.1 | 3.9 | 0.7 | 0.5 | 0.4 | 33.4 | 9.5 | 450 |
| Example 182 | 24.7 | 50.0 | 10.2 | 3.1 | 3.8 | 0.5 | 0.5 | 0.3 | 31.9 | 7.8 | 408 |
| Comparative | 24.7 | 50.0 | 10.3 | 3.1 | 3.9 | 0.7 | 0.5 | 0.3 | 31.2 | 6.8 | 239 |
| example 183 | | | | | | | | | | | |
| Example 184 | 24.5 | 49.8 | 10.1 | 3.1 | 3.8 | 0.6 | 0.5 | 0.3 | 34.0 | 10.1 | 474 |
| Example 185 | 24.7 | 50.0 | 10.1 | 3.1 | 3.9 | 0.6 | 0.5 | 0.3 | 34.0 | 10.1 | 473 |
| Example 186 | 24.6 | 50.0 | 10.3 | 3.1 | 3.8 | 0.5 | 0.5 | 0.4 | 34.0 | 10.1 | 471 |
| Example 187 | 24.6 | 49.8 | 10.3 | 3.1 | 3.8 | 0.5 | 0.5 | 0.4 | 33.7 | 9.8 | 468 |
| Example 188 | 24.7 | 50.0 | 10.1 | 3.1 | 3.8 | 0.5 | 0.5 | 0.4 | 33.3 | 9.4 | 449 |
| Example 189 | 24.5 | 49.9 | 10.2 | 3.1 | 3.8 | 0.5 | 0.5 | 0.3 | 31.5 | 7.2 | 407 |
| Comparative | 24.6 | 50.0 | 10.3 | 3.1 | 3.9 | 0.6 | 0.5 | 0.4 | 30.6 | 5.8 | 239 |
| example 190 | | | | | | | | | | | |
| Example 191 | 24.6 | 49.8 | 10.1 | 3.1 | 3.9 | 0.6 | 0.5 | 0.3 | 34.0 | 10.1 | 448 |
| Example 192 | 24.7 | 49.9 | 10.3 | 3.1 | 3.9 | 0.6 | 0.5 | 0.4 | 34.0 | 10.1 | 446 |
| Example 193 | 24.6 | 49.8 | 10.3 | 3.1 | 3.9 | 0.6 | 0.5 | 0.3 | 34.0 | 10.0 | 434 |
| Example 194 | 24.6 | 49.9 | 10.2 | 3.1 | 3.9 | 0.6 | 0.5 | 0.4 | 33.5 | 9.6 | 439 |
| Example 195 | 24.6 | 49.8 | 10.2 | 3.1 | 3.8 | 0.5 | 0.5 | 0.4 | 33.0 | 9.0 | 444 |
| Example 196 | 24.6 | 49.9 | 10.2 | 3.1 | 3.7 | 0.5 | 0.5 | 0.5 | 30.4 | 5.5 | 445 |
| Comparative | 24.7 | 49.8 | 10.2 | 3.1 | 3.9 | 0.7 | 0.5 | 0.4 | 29.2 | 2.9 | 211 |
| example 197 | | | | | | | | | | | |

TABLE 6B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 63 | Fe_{52.85}Co_{22.65}B_{11.00}P_{9.00}Si_{4.00}C_{0.50} | 1.41 | 20 | 0.3 | 10 | 0.5 | 0.5 | 3 |
| Example 198 | Fe_{52.84}Co_{22.65}B_{11.00}P_{9.00}Si_{4.00}C_{0.50}Cr_{0.01} | 1.41 | 20 | 0.3 | 10 | 0.5 | 0.5 | 3 |
| Example 199 | Fe_{52.82}Co_{22.64}B_{11.00}P_{9.00}Si_{4.00}C_{0.50}Cr_{0.05} | 1.41 | 20 | 0.3 | 10 | 0.5 | 0.5 | 3 |
| Example 200 | Fe_{52.78}Co_{22.62}B_{11.00}P_{9.00}Si_{4.00}C_{0.50}Cr_{0.10} | 1.41 | 20 | 0.3 | 10 | 0.5 | 0.5 | 3 |
| Example 201 | Fe_{52.50}Co_{22.50}B_{11.00}P_{9.00}Si_{4.00}C_{0.50}Cr_{0.50} | 1.40 | 20 | 0.3 | 10 | 0.5 | 0.5 | 3 |
| Example 202 | Fe_{52.15}Co_{22.35}B_{11.00}P_{9.00}Si_{4.00}C_{0.50}Cr_{1.00} | 1.39 | 20 | 0.3 | 10 | 0.5 | 0.5 | 3 |
| Example 203 | Fe_{50.75}Co_{21.75}B_{11.00}P_{9.00}Si_{4.00}C_{0.50}Cr_{3.00} | 1.34 | 20 | 0.3 | 10 | 0.5 | 0.5 | 3 |
| Comparative | Fe_{50.05}Co_{21.45}B_{11.00}P_{9.00}Si_{4.00}C_{0.50}Cr_{4.00} | 1.32 | 20 | 0.3 | 10 | 0.5 | 0.5 | 3 |
| example 204 | | | | | | | | |
| Example 205 | Fe_{52.84}Co_{22.65}B_{11.00}P_{9.00}Si_{4.00}C_{0.50}Cu_{0.01} | 1.41 | 20 | 0.3 | 10 | 0.5 | 0.5 | 3 |
| Example 206 | Fe_{52.82}Co_{22.64}B_{11.00}P_{9.00}Si_{4.00}C_{0.50}Cu_{0.05} | 1.41 | 20 | 0.3 | 10 | 0.5 | 0.5 | 3 |
| Example 207 | Fe_{52.78}Co_{22.62}B_{11.00}P_{9.00}Si_{4.00}C_{0.50}Cu_{0.10} | 1.41 | 20 | 0.3 | 10 | 0.5 | 0.5 | 3 |
| Example 208 | Fe_{52.50}Co_{22.50}B_{11.00}P_{9.00}Si_{4.00}C_{0.50}Cu_{0.50} | 1.39 | 20 | 0.3 | 10 | 0.5 | 0.5 | 3 |
| Example 209 | Fe_{52.15}Co_{22.35}B_{11.00}P_{9.00}Si_{4.00}C_{0.50}Cu_{1.00} | 1.38 | 20 | 0.3 | 10 | 0.5 | 0.5 | 3 |
| Example 210 | Fe_{50.75}Co_{21.75}B_{11.00}P_{9.00}Si_{4.00}C_{0.50}Cu_{3.00} | 1.33 | 20 | 0.3 | 10 | 0.5 | 0.5 | 3 |
| Comparative | Fe_{50.05}Co_{21.45}B_{11.00}P_{9.00}Si_{4.00}C_{0.50}Cu_{4.00} | 1.30 | 20 | 0.3 | 10 | 0.5 | 0.5 | 3 |
| example 211 | | | | | | | | |
| Example 212 | Fe_{52.84}Co_{22.65}B_{11.00}P_{9.00}Si_{4.00}C_{0.50}Nb_{0.01} | 1.41 | 20 | 0.3 | 10 | 0.5 | 0.5 | 3 |
| Example 213 | Fe_{52.82}Co_{22.64}B_{11.00}P_{9.00}Si_{4.00}C_{0.50}Nb_{0.05} | 1.41 | 20 | 0.3 | 10 | 0.5 | 0.5 | 3 |
| Example 214 | Fe_{52.78}Co_{22.62}B_{11.00}P_{9.00}Si_{4.00}C_{0.50}Nb_{0.10} | 1.40 | 20 | 0.3 | 10 | 0.5 | 0.5 | 3 |
| Example 215 | Fe_{52.50}Co_{22.50}B_{11.00}P_{9.00}Si_{4.00}C_{0.50}Nb_{0.50} | 1.39 | 20 | 0.3 | 10 | 0.5 | 0.5 | 3 |
| Example 216 | Fe_{52.15}Co_{22.35}B_{11.00}P_{9.00}Si_{4.00}C_{0.50}Nb_{1.00} | 1.37 | 20 | 0.3 | 10 | 0.5 | 0.5 | 3 |
| Example 217 | Fe_{50.75}Co_{21.75}B_{11.00}P_{9.00}Si_{4.00}C_{0.50}Nb_{3.00} | 1.31 | 20 | 0.3 | 10 | 0.5 | 0.5 | 3 |
| Comparative | Fe_{50.05}Co_{21.45}B_{11.00}P_{9.00}Si_{4.00}C_{0.50}Nb_{4.00} | 1.26 | 20 | 0.3 | 10 | 0.5 | 0.5 | 3 |
| example 218 | | | | | | | | |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 63 | 24.6 | 49.8 | 10.3 | 3.1 | 3.9 | 0.7 | 0.5 | 0.4 | 33.0 | 10.0 | 463 |
| Example 198 | 24.6 | 50.0 | 10.3 | 3.1 | 3.8 | 0.6 | 0.5 | 0.3 | 33.0 | 9.9 | 463 |
| Example 199 | 24.6 | 49.9 | 10.2 | 3.1 | 3.8 | 0.6 | 0.5 | 0.3 | 33.0 | 9.8 | 462 |
| Example 200 | 24.7 | 50.0 | 10.3 | 3.1 | 3.9 | 0.7 | 0.5 | 0.4 | 32.9 | 9.8 | 461 |
| Example 201 | 24.6 | 49.9 | 10.2 | 3.1 | 3.8 | 0.5 | 0.5 | 0.5 | 32.6 | 9.5 | 454 |
| Example 202 | 24.7 | 49.9 | 10.2 | 3.1 | 3.8 | 0.6 | 0.5 | 0.3 | 32.3 | 9.2 | 436 |
| Example 203 | 24.5 | 49.9 | 10.2 | 3.1 | 3.8 | 0.5 | 0.5 | 0.3 | 30.9 | 7.3 | 399 |
| Comparative | 24.7 | 49.9 | 10.3 | 3.1 | 3.8 | 0.6 | 0.5 | 0.5 | 30.1 | 6.1 | 233 |
| example 204 | | | | | | | | | | | |
| Example 205 | 24.6 | 49.9 | 10.3 | 3.1 | 3.9 | 0.6 | 0.5 | 0.4 | 33.0 | 9.9 | 459 |
| Example 206 | 24.5 | 49.9 | 10.2 | 3.1 | 3.8 | 0.5 | 0.5 | 0.3 | 33.0 | 9.8 | 462 |
| Example 207 | 24.7 | 50.0 | 10.3 | 3.1 | 3.8 | 0.6 | 0.5 | 0.4 | 32.9 | 9.8 | 459 |
| Example 208 | 24.7 | 49.9 | 10.3 | 3.1 | 3.8 | 0.6 | 0.5 | 0.4 | 32.6 | 9.5 | 454 |
| Example 209 | 24.6 | 50.0 | 10.3 | 3.1 | 3.9 | 0.6 | 0.5 | 0.3 | 32.1 | 9.0 | 437 |
| Example 210 | 24.6 | 49.9 | 10.1 | 3.1 | 3.9 | 0.6 | 0.5 | 0.4 | 30.4 | 6.7 | 395 |
| Comparative | 24.7 | 49.8 | 10.1 | 3.1 | 3.8 | 0.5 | 0.5 | 0.3 | 29.5 | 5.1 | 233 |
| example 211 | | | | | | | | | | | |
| Example 212 | 24.7 | 49.8 | 10.2 | 3.1 | 3.9 | 0.7 | 0.5 | 0.4 | 33.0 | 9.9 | 435 |
| Example 213 | 24.7 | 50.0 | 10.3 | 3.1 | 3.9 | 0.7 | 0.5 | 0.4 | 32.9 | 9.8 | 434 |
| Example 214 | 24.7 | 49.9 | 10.3 | 3.1 | 3.9 | 0.6 | 0.5 | 0.3 | 32.9 | 9.8 | 424 |
| Example 215 | 24.7 | 50.0 | 10.2 | 3.1 | 3.9 | 0.6 | 0.5 | 0.3 | 32.4 | 9.3 | 429 |
| Example 216 | 24.6 | 49.9 | 10.3 | 3.1 | 3.9 | 0.6 | 0.5 | 0.4 | 31.8 | 8.6 | 431 |
| Example 217 | 24.7 | 49.8 | 10.3 | 3.1 | 3.9 | 0.7 | 0.5 | 0.4 | 29.4 | 5.5 | 431 |
| Comparative | 24.5 | 49.8 | 10.3 | 3.1 | 3.8 | 0.6 | 0.5 | 0.4 | 28.1 | 2.0 | 205 |
| example 218 | | | | | | | | | | | |

TABLE 7A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 219 | Fe_{53.17}Co_{22.79}B_{11.00}P_{9.00}Si_{4.00}Al_{0.05} | 1.42 | 20 | 0.3 | 10 | 0.5 | 0.5 | 3 |
| Example 220 | Fe_{52.85}Co_{22.65}B_{11.00}P_{9.00}Si_{4.00}Al_{0.50} | 1.41 | 20 | 0.3 | 10 | 0.5 | 0.5 | 3 |
| Example 221 | Fe_{52.50}Co_{22.50}B_{11.00}P_{9.00}Si_{4.00}Al_{1.00} | 1.41 | 20 | 0.3 | 10 | 0.5 | 0.5 | 3 |
| Example 222 | Fe_{53.17}Co_{22.79}B_{11.00}P_{9.00}Si_{4.00}Ti_{0.05} | 1.42 | 20 | 0.3 | 10 | 0.5 | 0.5 | 3 |
| Example 223 | Fe_{52.85}Co_{22.65}B_{11.00}P_{9.00}Si_{4.00}Ti_{0.50} | 1.41 | 20 | 0.3 | 10 | 0.5 | 0.5 | 3 |
| Example 224 | Fe_{52.50}Co_{22.50}B_{11.00}P_{9.00}Si_{4.00}Ti_{1.00} | 1.40 | 20 | 0.3 | 10 | 0.5 | 0.5 | 3 |
| Example 225 | Fe_{53.17}Co_{22.79}B_{11.00}P_{9.00}Si_{4.00}V_{0.05} | 1.42 | 20 | 0.3 | 10 | 0.5 | 0.5 | 3 |
| Example 226 | Fe_{52.85}Co_{22.65}B_{11.00}P_{9.00}Si_{4.00}V_{0.50} | 1.41 | 20 | 0.3 | 10 | 0.5 | 0.5 | 3 |
| Example 227 | Fe_{52.50}Co_{22.50}B_{11.00}P_{9.00}Si_{4.00}V_{1.00} | 1.40 | 20 | 0.3 | 10 | 0.5 | 0.5 | 3 |
| Example 228 | Fe_{53.17}Co_{22.79}B_{11.00}P_{9.00}Si_{4.00}Mn_{0.05} | 1.42 | 20 | 0.3 | 10 | 0.5 | 0.5 | 3 |
| Example 229 | Fe_{52.85}Co_{22.65}B_{11.00}P_{9.00}Si_{4.00}Mn_{0.50} | 1.41 | 20 | 0.3 | 10 | 0.5 | 0.5 | 3 |
| Example 230 | Fe_{52.50}Co_{22.50}B_{11.00}P_{9.00}Si_{4.00}Mn_{1.00} | 1.40 | 20 | 0.3 | 10 | 0.5 | 0.5 | 3 |
| Example 231 | Fe_{53.17}Co_{22.79}B_{11.00}P_{9.00}Si_{4.00}Zn_{0.05} | 1.42 | 20 | 0.3 | 10 | 0.5 | 0.5 | 3 |
| Example 232 | Fe_{52.85}Co_{22.65}B_{11.00}P_{9.00}Si_{4.00}Zn_{0.50} | 1.41 | 20 | 0.3 | 10 | 0.5 | 0.5 | 3 |
| Example 233 | Fe_{52.50}Co_{22.50}B_{11.00}P_{9.00}Si_{4.00}Zn_{1.00} | 1.39 | 20 | 0.3 | 10 | 0.5 | 0.5 | 3 |
| Example 234 | Fe_{53.17}Co_{22.79}B_{11.00}P_{9.00}Si_{4.00}Ga_{0.05} | 1.42 | 20 | 0.3 | 10 | 0.5 | 0.5 | 3 |
| Example 235 | Fe_{52.85}Co_{22.65}B_{11.00}P_{9.00}Si_{4.00}Ga_{0.50} | 1.40 | 20 | 0.3 | 10 | 0.5 | 0.5 | 3 |
| Example 236 | Fe_{52.50}Co_{22.50}B_{11.00}P_{9.00}Si_{4.00}Ga_{1.00} | 1.39 | 20 | 0.3 | 10 | 0.5 | 0.5 | 3 |
| Example 237 | Fe_{53.17}Co_{22.79}B_{11.00}P_{9.00}Si_{4.00}As_{0.05} | 1.42 | 20 | 0.3 | 10 | 0.5 | 0.5 | 3 |
| Example 238 | Fe_{52.85}Co_{22.65}B_{11.00}P_{9.00}Si_{4.00}As_{0.50} | 1.40 | 20 | 0.3 | 10 | 0.5 | 0.5 | 3 |
| Example 239 | Fe_{52.50}Co_{22.50}B_{11.00}P_{9.00}Si_{4.00}As_{1.00} | 1.39 | 20 | 0.3 | 10 | 0.5 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 219 | 24.5 | 49.9 | 10.2 | 3.1 | 3.8 | 0.6 | 0.5 | 0.4 | 34.0 | 10.1 | 474 |
| Example 220 | 24.5 | 50.0 | 10.3 | 3.1 | 3.7 | 0.5 | 0.5 | 0.4 | 33.9 | 10.0 | 474 |
| Example 221 | 24.7 | 50.0 | 10.3 | 3.1 | 3.8 | 0.5 | 0.5 | 0.3 | 33.7 | 9.8 | 472 |
| Example 222 | 24.7 | 49.8 | 10.2 | 3.1 | 3.9 | 0.7 | 0.5 | 0.3 | 34.0 | 10.1 | 475 |
| Example 223 | 24.7 | 49.9 | 10.2 | 3.1 | 3.8 | 0.6 | 0.5 | 0.3 | 33.8 | 9.9 | 473 |
| Example 224 | 24.6 | 49.9 | 10.3 | 3.1 | 3.8 | 0.6 | 0.5 | 0.3 | 33.5 | 9.6 | 472 |
| Example 225 | 24.7 | 50.0 | 10.2 | 3.1 | 3.8 | 0.5 | 0.5 | 0.5 | 34.0 | 10.1 | 475 |
| Example 226 | 24.7 | 49.9 | 10.2 | 3.1 | 3.8 | 0.5 | 0.5 | 0.3 | 33.8 | 9.9 | 474 |
| Example 227 | 24.7 | 49.9 | 10.1 | 3.1 | 3.9 | 0.7 | 0.5 | 0.4 | 33.4 | 9.5 | 471 |
| Example 228 | 24.6 | 49.8 | 10.3 | 3.1 | 3.8 | 0.5 | 0.5 | 0.3 | 34.0 | 10.1 | 474 |
| Example 229 | 24.7 | 49.8 | 10.2 | 3.1 | 3.8 | 0.6 | 0.5 | 0.3 | 33.7 | 9.8 | 474 |
| Example 230 | 24.6 | 49.8 | 10.3 | 3.1 | 3.9 | 0.7 | 0.5 | 0.4 | 33.4 | 9.5 | 471 |
| Example 231 | 24.6 | 49.8 | 10.2 | 3.1 | 3.7 | 0.5 | 0.5 | 0.3 | 34.0 | 10.1 | 475 |
| Example 232 | 24.6 | 49.9 | 10.2 | 3.1 | 3.8 | 0.6 | 0.5 | 0.4 | 33.7 | 9.8 | 473 |
| Example 233 | 24.7 | 50.0 | 10.1 | 3.1 | 3.8 | 0.6 | 0.5 | 0.4 | 33.3 | 9.4 | 471 |
| Example 234 | 24.6 | 49.9 | 10.3 | 3.1 | 3.9 | 0.6 | 0.5 | 0.4 | 34.0 | 10.1 | 475 |
| Example 235 | 24.7 | 49.9 | 10.3 | 3.1 | 3.8 | 0.5 | 0.5 | 0.4 | 33.7 | 9.8 | 473 |
| Example 236 | 24.6 | 49.9 | 10.1 | 3.1 | 3.8 | 0.6 | 0.5 | 0.4 | 33.2 | 9.3 | 472 |
| Example 237 | 24.6 | 49.8 | 10.3 | 3.1 | 3.9 | 0.7 | 0.5 | 0.4 | 34.0 | 10.1 | 475 |
| Example 238 | 24.6 | 49.9 | 10.2 | 3.1 | 3.8 | 0.6 | 0.5 | 0.3 | 33.6 | 9.7 | 474 |
| Example 239 | 24.7 | 49.8 | 10.3 | 3.1 | 3.9 | 0.6 | 0.5 | 0.5 | 33.2 | 9.3 | 471 |

TABLE 7B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 240 | Fe_{53.17}Co_{22.79}B_{11.00}P_{9.00}Si_{4.00}Zr_{0.05} | 1.42 | 20 | 0.3 | 10 | 0.5 | 0.5 | 3 |
| Example 241 | Fe_{52.85}Co_{22.65}B_{11.00}P_{9.00}Si_{4.00}Zr_{0.50} | 1.40 | 20 | 0.3 | 10 | 0.5 | 0.5 | 3 |
| Example 242 | Fe_{52.50}Co_{22.50}B_{11.00}P_{9.00}Si_{4.00}Zr_{1.00} | 1.38 | 20 | 0.3 | 10 | 0.5 | 0.5 | 3 |
| Example 243 | Fe_{53.17}Co_{22.79}B_{11.00}P_{9.00}Si_{4.00}Mo_{0.05} | 1.42 | 20 | 0.3 | 10 | 0.5 | 0.5 | 3 |
| Example 244 | Fe_{52.85}Co_{22.65}B_{11.00}P_{9.00}Si_{4.00}Mo_{0.50} | 1.40 | 20 | 0.3 | 10 | 0.5 | 0.5 | 3 |
| Example 245 | Fe_{52.50}Co_{22.50}B_{11.00}P_{9.00}Si_{4.00}Mo_{1.00} | 1.38 | 20 | 0.3 | 10 | 0.5 | 0.5 | 3 |
| Example 246 | Fe_{53.17}Co_{22.79}B_{11.00}P_{9.00}Si_{4.00}Ag_{0.05} | 1.42 | 20 | 0.3 | 10 | 0.5 | 0.5 | 3 |
| Example 247 | Fe_{52.85}Co_{22.65}B_{11.00}P_{9.00}Si_{4.00}Ag_{0.50} | 1.40 | 20 | 0.3 | 10 | 0.5 | 0.5 | 3 |
| Example 248 | Fe_{52.50}Co_{22.50}B_{11.00}P_{9.00}Si_{4.00}Ag_{1.00} | 1.38 | 20 | 0.3 | 10 | 0.5 | 0.5 | 3 |
| Example 249 | Fe_{53.17}Co_{22.79}B_{11.00}P_{9.00}Si_{4.00}Sn_{0.05} | 1.42 | 20 | 0.3 | 10 | 0.5 | 0.5 | 3 |
| Example 250 | Fe_{52.85}Co_{22.65}B_{11.00}P_{9.00}Si_{4.00}Sn_{0.50} | 1.40 | 20 | 0.3 | 10 | 0.5 | 0.5 | 3 |
| Example 251 | Fe_{52.50}Co_{22.50}B_{11.00}P_{9.00}Si_{4.00}Sn_{1.00} | 1.37 | 20 | 0.3 | 10 | 0.5 | 0.5 | 3 |
| Example 252 | Fe_{53.17}Co_{22.79}B_{11.00}P_{9.00}Si_{4.00}Sb_{0.05} | 1.42 | 20 | 0.3 | 10 | 0.5 | 0.5 | 3 |
| Example 253 | Fe_{52.85}Co_{22.65}B_{11.00}P_{9.00}Si_{4.00}Sb_{0.50} | 1.39 | 20 | 0.3 | 10 | 0.5 | 0.5 | 3 |
| Example 254 | Fe_{52.50}Co_{22.50}B_{11.00}P_{9.00}Si_{4.00}Sb_{1.00} | 1.37 | 20 | 0.3 | 10 | 0.5 | 0.5 | 3 |
| Example 255 | Fe_{53.17}Co_{22.79}B_{11.00}P_{9.00}Si_{4.00}Hf_{0.05} | 1.42 | 20 | 0.3 | 10 | 0.5 | 0.5 | 3 |
| Example 256 | Fe_{52.85}Co_{22.65}B_{11.00}P_{9.00}Si_{4.00}Hf_{0.50} | 1.38 | 20 | 0.3 | 10 | 0.5 | 0.5 | 3 |
| Example 257 | Fe_{52.50}Co_{22.50}B_{11.00}P_{9.00}Si_{4.00}Hf_{1.00} | 1.35 | 20 | 0.3 | 10 | 0.5 | 0.5 | 3 |
| Example 258 | Fe_{53.17}Co_{22.79}B_{11.00}P_{9.00}Si_{4.00}Ta_{0.05} | 1.42 | 20 | 0.3 | 10 | 0.5 | 0.5 | 3 |
| Example 259 | Fe_{52.85}Co_{22.65}B_{11.00}P_{9.00}Si_{4.00}Ta_{0.50} | 1.38 | 20 | 0.3 | 10 | 0.5 | 0.5 | 3 |
| Example 260 | Fe_{52.50}Co_{22.50}B_{11.00}P_{9.00}Si_{4.00}Ta_{1.00} | 1.35 | 20 | 0.3 | 10 | 0.5 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 240 | 24.7 | 50.0 | 10.3 | 3.1 | 3.8 | 0.6 | 0.5 | 0.5 | 34.0 | 10.1 | 474 |
| Example 241 | 24.6 | 49.9 | 10.3 | 3.1 | 3.8 | 0.5 | 0.5 | 0.5 | 33.5 | 9.6 | 474 |
| Example 242 | 24.6 | 49.8 | 10.2 | 3.1 | 3.8 | 0.5 | 0.5 | 0.3 | 33.0 | 9.1 | 472 |
| Example 243 | 24.7 | 49.9 | 10.3 | 3.1 | 3.8 | 0.5 | 0.5 | 0.3 | 34.0 | 10.1 | 475 |
| Example 244 | 24.5 | 49.9 | 10.2 | 3.1 | 3.7 | 0.5 | 0.5 | 0.4 | 33.5 | 9.6 | 474 |
| Example 245 | 24.7 | 49.9 | 10.2 | 3.1 | 3.9 | 0.6 | 0.5 | 0.3 | 32.9 | 9.0 | 471 |
| Example 246 | 24.7 | 50.0 | 10.1 | 3.1 | 3.8 | 0.5 | 0.5 | 0.4 | 34.0 | 10.1 | 474 |
| Example 247 | 24.7 | 50.0 | 10.3 | 3.1 | 3.8 | 0.5 | 0.5 | 0.4 | 33.5 | 9.6 | 473 |
| Example 248 | 24.5 | 50.0 | 10.2 | 3.1 | 3.8 | 0.5 | 0.5 | 0.4 | 32.8 | 8.8 | 472 |
| Example 249 | 24.7 | 49.9 | 10.3 | 3.1 | 3.9 | 0.7 | 0.5 | 0.4 | 34.0 | 10.1 | 474 |
| Example 250 | 24.6 | 50.0 | 10.2 | 3.1 | 3.9 | 0.6 | 0.5 | 0.4 | 33.4 | 9.5 | 474 |
| Example 251 | 24.7 | 49.9 | 10.2 | 3.1 | 3.7 | 0.5 | 0.5 | 0.3 | 32.7 | 8.7 | 472 |
| Example 252 | 24.6 | 49.9 | 10.2 | 3.1 | 3.9 | 0.6 | 0.5 | 0.4 | 34.0 | 10.1 | 474 |
| Example 253 | 24.6 | 49.8 | 10.2 | 3.1 | 3.9 | 0.6 | 0.5 | 0.3 | 33.4 | 9.5 | 473 |
| Example 254 | 24.6 | 49.8 | 10.2 | 3.1 | 3.8 | 0.5 | 0.5 | 0.4 | 32.6 | 8.6 | 472 |
| Example 255 | 24.7 | 49.8 | 10.3 | 3.1 | 3.8 | 0.5 | 0.5 | 0.3 | 34.0 | 10.0 | 475 |
| Example 256 | 24.6 | 49.9 | 10.3 | 3.1 | 3.8 | 0.5 | 0.5 | 0.4 | 33.1 | 9.1 | 474 |
| Example 257 | 24.5 | 50.0 | 10.2 | 3.1 | 3.8 | 0.5 | 0.5 | 0.4 | 31.9 | 7.8 | 472 |
| Example 258 | 24.6 | 49.8 | 10.2 | 3.1 | 3.8 | 0.5 | 0.5 | 0.4 | 34.0 | 10.0 | 474 |
| Example 259 | 24.7 | 49.9 | 10.1 | 3.1 | 3.9 | 0.6 | 0.5 | 0.5 | 33.0 | 9.1 | 473 |
| Example 260 | 24.6 | 49.8 | 10.3 | 3.1 | 3.9 | 0.7 | 0.5 | 0.4 | 31.9 | 7.7 | 472 |

TABLE 7C

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 261 | Fe_{53.17}Co_{22.79}B_{11.00}P_{9.00}Si_{4.00}W_{0.05} | 1.42 | 20 | 0.3 | 10 | 0.5 | 0.5 | 3 |
| Example 262 | Fe_{52.85}Co_{22.65}B_{11.00}P_{9.00}Si_{4.00}W_{0.50} | 1.38 | 20 | 0.3 | 10 | 0.5 | 0.5 | 3 |
| Example 263 | Fe_{52.50}Co_{22.50}B_{11.00}P_{9.00}Si_{4.00}W_{1.00} | 1.35 | 20 | 0.3 | 10 | 0.5 | 0.5 | 3 |
| Example 264 | Fe_{53.17}Co_{22.79}B_{11.00}P_{9.00}Si_{4.00}Au_{0.05} | 1.42 | 20 | 0.3 | 10 | 0.5 | 0.5 | 3 |
| Example 265 | Fe_{52.85}Co_{22.65}B_{11.00}P_{9.00}Si_{4.00}Au_{0.50} | 1.38 | 20 | 0.3 | 10 | 0.5 | 0.5 | 3 |
| Example 266 | Fe_{52.50}Co_{22.50}B_{11.00}P_{9.00}Si_{4.00}Au_{1.00} | 1.34 | 20 | 0.3 | 10 | 0.5 | 0.5 | 3 |
| Example 267 | Fe_{53.17}Co_{22.79}B_{11.00}P_{9.00}Si_{4.00}Bi_{0.05} | 1.41 | 20 | 0.3 | 10 | 0.5 | 0.5 | 3 |
| Example 268 | Fe_{52.85}Co_{22.65}B_{11.00}P_{9.00}Si_{4.00}Bi_{0.50} | 1.38 | 20 | 0.3 | 10 | 0.5 | 0.5 | 3 |
| Example 269 | Fe_{52.50}Co_{22.50}B_{11.00}P_{9.00}Si_{4.00}Bi_{1.00} | 1.34 | 20 | 0.3 | 10 | 0.5 | 0.5 | 3 |
| Example 270 | Fe_{53.17}Co_{22.79}B_{11.00}P_{9.00}Si_{4.00}Y_{0.05} | 1.42 | 20 | 0.3 | 10 | 0.5 | 0.5 | 3 |
| Example 271 | Fe_{52.85}Co_{22.65}B_{11.00}P_{9.00}Si_{4.00}Y_{0.50} | 1.40 | 20 | 0.3 | 10 | 0.5 | 0.5 | 3 |
| Example 272 | Fe_{52.50}Co_{22.50}B_{11.00}P_{9.00}Si_{4.00}Y_{1.00} | 1.38 | 20 | 0.3 | 10 | 0.5 | 0.5 | 3 |
| Example 273 | Fe_{53.17}Co_{22.79}B_{11.00}P_{9.00}Si_{4.00}La_{0.05} | 1.42 | 20 | 0.3 | 10 | 0.5 | 0.5 | 3 |
| Example 274 | Fe_{52.85}Co_{22.65}B_{11.00}P_{9.00}Si_{4.00}La_{0.50} | 1.39 | 20 | 0.3 | 10 | 0.5 | 0.5 | 3 |
| Example 275 | Fe_{52.50}Co_{22.50}B_{11.00}P_{9.00}Si_{4.00}La_{1.00} | 1.36 | 20 | 0.3 | 10 | 0.5 | 0.5 | 3 |
| Example 276 | Fe_{53.17}Co_{22.79}B_{11.00}P_{9.00}Si_{4.00}Pt_{0.05} | 1.42 | 20 | 0.3 | 10 | 0.5 | 0.5 | 3 |
| Example 277 | Fe_{52.85}Co_{22.65}B_{11.00}P_{9.00}Si_{4.00}Pt_{0.50} | 1.38 | 20 | 0.3 | 10 | 0.5 | 0.5 | 3 |
| Example 278 | Fe_{52.50}Co_{22.50}B_{11.00}P_{9.00}Si_{4.00}Pt_{1.00} | 1.34 | 20 | 0.3 | 10 | 0.5 | 0.5 | 3 |
| Example 279 | Fe_{53.19}Co_{22.80}B_{11.00}P_{9.00}Si_{4.00}S_{0.01} | 1.42 | 20 | 0.3 | 10 | 0.5 | 0.5 | 3 |
| Example 280 | Fe_{53.18}Co_{22.79}B_{11.00}P_{9.00}Si_{4.00}S_{0.025} | 1.42 | 20 | 0.3 | 10 | 0.5 | 0.5 | 3 |
| Example 281 | Fe_{53.13}Co_{22.77}B_{11.00}P_{9.00}Si_{4.00}S_{0.10} | 1.42 | 20 | 0.3 | 10 | 0.5 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 261 | 24.6 | 49.9 | 10.1 | 3.1 | 3.8 | 0.5 | 0.5 | 0.3 | 34.0 | 10.0 | 474 |
| Example 262 | 24.7 | 49.9 | 10.2 | 3.1 | 3.8 | 0.5 | 0.5 | 0.4 | 33.0 | 9.1 | 473 |
| Example 263 | 24.6 | 49.9 | 10.2 | 3.1 | 3.9 | 0.6 | 0.5 | 0.4 | 31.8 | 7.7 | 472 |
| Example 264 | 24.6 | 49.9 | 10.2 | 3.1 | 3.8 | 0.6 | 0.5 | 0.4 | 33.9 | 10.0 | 475 |
| Example 265 | 24.6 | 50.0 | 10.2 | 3.1 | 3.8 | 0.6 | 0.5 | 0.3 | 32.9 | 9.0 | 473 |
| Example 266 | 24.6 | 49.8 | 10.2 | 3.1 | 3.9 | 0.6 | 0.5 | 0.4 | 31.7 | 7.5 | 471 |
| Example 267 | 24.5 | 50.0 | 10.3 | 3.1 | 3.8 | 0.5 | 0.5 | 0.4 | 33.9 | 10.0 | 475 |
| Example 268 | 24.6 | 49.9 | 10.2 | 3.1 | 3.9 | 0.7 | 0.5 | 0.4 | 32.9 | 8.9 | 473 |
| Example 269 | 24.6 | 49.9 | 10.2 | 3.1 | 3.8 | 0.5 | 0.5 | 0.5 | 31.5 | 7.3 | 471 |
| Example 270 | 24.5 | 49.9 | 10.1 | 3.1 | 3.8 | 0.5 | 0.5 | 0.3 | 34.0 | 10.1 | 474 |
| Example 271 | 24.6 | 49.8 | 10.2 | 3.1 | 3.7 | 0.5 | 0.5 | 0.4 | 33.6 | 9.7 | 474 |
| Example 272 | 24.5 | 49.8 | 10.3 | 3.1 | 3.9 | 0.7 | 0.5 | 0.4 | 33.0 | 9.1 | 472 |
| Example 273 | 24.5 | 49.8 | 10.3 | 3.1 | 3.8 | 0.6 | 0.5 | 0.3 | 34.0 | 10.1 | 474 |
| Example 274 | 24.7 | 49.9 | 10.3 | 3.1 | 3.8 | 0.5 | 0.5 | 0.4 | 33.3 | 9.4 | 473 |
| Example 275 | 24.7 | 49.8 | 10.2 | 3.1 | 3.8 | 0.5 | 0.5 | 0.4 | 32.4 | 8.4 | 471 |
| Example 276 | 24.7 | 49.9 | 10.3 | 3.1 | 3.7 | 0.5 | 0.5 | 0.4 | 33.9 | 10.0 | 474 |
| Example 277 | 24.6 | 49.9 | 10.3 | 3.1 | 3.8 | 0.5 | 0.5 | 0.3 | 33.0 | 9.0 | 473 |
| Example 278 | 24.7 | 49.9 | 10.2 | 3.1 | 3.9 | 0.7 | 0.5 | 0.4 | 31.7 | 7.5 | 472 |
| Example 279 | 24.7 | 49.8 | 10.2 | 3.1 | 3.8 | 0.5 | 0.5 | 0.4 | 34.0 | 10.1 | 474 |
| Example 280 | 24.5 | 49.9 | 10.3 | 3.1 | 3.9 | 0.7 | 0.5 | 0.3 | 34.0 | 10.1 | 474 |
| Example 281 | 24.6 | 49.9 | 10.2 | 3.1 | 3.8 | 0.5 | 0.5 | 0.4 | 34.0 | 10.1 | 475 |

TABLE 7D

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 282 | Fe_{53.19}Co_{22.80}B_{11.00}P_{9.00}Si_{4.00}Mg_{0.01} | 1.42 | 20 | 0.3 | 10 | 0.5 | 0.5 | 3 |
| Example 283 | Fe_{53.18}Co_{22.79}B_{11.00}P_{9.00}Si_{4.00}Mg_{0.025} | 1.42 | 20 | 0.3 | 10 | 0.5 | 0.5 | 3 |
| Example 284 | Fe_{53.13}Co_{22.77}B_{11.00}P_{9.00}Si_{4.00}Mg_{0.10} | 1.42 | 20 | 0.3 | 10 | 0.5 | 0.5 | 3 |
| Example 285 | Fe_{53.19}Co_{22.80}B_{11.00}P_{9.00}Si_{4.00}Ca_{0.01} | 1.42 | 20 | 0.3 | 10 | 0.5 | 0.5 | 3 |
| Example 286 | Fe_{53.18}Co_{22.79}B_{11.00}P_{9.00}Si_{4.00}Ca_{0.025} | 1.42 | 20 | 0.3 | 10 | 0.5 | 0.5 | 3 |
| Example 287 | Fe_{53.13}Co_{22.77}B_{11.00}P_{9.00}Si_{4.00}Ca_{0.10} | 1.42 | 20 | 0.3 | 10 | 0.5 | 0.5 | 3 |
| Example 288 | Fe_{53.19}Co_{22.80}B_{11.00}P_{9.00}Si_{4.00}N_{0.01} | 1.42 | 20 | 0.3 | 10 | 0.5 | 0.5 | 3 |
| Example 289 | Fe_{53.18}Co_{22.79}B_{11.00}P_{9.00}Si_{4.00}N_{0.025} | 1.42 | 20 | 0.3 | 10 | 0.5 | 0.5 | 3 |
| Example 290 | Fe_{53.13}Co_{22.77}B_{11.00}P_{9.00}Si_{4.00}N_{0.10} | 1.42 | 20 | 0.3 | 10 | 0.5 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 282 | 24.6 | 49.9 | 10.2 | 3.1 | 3.7 | 0.5 | 0.5 | 0.4 | 34.0 | 10.1 | 475 |
| Example 283 | 24.6 | 49.9 | 10.1 | 3.1 | 3.8 | 0.6 | 0.5 | 0.5 | 34.0 | 10.1 | 474 |
| Example 284 | 24.6 | 49.9 | 10.3 | 3.1 | 3.8 | 0.5 | 0.5 | 0.3 | 34.0 | 10.1 | 475 |
| Example 285 | 24.7 | 49.9 | 10.3 | 3.1 | 3.9 | 0.6 | 0.5 | 0.5 | 34.0 | 10.1 | 475 |
| Example 286 | 24.6 | 49.8 | 10.2 | 3.1 | 3.9 | 0.7 | 0.5 | 0.4 | 34.0 | 10.1 | 474 |
| Example 287 | 24.6 | 50.0 | 10.2 | 3.1 | 3.9 | 0.7 | 0.5 | 0.3 | 34.0 | 10.1 | 475 |
| Example 288 | 24.6 | 49.9 | 10.2 | 3.1 | 3.8 | 0.6 | 0.5 | 0.4 | 34.0 | 10.1 | 475 |
| Example 289 | 24.7 | 50.0 | 10.2 | 3.1 | 3.8 | 0.6 | 0.5 | 0.4 | 34.0 | 10.1 | 474 |
| Example 290 | 24.6 | 49.8 | 10.1 | 3.1 | 3.8 | 0.5 | 0.5 | 0.4 | 34.0 | 10.1 | 474 |

TABLE 8A

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 296 | Fe_{52.50}Co_{22.50}B_{11.00}P_{9.00}Si_{4.00}C_{0.50}Al_{0.50} | 1.41 | 20 | 0.3 | 10 | 0.5 | 0.5 | 3 |
| Example 297 | Fe_{52.50}Co_{22.50}B_{11.00}P_{9.00}Si_{4.00}C_{0.50}Ti_{0.50} | 1.41 | 20 | 0.3 | 10 | 0.5 | 0.5 | 3 |
| Example 298 | Fe_{52.50}Co_{22.50}B_{11.00}P_{9.00}Si_{4.00}C_{0.50}V_{0.50} | 1.41 | 20 | 0.3 | 10 | 0.5 | 0.5 | 3 |
| Example 299 | Fe_{52.50}Co_{22.50}B_{11.00}P_{9.00}Si_{4.00}C_{0.50}Mn_{0.50} | 1.41 | 20 | 0.3 | 10 | 0.5 | 0.5 | 3 |
| Example 300 | Fe_{52.50}Co_{22.50}B_{11.00}P_{9.00}Si_{4.00}C_{0.50}Zn_{0.50} | 1.40 | 20 | 0.3 | 10 | 0.5 | 0.5 | 3 |
| Example 301 | Fe_{52.50}Co_{22.50}B_{11.00}P_{9.00}Si_{4.00}C_{0.50}Ga_{0.50} | 1.40 | 20 | 0.3 | 10 | 0.5 | 0.5 | 3 |
| Example 302 | Fe_{52.50}Co_{22.50}B_{11.00}P_{9.00}Si_{4.00}C_{0.50}As_{0.50} | 1.40 | 20 | 0.3 | 10 | 0.5 | 0.5 | 3 |
| Example 303 | Fe_{52.50}Co_{22.50}B_{11.00}P_{9.00}Si_{4.00}C_{0.50}Zr_{0.50} | 1.40 | 20 | 0.3 | 10 | 0.5 | 0.5 | 3 |
| Example 304 | Fe_{52.50}Co_{22.50}B_{11.00}P_{9.00}Si_{4.00}C_{0.50}Mo_{0.50} | 1.40 | 20 | 0.3 | 10 | 0.5 | 0.5 | 3 |
| Example 305 | Fe_{52.50}Co_{22.50}B_{11.00}P_{9.00}Si_{4.00}C_{0.50}Ag_{0.50} | 1.40 | 20 | 0.3 | 10 | 0.5 | 0.5 | 3 |
| Example 306 | Fe_{52.50}Co_{22.50}B_{11.00}P_{9.00}Si_{4.00}C_{0.50}Sn_{0.50} | 1.39 | 20 | 0.3 | 10 | 0.5 | 0.5 | 3 |
| Example 307 | Fe_{52.50}Co_{22.50}B_{11.00}P_{9.00}Si_{4.00}C_{0.50}Sb_{0.50} | 1.39 | 20 | 0.3 | 10 | 0.5 | 0.5 | 3 |
| Example 308 | Fe_{52.50}Co_{22.50}B_{11.00}P_{9.00}Si_{4.00}C_{0.50}Hf_{0.50} | 1.38 | 20 | 0.3 | 10 | 0.5 | 0.5 | 3 |
| Example 309 | Fe_{52.50}Co_{22.50}B_{11.00}P_{9.00}Si_{4.00}C_{0.50}Ta_{0.50} | 1.38 | 20 | 0.3 | 10 | 0.5 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 296 | 24.6 | 49.9 | 10.2 | 3.1 | 3.7 | 0.5 | 0.5 | 0.4 | 32.8 | 9.9 | 461 |
| Example 297 | 24.6 | 50.0 | 10.1 | 3.1 | 3.8 | 0.5 | 0.5 | 0.4 | 32.7 | 9.8 | 460 |
| Example 298 | 24.7 | 49.9 | 10.3 | 3.1 | 3.8 | 0.5 | 0.5 | 0.4 | 32.7 | 9.8 | 460 |
| Example 299 | 24.6 | 50.0 | 10.3 | 3.1 | 3.8 | 0.5 | 0.5 | 0.3 | 32.7 | 9.8 | 459 |
| Example 300 | 24.6 | 49.8 | 10.2 | 3.1 | 3.8 | 0.5 | 0.5 | 0.3 | 32.6 | 9.7 | 459 |
| Example 301 | 24.5 | 49.9 | 10.1 | 3.1 | 3.8 | 0.5 | 0.5 | 0.5 | 32.6 | 9.7 | 460 |
| Example 302 | 24.6 | 50.0 | 10.2 | 3.1 | 3.8 | 0.6 | 0.5 | 0.3 | 32.6 | 9.7 | 459 |
| Example 303 | 24.6 | 49.9 | 10.2 | 3.1 | 3.8 | 0.5 | 0.5 | 0.3 | 32.5 | 9.6 | 460 |
| Example 304 | 24.7 | 49.9 | 10.2 | 3.1 | 3.8 | 0.5 | 0.5 | 0.4 | 32.4 | 9.6 | 461 |
| Example 305 | 24.6 | 50.0 | 10.2 | 3.1 | 3.8 | 0.6 | 0.5 | 0.4 | 32.4 | 9.5 | 460 |
| Example 306 | 24.7 | 50.0 | 10.2 | 3.1 | 3.8 | 0.6 | 0.5 | 0.4 | 32.3 | 9.4 | 460 |
| Example 307 | 24.5 | 49.9 | 10.2 | 3.1 | 3.8 | 0.6 | 0.5 | 0.4 | 32.3 | 9.4 | 460 |
| Example 308 | 24.6 | 49.8 | 10.2 | 3.1 | 3.9 | 0.6 | 0.5 | 0.4 | 31.9 | 9.1 | 461 |
| Example 309 | 24.6 | 49.9 | 10.2 | 3.1 | 3.8 | 0.6 | 0.5 | 0.3 | 31.9 | 9.1 | 460 |

TABLE 8B

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 310 | Fe_{52.50}Co_{22.50}B_{11.00}P_{9.00}Si_{4.00}C_{0.50}W_{0.50} | 1.38 | 20 | 0.3 | 10 | 0.5 | 0.5 | 3 |
| Example 311 | Fe_{52.50}Co_{22.50}B_{11.00}P_{9.00}Si_{4.00}C_{0.50}Au_{0.50} | 1.38 | 20 | 0.3 | 10 | 0.5 | 0.5 | 3 |
| Example 312 | Fe_{52.50}Co_{22.50}B_{11.00}P_{9.00}Si_{4.00}C_{0.50}Bi_{0.50} | 1.38 | 20 | 0.3 | 10 | 0.5 | 0.5 | 3 |
| Example 313 | Fe_{52.50}Co_{22.50}B_{11.00}P_{9.00}Si_{4.00}C_{0.50}Y_{0.50} | 1.40 | 20 | 0.3 | 10 | 0.5 | 0.5 | 3 |
| Example 314 | Fe_{52.50}Co_{22.50}B_{11.00}P_{9.00}Si_{4.00}C_{0.50}La_{0.50} | 1.39 | 20 | 0.3 | 10 | 0.5 | 0.5 | 3 |
| Example 315 | Fe_{52.50}Co_{22.50}B_{11.00}P_{9.00}Si_{4.00}C_{0.50}Pt_{0.50} | 1.38 | 20 | 0.3 | 10 | 0.5 | 0.5 | 3 |
| Example 316 | Fe_{52.83}Co_{22.64}B_{11.00}P_{9.00}Si_{4.00}C_{0.50}S_{0.025} | 1.42 | 20 | 0.3 | 10 | 0.5 | 0.5 | 3 |
| Example 317 | Fe_{52.83}Co_{22.64}B_{11.00}P_{9.00}Si_{4.00}C_{0.50}Mg_{0.025} | 1.42 | 20 | 0.3 | 10 | 0.5 | 0.5 | 3 |
| Example 318 | Fe_{52.83}Co_{22.64}B_{11.00}P_{9.00}Si_{4.00}C_{0.50}Ca_{0.025} | 1.42 | 20 | 0.3 | 10 | 0.5 | 0.5 | 3 |
| Example 319 | Fe_{52.83}Co_{22.64}B_{11.00}P_{9.00}Si_{4.00}C_{0.50}N_{0.025} | 1.42 | 20 | 0.3 | 10 | 0.5 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 310 | 24.6 | 49.9 | 10.2 | 3.1 | 3.9 | 0.6 | 0.5 | 0.4 | 32.8 | 9.0 | 461 |
| Example 311 | 24.6 | 49.8 | 10.3 | 3.1 | 3.7 | 0.5 | 0.5 | 0.3 | 32.7 | 9.0 | 459 |
| Example 312 | 24.7 | 49.8 | 10.3 | 3.1 | 3.9 | 0.6 | 0.5 | 0.3 | 32.7 | 8.9 | 461 |
| Example 313 | 24.7 | 50.0 | 10.2 | 3.1 | 3.9 | 0.7 | 0.5 | 0.4 | 32.7 | 9.6 | 459 |
| Example 314 | 24.6 | 49.9 | 10.3 | 3.1 | 3.9 | 0.6 | 0.5 | 0.4 | 32.6 | 9.3 | 459 |
| Example 315 | 24.6 | 49.8 | 10.1 | 3.1 | 3.8 | 0.6 | 0.5 | 0.3 | 32.6 | 9.0 | 459 |
| Example 316 | 24.6 | 49.9 | 10.2 | 3.1 | 3.9 | 0.6 | 0.5 | 0.3 | 33.0 | 10.1 | 460 |
| Example 317 | 24.6 | 50.0 | 10.3 | 3.1 | 3.8 | 0.5 | 0.5 | 0.5 | 33.0 | 10.1 | 461 |
| Example 318 | 24.6 | 49.9 | 10.2 | 3.1 | 3.8 | 0.6 | 0.5 | 0.4 | 33.0 | 10.1 | 461 |
| Example 319 | 24.6 | 49.9 | 10.1 | 3.1 | 3.8 | 0.5 | 0.5 | 0.4 | 33.0 | 10.1 | 460 |

Each example having a composition within a predetermined range exhibited good properties. On the contrary to this, the withstand voltage decreased in the case of Comparative examples 183, 190, 197, 204, 211, and 218 where the content ratio of X2 was too large. Further, Bs, the relative permeability, and/or the DC superimposition characteristic also decreased in some of the comparative examples.

### Experiment Example 7

Experiment example 7 was carried out under the same conditions as in the case of Experiment 21 except that a water injecting condition which injected water intermittently from the intermittent injection holes was changed accordingly. Results are shown in Table 9. In Table 9, the result of Example 5 is shown as a reference.

TABLE 9

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 5 | Fe_{53.20}Co_{22.80}B_{11.00}P_{9.00}Si_{4.00} | 1.42 | 24 | N/A | | | | 1 |
| Example 323 | Fe_{53.20}Co_{22.80}B_{11.00}P_{9.00}Si_{4.00} | 1.42 | 20 | 0.3 | 7.5 | 0.5 | 0.2 | 2 |
| Example 21 | Fe_{53.20}Co_{22.80}B_{11.00}P_{9.00}Si_{4.00} | 1.42 | 20 | 0.3 | 10.0 | 0.5 | 0.5 | 3 |
| Example 324 | Fe_{53.20}Co_{22.80}B_{11.00}P_{9.00}Si_{4.00} | 1.42 | 20 | 0.3 | 15.0 | 0.5 | 1.0 | 4 |
| Example 325 | Fe_{53.20}Co_{22.80}B_{11.00}P_{9.00}Si_{4.00} | 1.42 | 20 | 0.3 | 22.5 | 0.5 | 1.6 | 5 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 5 | 24.3 | 41.6 | 14.2 | 3.4 | — | — | 0.4 | — | 33.1 | 9.9 | 390 |
| Example 323 | 24.9 | 47.6 | 12.0 | 3.3 | 0.4 | 0.7 | 0.5 | 0.4 | 34.0 | 10.1 | 476 |
| Example 21 | 24.6 | 49.9 | 10.2 | 3.1 | 3.8 | 0.6 | 0.5 | 0.4 | 34.1 | 10.2 | 476 |
| Example 324 | 25.3 | 52.1 | 7.5 | 2.8 | 3.9 | 0.7 | 0.5 | 0.4 | 34.0 | 10.2 | 476 |
| Example 325 | 24.8 | 52.5 | 4.7 | 3.9 | 2.2 | 0.8 | 0.4 | 0.3 | 34.1 | 10.1 | 478 |

Each example having a composition within a predetermined range exhibited good properties even when the water injecting condition was changed. Also, the higher the water pressure and the longer the injecting time, the larger the n tends to be. That is, the higher the water pressure and the longer the injecting time, the resulting powder can be represented by a particle size distribution obtained through the multiple probability density functions.

### Experiment Example 7A

Experiment example 7A was carried out under the same conditions as in the case of Examples 5 and 21 except that the water injecting conditions were changed accordingly. Results are shown in Table 10. In regards with each soft magnetic alloy powder shown in Table 10, the oxygen content changed drastically depending on the size of D50; and the smaller the D50 of the example, the larger the oxygen content tended to be. However, for each of the examples, the oxygen content was 300 ppm or greater and 10000 ppm or less.

TABLE 10

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 326 | Fe_{53.20}Co_{22.80}B_{11.00}P_{9.00}Si_{4.00} | 1.42 | 75 | N/A | | | | 1 |
| Example 327 | Fe_{53.20}Co_{22.80}B_{11.00}P_{9.00}Si_{4.00} | 1.42 | 55 | N/A | | | | 1 |
| Example 328 | Fe_{53.20}Co_{22.80}B_{11.00}P_{9.00}Si_{4.00} | 1.42 | 35 | N/A | | | | 1 |
| Example 329 | Fe_{53.20}Co_{22.80}B_{11.00}P_{9.00}Si_{4.00} | 1.42 | 27 | N/A | | | | 1 |
| Example 5 | Fe_{53.20}Co_{22.80}B_{11.00}P_{9.00}Si_{4.00} | 1.42 | 24 | N/A | | | | 1 |
| Example 330 | Fe_{53.20}Co_{22.80}B_{11.00}P_{9.00}Si_{4.00} | 1.42 | 20 | N/A | | | | 1 |
| Example 331 | Fe_{53.20}Co_{22.80}B_{11.00}P_{9.00}Si_{4.00} | 1.42 | 18 | N/A | | | | 1 |
| Example 332 | Fe_{53.20}Co_{22.80}B_{11.00}P_{9.00}Si_{4.00} | 1.42 | 16 | N/A | | | | 1 |
| Example 333 | Fe_{53.20}Co_{22.80}B_{11.00}P_{9.00}Si_{4.00} | 1.42 | 70 | 0.3 | 7.5 | 1.0 | 0.5 | 3 |
| Example 334 | Fe_{53.20}Co_{22.80}B_{11.00}P_{9.00}Si_{4.00} | 1.42 | 50 | 0.3 | 7.5 | 1.0 | 0.5 | 3 |
| Example 335 | Fe_{53.20}Co_{22.80}B_{11.00}P_{9.00}Si_{4.00} | 1.42 | 30 | 0.3 | 7.5 | 1.0 | 0.5 | 3 |
| Example 336 | Fe_{53.20}Co_{22.80}B_{11.00}P_{9.00}Si_{4.00} | 1.42 | 25 | 0.3 | 10 | 0.5 | 1.0 | 3 |
| Example 21 | Fe_{53.20}Co_{22.80}B_{11.00}P_{9.00}Si_{4.00} | 1.42 | 20 | 0.3 | 10 | 0.5 | 0.4 | 3 |
| Example 337 | Fe_{53.20}Co_{22.80}B_{11.00}P_{9.00}Si_{4.00} | 1.42 | 15 | 0.3 | 10 | 0.5 | 1.0 | 3 |
| Example 338 | Fe_{53.20}Co_{22.80}B_{11.00}P_{9.00}Si_{4.00} | 1.42 | 15 | 0.3 | 5.0 | 1.0 | 0.3 | 3 |
| Example 339 | Fe_{53.20}Co_{22.80}B_{11.00}P_{9.00}Si_{4.00} | 1.42 | 15 | 0.3 | 2.5 | 0.5 | 1.0 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 326 | 1.5 | 3.5 | 0.7 | 0.9 | — | — | 0.7 | — | 12.0 | 25.0 | 399 |
| Example 327 | 3.1 | 7.1 | 1.4 | 1.6 | — | — | 0.6 | — | 17.0 | 19.4 | 398 |
| Example 328 | 9.6 | 18.7 | 5.0 | 2.6 | — | — | 0.5 | — | 25.0 | 13.2 | 397 |
| Example 329 | 18.2 | 32.4 | 10.2 | 3.2 | — | — | 0.4 | — | 31.0 | 10.6 | 393 |
| Example 5 | 24.3 | 41.6 | 14.2 | 3.4 | — | — | 0.4 | — | 33.1 | 9.9 | 390 |
| Example 330 | 37.8 | 60.2 | 23.7 | 3.8 | — | — | 0.4 | — | 36.0 | 9.1 | 388 |
| Example 331 | 48.4 | 74.5 | 31.6 | 4.1 | — | — | 0.3 | — | 37.0 | 8.9 | 387 |
| Example 332 | 69.1 | 100.3 | 48.1 | 4.4 | — | — | 0.3 | — | 40.0 | 8.2 | 385 |
| Example 333 | 1.5 | 3.7 | 0.7 | 1.0 | 0.4 | 0.4 | 0.7 | 0.6 | 12.4 | 25.5 | 487 |
| Example 334 | 3.2 | 7.5 | 1.4 | 1.7 | 0.9 | 0.5 | 0.6 | 0.5 | 17.5 | 19.8 | 486 |
| Example 335 | 10.0 | 21.1 | 4.8 | 2.7 | 1.1 | 0.8 | 0.6 | 0.6 | 25.8 | 13.4 | 485 |
| Example 336 | 18.0 | 34.3 | 8.0 | 3.3 | 2.6 | 0.5 | 0.4 | 0.5 | 31.9 | 10.8 | 480 |
| Example 21 | 24.6 | 49.9 | 10.2 | 3.1 | 3.8 | 0.6 | 0.5 | 0.4 | 34.1 | 10.2 | 476 |
| Example 337 | 38.4 | 98.8 | 14.7 | 4.3 | 2.9 | 0.6 | 0.7 | 0.7 | 37.1 | 9.3 | 474 |
| Example 338 | 44.7 | 79.6 | 24.6 | 4.1 | 2.9 | 0.8 | 0.5 | 0.9 | 38.1 | 9.1 | 473 |
| Example 339 | 69.9 | 105.5 | 46.6 | 4.4 | 3.2 | 1.0 | 0.3 | 0.3 | 40.1 | 8.2 | 470 |

In the case of changing the particle size of the soft magnetic alloy particle by changing the injecting condition, the larger the particle size, the larger the relative permeability and the smaller the DC superimposition characteristic tended to be. Also, in the case that other conditions were substantially the same, the soft magnetic alloy powder of n=3 exhibited excellent relative permeability, DC superimposition characteristic, and withstand voltage compared to the soft magnetic alloy powder of n=1.

### Experiment Example 8

Experiment example 8 was carried out under the same conditions as in the case of Comparative example 17 and Examples 18 to 25 except that, in Experiment example 8, a heat treatment was carried out to the soft magnetic alloy powder which was obtained after water atomization. A heat treatment temperature was (Tx−100° C.), and a heat treatment time was 60 min. Results are shown in Table 11.

TABLE 11

| | | | | | | | | DC | |
|---|---|---|---|---|---|---|---|---|---|
| | | | | | | | | superimposition | Withstand |
| | | | Bs | Tg | Tx | ΔTx | Relative | characteristic | voltage |
| Sample | Composition (Atomic ratio) | Heat treatment | T | ° C. | ° C. | ° C. | permeability | A | V/mm |
| Comparative | Fe_{47.60}Co_{20.40}B_{15.00}P_{12.00}Si_{5.00} | No heat treatment | 1.29 | 503.0 | 560.3 | 57.3 | 29.8 | 4.3 | 289 |
| example 17 | | | | | | | | | |
| Comparative | | Heat treated | | 514.4 | | 45.9 | 33.3 | 4.8 | 288 |
| example 340 | | | | | | | | | |
| Example 18 | Fe_{49.00}Co_{21.00}B_{13.00}P_{12.00}Si_{5.00} | No heat treatment | 1.31 | 500.0 | 550.0 | 50.0 | 30.5 | 5.7 | 403 |
| Example 341 | | Heat treated | | 511.0 | | 39.0 | 34.0 | 6.3 | 402 |
| Example 19 | Fe_{50.40}Co_{21.60}B_{11.00}P_{12.00}Si_{5.00} | No heat treatment | 1.33 | 497.0 | 539.7 | 42.7 | 31.2 | 6.8 | 460 |
| Example 342 | | Heat treated | | 507.1 | | 32.6 | 34.4 | 7.6 | 462 |
| Example 20 | Fe_{51.80}Co_{22.20}B_{11.00}P_{10.00}Si_{5.00} | No heat treatment | 1.37 | 494.0 | 529.4 | 35.4 | 32.7 | 8.8 | 462 |
| Example 343 | | Heat treated | | 505.8 | | 23.6 | 36.3 | 9.7 | 462 |
| Example 21 | Fe_{53.20}Co_{22.80}B_{11.00}P_{9.00}Si_{4.00} | No heat treatment | 1.42 | 491.0 | 519.1 | 28.1 | 34.1 | 10.2 | 476 |
| Example 345 | | Heat treated | | 502.1 | | 17.0 | 37.5 | 11.2 | 475 |
| Example 22 | Fe_{54.60}Co_{23.40}B_{11.00}P_{8.00}Si_{3.00} | No heat treatment | 1.50 | 488.0 | 508.8 | 20.8 | 34.3 | 11.3 | 467 |
| Example 346 | | Heat treated | | 499.1 | | 9.7 | 38.3 | 12.5 | 465 |
| Example 23 | Fe_{56.00}Co_{24.00}B_{11.00}P_{7.00}Si_{2.00} | No heat treatment | 1.59 | 485.0 | 498.5 | 13.5 | 35.2 | 11.3 | 466 |
| Example 347 | | Heat treated | | — | | — | 38.7 | 12.5 | 466 |
| Example 24 | Fe_{57.40}Co_{24.60}B_{11.00}P_{5.00}Si_{2.00} | No heat treatment | 1.70 | — | 488.2 | — | 35.0 | 10.5 | 460 |
| Example 348 | | Heat treated | | — | | — | 38.9 | 11.6 | 463 |
| Example 25 | Fe_{58.80}Co_{25.20}B_{11.00}P_{4.00}Si_{1.00} | No heat treatment | 1.82 | — | 477.9 | — | 32.8 | 9.4 | 432 |
| Example 349 | | Heat treated | | — | | — | 36.1 | 10.6 | 430 |

According to Table 11, in the case that the content ratio of FeCo was 78.00 at % or less, the soft magnetic alloy powder after the heat treatment also had a glass transition temperature Tg. In contrast, in the case that the content ratio of FeCo was 80.00 at % or larger, the soft magnetic alloy powder after the heat treatment did not have the glass transition temperature Tg.

### Experiment Example 9

Experiment example 9 was carried out under the same conditions as in the case of Example 188 except that, in Experiment example 9, the heat treatment was carried out to the soft magnetic alloy powder which was obtained after the water atomization. A temperature rising rate was shown in Table 12. Specifically, the temperature rising rate was 10° C./min for Example 350. The temperature rising rate was 40° C./min for Example 351. The temperature rising rate was 100° C./min for Example 352. The heat treatment condition of each example was selected so as to achieve the highest relative permeability for each example. Specifically, for each example, the heat treatment temperature was selected from the range between 40° and 500° C., and the heat treatment time was selected from the range between 1 to 30 min.

TABLE 12

| | | | | | | DC | |
|---|---|---|---|---|---|---|---|
| | | | Temperature | Nano | | superimposition | Withstand |
| | | Bs | rising rate | crystal | Relative | characteristic | voltage |
| Sample | Composition (Atomic ratio) | T | ° C./min | nm | permeability | A | V/mm |
| Example 188 | Fe_{52.50}Co_{22.50}B_{11.00}P_{9.00}Si_{4.00}Cu_{1.00} | 1.39 | N/A | N/A | 33.3 | 9.4 | 449 |
| Example 350 | Fe_{52.50}Co_{22.50}B_{11.00}P_{9.00}Si_{4.00}Cu_{1.00} | 1.41 | 10 | 50 | 34.0 | 9.5 | 447 |
| Example 351 | Fe_{52.50}Co_{22.50}B_{11.00}P_{9.00}Si_{4.00}Cu_{1.00} | 1.40 | 40 | 18 | 35.2 | 9.4 | 446 |
| Example 352 | Fe_{52.50}Co_{22.50}B_{11.00}P_{9.00}Si_{4.00}Cu_{1.00} | 1.39 | 100 | 12 | 36.0 | 9.4 | 445 |

Each soft magnetic alloy powder obtained in Examples 350 to 352 was verified whether it included amorphous or a nanocrystal. The presence of a peak derived from the nanocrystal was verified using XRD. The peak derived from the nanocrystal was confirmed in Examples 350 to 352. That is, it was confirmed that the nanocrystal was included in the soft magnetic powder. Average particle sizes of the nanocrystals in Examples 350 to 352 are shown in Table 12. The faster the temperature rising rate, the smaller the particle size of the nanocrystal and the higher the relative permeability tended to be.

### Experiment Example 10

Experiment example 10 was carried out under the same conditions as in the case of Example 21 except that, in Experiment example 10, a phosphate-based coating or a silica-based coating was performed to the soft magnetic alloy powder of Example 21. The phosphate-based coating was carried out by applying a solution including phosphate on the soft magnetic alloy powder. The silica-based coating was carried out by applying a solution including SiO2 on the soft magnetic alloy powder. An average thickness of the phosphate-based coating and an average thickness of the silica-based coating were controlled to be the values shown in Table 13. Results are shown in Table 13. Parameters not shown in Table 13 were the same as Example 21 for all of the examples shown in Table 13.

TABLE 13

| | | | | | | DC | |
|---|---|---|---|---|---|---|---|
| | | | Cotaing | | | superimposition | Withstand |
| | | Bs | Type | Thickness | Relative | characteristic | voltage |
| Sample | Composition (Atomic ratio) | T | — | nm | permeability | A | V/mm |
| Example 21 | Fe_{53.20}Co_{22.80}B_{11.00}P_{9.00}Si_{4.00} | 1.42 | N/A | 0 | 34.1 | 10.2 | 476 |
| Example 353 | Fe_{53.20}Co_{22.80}B_{11.00}P_{9.00}Si_{4.00} | 1.42 | Phosphate- | 5 | 34.0 | 10.3 | 508 |
| Example 354 | Fe_{53.20}Co_{22.80}B_{11.00}P_{9.00}Si_{4.00} | 1.42 | based | 10 | 33.9 | 10.5 | 511 |
| Example 355 | Fe_{53.20}Co_{22.80}B_{11.00}P_{9.00}Si_{4.00} | 1.42 | | 30 | 33.6 | 11.0 | 517 |
| Example 356 | Fe_{53.20}Co_{22.80}B_{11.00}P_{9.00}Si_{4.00} | 1.42 | | 50 | 33.3 | 11.5 | 519 |
| Example 357 | Fe_{53.20}Co_{22.80}B_{11.00}P_{9.00}Si_{4.00} | 1.42 | Silica- | 5 | 34.0 | 10.3 | 519 |
| Example 358 | Fe_{53.20}Co_{22.80}B_{11.00}P_{9.00}Si_{4.00} | 1.42 | based | 10 | 33.9 | 10.5 | 522 |
| Example 359 | Fe_{53.20}Co_{22.80}B_{11.00}P_{9.00}Si_{4.00} | 1.42 | | 30 | 33.7 | 11.0 | 524 |
| Example 360 | Fe_{53.20}Co_{22.80}B_{11.00}P_{9.00}Si_{4.00} | 1.42 | | 50 | 33.4 | 11.5 | 527 |

Examples 353 to 360 exhibited excellent properties which were about the same as those exhibited in Example 21. Also, the thinner the coating, the higher the relative permeability tended to be. The thicker the coating, the higher the DC superimposition characteristic and the withstand voltage tended to be.

### Experiment Example 10A

In Experiment example 10A the soft magnetic alloy powder of Example 21 was used as a powder A (a powder having D50 of 24.7 μm). The powders shown in Tables 14A to 14C (the soft magnetic alloy powder, the Fe powder, the FeNi alloy powder, and the FeCo alloy powder of Example 334) were used as a powder B (a powder having D50 of 3.2 μm). The powders shown in Tables 14A to 14C (the soft magnetic alloy powder, the Fe powder, the FeNi alloy powder, and the FeCo alloy powder of Example 333) were used as a powder C (a powder having D50 of 1.5 μm). The above-mentioned FeNi alloy powder was a powder which an atomic ratio of Fe to Ni was Fe: Ni=30:70. The above-mentioned FeCo alloy powder was a powder which an atomic ratio of Fe to Co was Fe: Co=50:50. Also, the compositions of Example 21, Example 333, and Example 334 were the same.

A powder obtained by mixing two or more selected from the powder A, the powder B, and the powder C in a mass ratio shown in Tables 14A to 14C were treated under the same conditions as in the case of Example 21. Results are shown in Tables 14A to 14C. The mixed powder of each example shown in Tables 14A to 14C had a composition within the above-mentioned range, and satisfied 0≤|exp(μ₁)−exp(μ₂)|/(D90−D10)≤1.0, 0.1≤σ_{1≤1.1}, and 0.01≤σ₂≤1.5.

TABLE 14A

| | Powder A | | | | Powder B | | | |
|---|---|---|---|---|---|---|---|---|
| | | | Bs/ | D50/ | | | Bs/ | D50/ |
| Sample | Composition (Atomic ratio) | Sample | T | μm | Composition (Atomic ratio) | Sample | T | μm |
| Example 361 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 362 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 363 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 364 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 365 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 366 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 366a | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 366b | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 366c | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 367 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 368 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 369 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} | Example334 | 1.42 | 3.2 |
| Example 370 | Fe_{53.20}Co_{22.80}B_{11.00}P_{9.00}Si_{4.00} | Example21 | 1.42 | 24.7 | Fe | | 2.00 | 3.2 |
| Example 371 | Fe_{53.20}Co_{22.80}B_{11.00}P_{9.00}Si_{4.00} | Example21 | 1.42 | 24.7 | FeNi | | 1.50 | 3.2 |
| Example 372 | Fe_{53.20}Co_{22.80}B_{11.00}P_{9.00}Si_{4.00} | Example21 | 1.42 | 24.7 | FeCo | | 2.30 | 3.2 |

| | | | | | | | DC | |
|---|---|---|---|---|---|---|---|---|
| | Powder C | | | | | | superimposition | Withstand |
| | | | Bs/ | D50/ | A:B:C | Relative | characteristic | voltage |
| Sample | Composition (Atomic ratio) | Sample | T | μm | Mass ratio | permeability | A | V/mm |
| Example 361 | Fe_{53.20}Co_{22.80}B_{11.00}P_{9.00}Si_{4.00} | Example333 | 1.42 | 1.5 | 90:5:5 | 35.0 | 10.2 | 483 |
| Example 362 | Fe_{53.20}Co_{22.80}B_{11.00}P_{9.00}Si_{4.00} | Example333 | 1.42 | 1.5 | 80:10:10 | 36.2 | 10.2 | 492 |
| Example 363 | Fe_{53.20}Co_{22.80}B_{11.00}P_{9.00}Si_{4.00} | Example333 | 1.42 | 1.5 | 75:12.5:12.5 | 38.0 | 10.2 | 503 |
| Example 364 | Fe_{53.20}Co_{22.80}B_{11.00}P_{9.00}Si_{4.00} | Example333 | 1.42 | 1.5 | 70:15:15 | 37.0 | 10.2 | 500 |
| Example 365 | Fe_{53.20}Co_{22.80}B_{11.00}P_{9.00}Si_{4.00} | Example333 | 1.42 | 1.5 | 60:20:20 | 36.0 | 10.2 | 488 |
| Example 366 | Fe_{53.20}Co_{22.80}B_{11.00}P_{9.00}Si_{4.00} | Example333 | 1.42 | 1.5 | 50:25:25 | 35.0 | 10.2 | 480 |
| Example 366a | Fe_{53.20}Co_{22.80}B_{11.00}P_{9.00}Si_{4.00} | Example333 | 1.42 | 1.5 | 40:30:30 | 34.8 | 10.2 | 475 |
| Example 366b | Fe_{53.20}Co_{22.80}B_{11.00}P_{9.00}Si_{4.00} | Example333 | 1.42 | 1.5 | 30:35:35 | 34.6 | 10.2 | 473 |
| Example 366c | Fe_{53.20}Co_{22.80}B_{11.00}P_{9.00}Si_{4.00} | Example333 | 1.42 | 1.5 | 20:40:40 | 34.5 | 10.2 | 470 |
| Example 367 | Fe | | 2.00 | 1.5 | 75:12.5:12.5 | 38.1 | 11.3 | 465 |
| Example 368 | FeNi | | 1.50 | 1.5 | 75:12.5:12.5 | 38.2 | 10.4 | 464 |
| Example 369 | FeCo | | 2.30 | 1.5 | 75:12.5:12.5 | 38.0 | 12.0 | 466 |
| Example 370 | Fe_{53.20}Co_{22.80}B_{11.00}P_{9.00}Si_{4.00} | Example333 | 1.42 | 1.5 | 75:12.5:12.5 | 37.9 | 11.5 | 460 |
| Example 371 | Fe_{53.20}Co_{22.80}B_{11.00}P_{9.00}Si_{4.00} | Example333 | 1.42 | 1.5 | 75:12.5:12.5 | 38.0 | 10.5 | 459 |
| Example 372 | Fe_{53.20}Co_{22.80}B_{11.00}P_{9.00}Si_{4.00} | Example333 | 1.42 | 1.5 | 75:12.5:12.5 | 38.1 | 12.1 | 459 |

TABLE 14B

| | Powder A | | | | |
|---|---|---|---|---|---|
| | | | Bs/ | D50/ | Powder B |
| Sample | Composition (Atomic ratio) | Sample | T | μm | Composition (Atomic ratio) |
| Example 1001 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} |
| Example 1002 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} |
| Example 1003 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} |
| Example 1004 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} |
| Example 1005 | Fe_{53.20}Co_{22.80}B_{11.00}P_{9.00}Si_{4.00} | Example21 | 1.42 | 24.7 | Fe_{53.20}Co_{22.80}B_{11.00}P_{9.00}Si_{4.00} |
| Example 1006 | Fe_{53.20}Co_{22.80}B_{11.00}P_{9.00}Si_{4.00} | Example21 | 1.42 | 24.7 | Fe |
| Example 1007 | Fe_{53.20}Co_{22.80}B_{11.00}P_{9.00}Si_{4.00} | Example21 | 1.42 | 24.7 | Fe |
| Example 1008 | Fe_{53.20}Co_{22.80}B_{11.00}P_{9.00}Si_{4.00} | Example21 | 1.42 | 24.7 | Fe |
| Example 1009 | Fe_{53.20}Co_{22.80}B_{11.00}P_{9.00}Si_{4.00} | Example21 | 1.42 | 24.7 | Fe |
| Example 1010 | Fe_{53.20}Co_{22.80}B_{11.00}P_{9.00}Si_{4.00} | Example21 | 1.42 | 24.7 | Fe |
| Example 1011 | Fe_{53.20}Co_{22.80}B_{11.00}P_{9.00}Si_{4.00} | Example21 | 1.42 | 24.7 | FeNi |
| Example 1012 | Fe_{53.20}Co_{22.80}B_{11.00}P_{9.00}Si_{4.00} | Example21 | 1.42 | 24.7 | FeCo |

| | | | | | | DC | |
|---|---|---|---|---|---|---|---|
| | Powder B | | | A:B | | superimposition | Withstand |
| | | Bs/ | D50/ | Mass | Relative | characteristic | voltage |
| Sample | Sample | T | μm | ratio | permeability | A | V/mm |
| Example 1001 | Example334 | 1.42 | 3.2 | 80:20 | 35.1 | 10.1 | 490 |
| Example 1002 | Example334 | 1.42 | 3.2 | 60:40 | 34.9 | 10.1 | 486 |
| Example 1003 | Example334 | 1.42 | 3.2 | 50:50 | 34.0 | 10.1 | 478 |
| Example 1004 | Example334 | 1.42 | 3.2 | 40:60 | 33.8 | 10.1 | 473 |
| Example 1005 | Example334 | 1.42 | 3.2 | 20:80 | 33.5 | 10.1 | 468 |
| Example 1006 | | 2.00 | 3.2 | 80:20 | 35.0 | 11.4 | 448 |
| Example 1007 | | 2.00 | 3.2 | 60:40 | 34.9 | 11.4 | 445 |
| Example 1008 | | 2.00 | 3.2 | 50:50 | 33.9 | 11.4 | 437 |
| Example 1009 | | 2.00 | 3.2 | 40:60 | 33.7 | 11.4 | 433 |
| Example 1010 | | 2.00 | 3.2 | 20:80 | 33.4 | 11.4 | 428 |
| Example 1011 | | 1.50 | 3.2 | 50:50 | 34.2 | 10.3 | 441 |
| Example 1012 | | 2.30 | 3.2 | 50:50 | 34.0 | 11.9 | 443 |

TABLE 14C

| | Powder B | | | | |
|---|---|---|---|---|---|
| | | | Bs/ | D50/ | Powder C |
| Sample | Composition (Atomic ratio) | Sample | T | μm | Composition (Atomic ratio) |
| Example 1013 | Fe_{53.20}Co_{22.80}B_{11.00}P_{9.00}Si_{4.00} | Example334 | 1.42 | 3.2 | Fe_{53.20}Co_{22.80}B_{11.00}P_{9.00}Si_{4.00} |
| Example 1014 | Fe_{53.20}Co_{22.80}B_{11.00}P_{9.00}Si_{4.00} | Example334 | 1.42 | 3.2 | Fe_{53.20}Co_{22.80}B_{11.00}P_{9.00}Si_{4.00} |
| Example 1015 | Fe_{53.20}Co_{22.80}B_{11.00}P_{9.00}Si_{4.00} | Example334 | 1.42 | 3.2 | Fe_{53.20}Co_{22.80}B_{11.00}P_{9.00}Si_{4.00} |
| Example 1016 | Fe_{53.20}Co_{22.80}B_{11.00}P_{9.00}Si_{4.00} | Example334 | 1.42 | 3.2 | Fe_{53.20}Co_{22.80}B_{11.00}P_{9.00}Si_{4.00} |
| Example 1017 | Fe_{53.20}Co_{22.80}B_{11.00}P_{9.00}Si_{4.00} | Example334 | 1.42 | 3.2 | Fe_{53.20}Co_{22.80}B_{11.00}P_{9.00}Si_{4.00} |
| Example 1018 | Fe_{53.20}Co_{22.80}B_{11.00}P_{9.00}Si_{4.00} | Example334 | 1.42 | 3.2 | Fe |
| Example 1019 | Fe_{53.20}Co_{22.80}B_{11.00}P_{9.00}Si_{4.00} | Example334 | 1.42 | 3.2 | Fe |
| Example 1020 | Fe_{53.20}Co_{22.80}B_{11.00}P_{9.00}Si_{4.00} | Example334 | 1.42 | 3.2 | Fe |
| Example 1021 | Fe_{53.20}Co_{22.80}B_{11.00}P_{9.00}Si_{4.00} | Example334 | 1.42 | 3.2 | Fe |
| Example 1022 | Fe_{53.20}Co_{22.80}B_{11.00}P_{9.00}Si_{4.00} | Example334 | 1.42 | 3.2 | Fe |
| Example 1023 | Fe_{53.20}Co_{22.80}B_{11.00}P_{9.00}Si_{4.00} | Example334 | 1.42 | 3.2 | FeNi |
| Example 1024 | Fe_{53.20}Co_{22.80}B_{11.00}P_{9.00}Si_{4.00} | Example334 | 1.42 | 3.2 | FeCo |

| | | | | | | DC | |
|---|---|---|---|---|---|---|---|
| | Powder C | | | B:C | | superimposition | Withstand |
| | | Bs/ | D50/ | Mass | Relative | characteristic | voltage |
| Sample | Sample | T | μm | ratio | permeability | A | V/mm |
| Example 1013 | Example333 | 1.42 | 1.5 | 80:20 | 12.7 | 25.4 | 501 |
| Example 1014 | Example333 | 1.42 | 1.5 | 60:40 | 12.7 | 25.4 | 497 |
| Example 1015 | Example333 | 1.42 | 1.5 | 50:50 | 12.3 | 25.4 | 489 |
| Example 1016 | Example333 | 1.42 | 1.5 | 40:60 | 12.3 | 25.4 | 484 |
| Example 1017 | Example333 | 1.42 | 1.5 | 20:80 | 12.1 | 25.4 | 479 |
| Example 1018 | | 2.00 | 1.5 | 80:20 | 12.7 | 28.7 | 459 |
| Example 1019 | | 2.00 | 1.5 | 60:40 | 12.7 | 25.4 | 497 |
| Example 1020 | | 2.00 | 1.5 | 50:50 | 12.3 | 25.4 | 489 |
| Example 1021 | | 2.00 | 1.5 | 40:60 | 12.3 | 25.4 | 484 |
| Example 1022 | | 2.00 | 1.5 | 20:80 | 12.1 | 25.4 | 479 |
| Example 1023 | | 1.50 | 1.5 | 50:50 | 12.4 | 22.9 | 494 |
| Example 1024 | | 2.30 | 1.5 | 50:50 | 12.3 | 26.5 | 491 |

The soft magnetic alloy powders of Examples 361 to 372 of Table 14A and Examples 1001 to 1012 of Table 14B exhibited excellent properties which were about the same as each example of Example 21 and the like. Also, the soft magnetic alloy powders of Examples 1013 to 1024 shown in Table 14C had a lower relative permeability and a higher DC superimposition characteristic compared to the soft magnetic alloy powders of other examples of Experiment example 10A. This is due to the smaller D50 of the soft magnetic alloy powder.

### Experiment Example 11

Experiment example 11 was carried out under the same conditions as Example 21 or Example 334 except for changing the oxygen content. Results are shown in Table 15. The oxygen content was varied by regulating the drying condition. Specifically, the atmosphere during drying was changed from a vacuum atmosphere of 1×10⁻⁴ Pa and 1×10⁻² Pa to the atmosphere having oxygen concentration of 5%. A drying temperature was 50° C. and a drying time was 12 hours.

TABLE 15

| | | | Continuous | | | | | |
|---|---|---|---|---|---|---|---|---|
| | | | injection | | | | | |
| | | | hole | Intermittent injection hole | | | | |
| | | Oxygen | Water | Hole | Water | Injection | Injection | |
| | | content | pressure | diameter | pressure | interval | time | |
| Sample | Composition (Atomic ratio) | ppm | MPa | mm | MPa | s | s | n |
| Example 373 | Fe_{53.20}Co_{22.80}B_{11.00}P_{9.00}Si_{4.00} | 1000 | 20 | 0.3 | 10 | 0.5 | 0.5 | 3 |
| Example 21 | Fe_{53.20}Co_{22.80}B_{11.00}P_{9.00}Si_{4.00} | 1500 | 20 | 0.3 | 10 | 0.5 | 0.5 | 3 |
| Example 374 | Fe_{53.20}Co_{22.80}B_{11.00}P_{9.00}Si_{4.00} | 1980 | 20 | 0.3 | 10 | 0.5 | 0.5 | 3 |
| Example 375 | Fe_{53.20}Co_{22.80}B_{11.00}P_{9.00}Si_{4.00} | 3300 | 20 | 0.3 | 10 | 0.5 | 0.5 | 3 |
| Example 376 | Fe_{53.20}Co_{22.80}B_{11.00}P_{9.00}Si_{4.00} | 6530 | 20 | 0.3 | 10 | 0.5 | 0.5 | 3 |
| Example 377 | Fe_{53.20}Co_{22.80}B_{11.00}P_{9.00}Si_{4.00} | 9890 | 20 | 0.3 | 10 | 0.5 | 0.5 | 3 |
| Example 378 | Fe_{53.20}Co_{22.80}B_{11.00}P_{9.00}Si_{4.00} | 3500 | 50 | 0.3 | 7.5 | 1.0 | 0.5 | 3 |
| Example 334 | Fe_{53.20}Co_{22.80}B_{11.00}P_{9.00}Si_{4.00} | 5000 | 50 | 0.3 | 7.5 | 1.0 | 0.5 | 3 |
| Example 379 | Fe_{53.20}Co_{22.80}B_{11.00}P_{9.00}Si_{4.00} | 6380 | 50 | 0.3 | 7.5 | 1.0 | 0.5 | 3 |
| Example 380 | Fe_{53.20}Co_{22.80}B_{11.00}P_{9.00}Si_{4.00} | 8800 | 50 | 0.3 | 7.5 | 1.0 | 0.5 | 3 |
| Example 381 | Fe_{53.20}Co_{22.80}B_{11.00}P_{9.00}Si_{4.00} | 9790 | 50 | 0.3 | 7.5 | 1.0 | 0.5 | 3 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 373 | 24.6 | 49.9 | 10.2 | 3.1 | 3.8 | 0.6 | 0.5 | 0.4 | 34.1 | 10.2 | 476 |
| Example 21 | 24.6 | 49.9 | 10.2 | 3.1 | 3.8 | 0.6 | 0.5 | 0.4 | 34.1 | 10.2 | 476 |
| Example 374 | 24.7 | 50.0 | 10.1 | 3.1 | 3.8 | 0.6 | 0.5 | 0.4 | 34.0 | 10.1 | 476 |
| Example 375 | 24.6 | 49.8 | 10.1 | 3.1 | 3.7 | 0.5 | 0.5 | 0.3 | 34.0 | 10.0 | 477 |
| Example 376 | 24.6 | 49.8 | 10.2 | 3.1 | 3.9 | 0.7 | 0.5 | 0.4 | 33.9 | 9.3 | 478 |
| Example 377 | 24.6 | 50.0 | 10.2 | 3.1 | 3.8 | 0.6 | 0.5 | 0.3 | 20.0 | 7.1 | 480 |
| Example 378 | 3.2 | 7.5 | 1.4 | 1.7 | 0.9 | 0.5 | 0.6 | 0.5 | 17.5 | 19.8 | 486 |
| Example 334 | 3.2 | 7.5 | 1.4 | 1.7 | 0.9 | 0.5 | 0.6 | 0.5 | 17.5 | 19.8 | 486 |
| Example 379 | 3.2 | 7.5 | 1.4 | 1.7 | 0.9 | 0.5 | 0.6 | 0.5 | 17.4 | 19.7 | 490 |
| Example 380 | 3.2 | 7.5 | 1.4 | 1.7 | 0.9 | 0.5 | 0.6 | 0.5 | 16.0 | 18.2 | 493 |
| Example 381 | 3.2 | 7.5 | 1.4 | 1.7 | 0.9 | 0.5 | 0.6 | 0.5 | 11.0 | 17.1 | 495 |

Each example in Table 15 which the oxygen content was 10000 ppm or less exhibited good properties. As the particle size of the soft magnetic alloy powder decreased, the oxygen content increased. Note that, the samples having lower oxygen content than Example 21 by lowering the atmosphere pressure and/or the oxygen concentration exhibited no difference in properties of Example 21. The same applies even in the case of replacing Example 21 with Example 334. Also, the larger the oxygen content, the better the withstand voltage, but the DC superimposition characteristic and the permeability decreased. This is because the larger the oxygen content of the soft magnetic alloy powder, the more oxides are included in the soft magnetic alloy powder.

### Experiment Example 12

Experiment example 12 was carried out under the same conditions as in the case of Example 21 except that various test conditions were changed accordingly to achieve n=5. Further, by controlling the injecting time, σ₂ was mainly changed, and by changing the water pressure from the continuous injection holes and the intermittent injection holes, σ₁ was mainly changed. Results are shown in Table 16.

TABLE 16

| | | | Continuous | | | | | |
|---|---|---|---|---|---|---|---|---|
| | | | injection | | | | | |
| | | | hole | Intermittent injection hole | | | | |
| | | | Water | Hole | Water | Injection | Injection | |
| | | Bs | pressure | diameter | pressure | interval | time | |
| Sample | Composition (Atomic ratio) | T | MPa | mm | MPa | s | s | n |
| Example 401 | Fe_{53.20}Co_{22.80}B_{11.00}P_{9.00}Si_{4.00} | 1.42 | 50 | 0.3 | 15.0 | 0.1 | 0.3 | 5 |
| Example 402 | Fe_{53.20}Co_{22.80}B_{11.00}P_{9.00}Si_{4.00} | 1.42 | 50 | 0.3 | 15.0 | 0.1 | 0.5 | 5 |
| Example 403 | Fe_{53.20}Co_{22.80}B_{11.00}P_{9.00}Si_{4.00} | 1.42 | 50 | 0.3 | 15.0 | 0.1 | 0.7 | 5 |
| Example 404 | Fe_{53.20}Co_{22.80}B_{11.00}P_{9.00}Si_{4.00} | 1.42 | 50 | 0.3 | 15.0 | 0.1 | 1.0 | 5 |
| Example 405 | Fe_{53.20}Co_{22.80}B_{11.00}P_{9.00}Si_{4.00} | 1.42 | 50 | 0.3 | 15.0 | 0.1 | 3.0 | 5 |
| Example 406 | Fe_{53.20}Co_{22.80}B_{11.00}P_{9.00}Si_{4.00} | 1.42 | 50 | 0.3 | 15.0 | 0.1 | 10.0 | 5 |
| Example 407 | Fe_{53.20}Co_{22.80}B_{11.00}P_{9.00}Si_{4.00} | 1.42 | 65 | 0.3 | 17.5 | 0.1 | 0.7 | 5 |
| Example 408 | Fe_{53.20}Co_{22.80}B_{11.00}P_{9.00}Si_{4.00} | 1.42 | 40 | 0.3 | 12.5 | 0.1 | 0.7 | 5 |
| Example 409 | Fe_{53.20}Co_{22.80}B_{11.00}P_{9.00}Si_{4.00} | 1.42 | 30 | 0.3 | 7.5 | 0.1 | 0.7 | 5 |

| | | | | | | | | | | DC | |
|---|---|---|---|---|---|---|---|---|---|---|---|
| | | | | | | | | | Relative | superimposition | Withstand |
| | D50 | D90 | D10 | μ₁ | μ₂ | Z | σ₁ | σ₂ | permeability | characteristic | voltage |
| Sample | μm | μm | μm | — | — | — | — | — | — | A | V/mm |
| Example 401 | 2.3 | 3.9 | 0.7 | 1.1 | 1.6 | 0.5 | 0.3 | 1.5 | 14.6 | 23.2 | 489 |
| Example 402 | 2.4 | 4.1 | 1.2 | 1.1 | 1.6 | 0.5 | 0.3 | 1.0 | 15.0 | 22.9 | 491 |
| Example 403 | 2.6 | 4.5 | 1.7 | 1.1 | 1.5 | 0.5 | 0.3 | 0.5 | 15.6 | 21.7 | 490 |
| Example 404 | 2.7 | 4.6 | 1.8 | 1.1 | 1.5 | 0.5 | 0.3 | 0.3 | 16.0 | 21.6 | 485 |
| Example 405 | 2.9 | 4.5 | 1.8 | 1.1 | 1.5 | 0.5 | 0.3 | 0.1 | 16.7 | 21.0 | 489 |
| Example 406 | 2.9 | 4.2 | 1.8 | 1.1 | 1.5 | 0.6 | 0.3 | 0.01 | 16.6 | 21.0 | 487 |
| Example 407 | 1.9 | 2.6 | 1.5 | 0.7 | 1.1 | 0.9 | 0.1 | 0.5 | 13.3 | 24.3 | 491 |
| Example 408 | 4.2 | 9.4 | 1.6 | 1.8 | 2.1 | 0.3 | 0.7 | 0.5 | 18.5 | 19.1 | 490 |
| Example 409 | 4.5 | 13.1 | 1.0 | 2.3 | 2.4 | 0.1 | 1.1 | 0.5 | 19.1 | 18.4 | 489 |

The soft magnetic alloy powder of each example shown in Table 16 exhibited excellent various properties as similar to other examples.

### REFERENCE SIGNS LIST

11 . . . . Continuous injection hole
13 . . . . Intermittent injection hole

1. A soft magnetic alloy powder represented by a composition formula of (Fe₁₋ₚX1ₚ)_{100-(a+b+c+d+e)}BₐP_{b}Si_{c}C_{d}X2ₑ (atomic ratio);
wherein X1 is one or more selected from the group consisting of Co and Ni, X2 is one or more selected from the group consisting of Ti, Zr, Hf, Nb, Ta, Mo, Cr, W, Al, Ga, Ag, Zn, S, Ca, Mg, V, Mn, Sn, As, Sb, Bi, N, Au, Cu, a rare earth element, and a platinum group element; and
p, a, b, c, d, and e satisfy
$$\begin{matrix}0 \leq p \leq 0 \text{.5} , \\ 2. \leq a \leq 20.00 , \\ 0. \leq b \leq 14.00 , \\ 0. \leq c \leq 10.00 , \\ 0. \leq d \leq 5.00 , \\ 0. \leq e \leq 3. , and \\ 70. \leq 100 - ( a + b + c + d + e ) \leq 96.00 .\end{matrix}$$

2. The soft magnetic alloy powder according to claim 1 satisfying,
$$0 < \vert exp ( {μ}_{1} ) - exp ( {μ}_{2} ) \vert / ( D 90 - D 10 ) \leq 1.0 , 0.1 \leq {σ}_{1} \leq 1.1 , and \\ 0.01 \leq {σ}_{2} \leq 1.5 ;$$
wherein D10 denotes a particle size at which a cumulative relative frequency based on volume calculated from F(x) is 10%, and D90 denotes a particle size at which a cumulative relative frequency based on volume calculated from F(x) is 90%, provided that F(x) is a particle size distribution based on volume of the soft magnetic alloy powder represented by following formulae (1) to (4) using a plurality of probability density functions fᵢ(x) (i=1, 2, . . . , n) (n≥2).
$$\begin{matrix}[ Formula 1 ] & \\ F ( x ) = {\sum }_{i = 1}^{n} {X}_{i} {f}_{i} ( x ) & ( 1 )\end{matrix}$$
$$\begin{matrix}[ Formula 2 ] & \\ {\sum }_{i = 1}^{n} {X}_{i} = 1 & ( 2 )\end{matrix}$$
$$\begin{matrix}[ Formula 3 ] & \\ {X}_{i} \geq {X}_{i + 1} & ( 3 )\end{matrix}$$
$$\begin{matrix}[ Formula 4 ] & \\ {f}_{i} ( x ) = \frac{1}{\sqrt{2 π} {σ}_{i} x} {e}^{- \frac{1}{2} {( \frac{ln x - {μ}_{i}}{{σ}_{i}} )}^{2}} & ( 4 )\end{matrix}$$

3. The soft magnetic alloy powder according to claim 1, wherein D50, a particle size at which the cumulative relative frequency based on volume is 50%, is between 1.0 μm or larger and smaller than 45.0 μm.

4. The soft magnetic alloy powder according to claim 1, wherein an oxygen content is between 300 ppm or more and 10000 ppm or less.

5. The soft magnetic alloy powder according to claim 1 further including amorphous.

6. The soft magnetic alloy powder according to claim 5, wherein the soft magnetic alloy powder has a crystallization temperature Tx and a glass transition temperature Tg, and has a super cooled liquid range represented by ΔTx=Tx−Tg.

7. The soft magnetic alloy powder according to claim 1 including a nanocrystal.

8. A magnetic core including the soft magnetic alloy powder according to claim 1.

9. The magnetic core according to claim 8 including two or more types of powders.

10. A magnetic device including the soft magnetic alloy powder according to claim 1.

11. An electronic apparatus including the soft magnetic alloy powder according to claim 1.
